(19) United States
(12) Patent Application Publication
(10) Pub. No.: US 2009/0292677 A1
(43) Pub. Date: Nov. 26, 2009

(54) Integrated web analytics and actionable workbench tools for search engine optimization and marketing

(75) Inventor: Larry Kim, Cambridge, MA (US)

Correspondence Address: THE WEBB LAW FIRM, P.C., 700 KOPPERS BUILDING, 436 SEVENTH AVENUE, PITTSBURGH, PA, 15219, US

(73) Assignee: WordStream, Inc., Boston, MA (US)

(21) Appl. No.: 12/412,856

(22) Filed: Mar. 27, 2009

Related U.S. Application Data
(63) Continuation-in-part of application No. 12/371,582, filed on Feb. 14, 2009.
(60) Provisional application No. 61/029,021, filed on Feb. 15, 2008.
(60) Provisional application No. 61/035,786, filed on Mar. 12, 2008.

(51) Int. Cl. G06F 17/30

(52) U.S. Cl. 707/3; 707/E17.108

(57) ABSTRACT

Methods and systems disclosed herein relate to a private keyword database and method of generating the database, such as compilation, manipulation, segmentation, analysis, and leveraging, to enable search engine optimization and marketing tools. The private keyword database may include search marketing data, such as keywords, a character string, a phrase, a slogan, an idiom, a string of characters of alpha-numeric codes, and the like, which may be aggregated from any number of public and proprietary data sources. Related user interfaces, applications, and computer program products are disclosed.

### CROSS-REFERENCE TO RELATED APPLICATIONS

This non-provisional application is a continuation-in-part of the United States Non-Provisional application Ser. No. 12/371,582, filed on Feb. 14, 2009, which claimed priority to U.S. Provisional Application No. 61/029,021, filed Feb. 15, 2008 and U.S. Provisional Application No. 61/035,786, filed Mar. 12, 2008, each of which are hereby incorporated by reference in their entirety.

### BACKGROUND OF THE INVENTION

1. Field of the Invention

The invention herein disclosed generally refers to methods and systems for browsing and manipulating keyword data.

2. Description of Related Art

Web/Internet marketing is the practice of engaging in various marketing activities in order to attract an audience of Internet users to a particular website with the objective to promote and/or sell products, engage with prospective customers, and/or conduct a wide variety of other business activities. Since a large number of Internet users rely on search engine technologies to find information, Internet marketing revolves around using an understanding of search engine technologies to develop various search-marketing activities. Currently, these activities consist of ‘Paid Search Marketing’ (Search Engine Marketing [SEM]/Pay-Per-Click advertising/Sponsored Links) and ‘Natural Search Marketing’ (Search Engine Optimization [SEO]/Organic Search Marketing).

‘Natural Search Marketing’ involves the application of SEO techniques to improve the Search Engine Ranking Positions (SERP) of a company's web pages as they appear in a search engine's natural search listings for various keywords deemed to be relevant to an organization's core activities. Typical Search Engine Optimization techniques may include using standard HTML tags for page titles, paragraphs, and headings; employing image captions and concise and descriptive page titles, descriptions, and file names; applying popular search phrases in the web page contents, using static file names (i.e., filenames that do not change over time), hyper-linking of different web pages with relevant and descriptive linked text (also known as ‘anchor text’, i.e., the active text that you click on to activate and follow a hyperlink to another web page), and soliciting hyperlinks to an organization's web site from other, popular external websites (also known as Link Building).

Some other SEO best practices may involve improving the organization, categorization, and linkage of a company's/organization's web content.

‘Paid Search Marketing’ or Search Engine Marketing (SEM) is a practice of attracting a target audience to a web site with the help of a search engine's commercial advertising platform (e.g., Google™, Yahoo™ MSN, and some other types of search engines.) It may involve identifying relevant search terms (also known as keywords), collecting them into related keyword groupings, and assigning them to ‘Ad Groups.’ An ‘Ad Group’ may consist of a group of related keywords, as well as one or more related advertisements. For example, a text or display advertisement may typically consist of a few lines of text, a headline, two lines of descriptive text, a display URL (collectively known as ‘Ad Copy’), as well as a web page address to direct the users who click on the advertisement. ‘Paid Search Marketing’ employs a Cost-Per-Click (CPC) pricing model. For instance, if a search engine user searches for a keyword that has already been bid by an advertiser; an advertisement is visually displayed on the search result page (also known as an impression). If the user clicks on this displayed advertisement, the advertiser pays the search engine company a dollar amount that may be less than or equal to the maximum ‘cost per click’ that the advertiser has earlier specified in the bid and greater than the minimum cost per click which is a dollar amount that is calculated by the search engine company based on various relevancy factors.

Various factors influence the exact dollar amount that may be billed by the search engine company to the advertiser, as well as the relative ordering of competing advertising units on the search result page. These may include, but may not be limited to, proximity in meaning of the search term entered by the search engine user to the search term that was bid by the advertiser, the relevance of the advertisement copy (i.e., the text) to the keyword, relevance of the keyword to the destination URL, maximum cost per click (the maximum amount that an advertiser is willing to pay for each click—the dollar amount reflects the importance a particular keyword to a business, and thus can imply greater relevancy), historical click through rate, and some other types of factors. These factors can be explained better with the help of an example. Suppose advertiser ‘A’ bids on the keyword “cars,” and advertiser ‘B’ bids on “Used Cars.” If a search engine user's query is for “Used Cars in Boston,” a search engine marketing system may consider advertiser B's advertisement to be more relevant to the user's query because it matches two terms in the user's query: “used” and “cars” as opposed to a single term “cars.” However, if a third advertiser, advertiser ‘C’ bids on an even more specific keyword such as “Used Cars Boston,” advertiser C's advertisement would be considered even more relevant than that of advertiser ‘B,’ because it is an even closer match in comparison to the actual query made by the search engine user. The keywords specified by the advertisers, however, do not have to exactly match a user's query in order to be displayed. Search engine advertising platforms may support different keyword matching options, including the ability to apply a ‘broad match’ which may display advertisements for partial keyword matches, misspellings, plurals, and even synonyms.

Similarly, for a search “Used Cars in Boston,” if advertiser C's Ad Copy actually contains the words “Used Cars in Boston” in the headline or in the description of the products or services being sold, then it would have a greater relevancy in comparison to an advertisement that only promoted “New Cars” within the advertisement copy.

The relevance of the keyword to the destination URL can be explained by considering the user clicks on advertiser C's ad on “Used Cars in Boston.” If the user is sent to a web page on New Trucks in Chicago that has absolutely nothing to do with Used Cars in Boston, the ad may be said to have a low relevancy score for its destination URL.

Search engine marketing platforms favor displaying ads with high click-through-ratios (CTRs) which are calculated by determining the ratio of the number of times an ad was clicked by search engine users divided by the number of impressions (simply, the number of times the ad was displayed.) The CTR is expressed as a percentage. The ads with high CTR are deemed more relevant than those with low value.

Other factors that may determine relevancy may include an advertiser's account history and many other factors, including some that may not be disclosed by search engine companies. Additionally, the weightage of different factors may change periodically, and new relevancy factors may be added to the list.

In a Pay-Per-Click advertising system, search engine companies only get paid if their users click on ads. Therefore, they try to display relevant ads, i.e., advertisements that are deemed to be closely related to a user's search. The mechanism of determining the relevancy of an ad by using various relevancy factors is referred to as calculating the ‘Quality Score’ of an ad (also called Quality Index). Quality Score is a dynamic variable calculated for each keyword in an advertiser's account. For example, ‘Quality Score’ for Google™ AdWords is measured on a scale of 1 to 10, where 10 is an excellent Quality Score (indicative of high relevance) and 1 is a poor Quality Score (indicative of low relevance). Quality Score combines a variety of factors and measures how relevant advertiser keywords are to their Ad Text and to a user's search query. The Quality Score is inversely proportionate to the minimum cost per click. If an advertiser's keywords have low Quality Score, they may be penalized by the search engine advertising platform by having to pay a higher minimum cost per clicks and being assigned lower average Ad Position, which is the position an ad occupies in the event that multiple competing ads are displayed for the same keyword search. Conversely, an advertiser with a high Quality Score may be rewarded by automatically being assigned lower Cost-Per-Clicks and relatively higher positions, which in turn may result in significantly greater return on advertiser's investment.

Advertisers may optimize their ads to achieve higher Quality Scores in various ways, including but not limited to, writing more relevant Ad Copy, choosing more specific keywords, creating tighter and more related keyword groupings, specifying negative keywords (a special kind of keyword matching option that prevents your ad from appearing when the specific term(s) are a part of the user's search), creating more relevant Destination URL's, and other optimization methods. Therefore, organizations may drive traffic to their sites and grow the business online by engaging in various web marketing efforts, including the use of both paid search marketing and natural search marketing.

However, there may be numerous challenges in managing effective pay-per-click search engine marketing campaigns on search engine advertising platforms that utilize the ‘Quality Score’ method of calculating Cost-Per-Click and Ad Position. The first challenge is to create high quality score (i.e., highly relevant) ad campaigns. This requires creating lists of very specific, relevant keywords and grouping them into specific categories, writing specific ad copy that directly reflects the keywords in the keyword groupings, creating relevant destination URL's which are on the same topic as the keyword groupings and ad copy, and continuously optimizing existing campaigns by repeating this process. These activities may be both time consuming and repetitive in nature.

The limitation of time and the necessity of an effective time management solution for growing, managing, and optimizing search engine marketing campaigns is another key challenge. An advertiser could keep publishing more and more ads, using more and more specific keywords, and create more and more destination URL's, and then keep measuring, testing, and optimizing them over and over again. Therefore, the biggest limiting factor may be the time required to complete these repetitive tasks. Subsequently, it may also be critical to use software workflow tools that may prioritize work so that the limited time available for creating, growing, managing, and optimizing search engine marketing campaigns may be spent where it is most likely to have the biggest potential impact in terms of overall return on investment.

The conventional approach to address the aforementioned challenges of creating and optimizing high quality score ads on search engine pay-per-click marketing campaigns issues may involve the use of consultants, keyword tools like Microsoft Excel™ or some other spreadsheet applications, web analytics programs, search analytics tools, and some other paid search marketing software programs. However, these established solutions may become limiting due to certain factors as listed below.

SEO consultants may require a high level of domain expertise which may be difficult considering the range of clients served. These consultants may not be able to reduce the amount of manual repetitive work, and may not be economical and cost-effective over a period. On the other hand, a company employee with some experience with the company will typically possess far more in-depth domain knowledge and expertise on the specifics of the business, and may be more effective in discerning relevant keywords, creating relevant ads, and writing compelling destination URL's.

Similarly, use of spreadsheet applications such as Microsoft Excel™ may involve old data and not real time data and it may be a tabular data (which may not be effective for visually preserving the fluid, keyword hierarchies of keyword groupings). In addition, it may not be used directly and may be desktop based. As a result, upon completing keyword organization, grouping, and analysis tasks for SEO and PPC work, the search marketer may have to perform an additional task of exporting the workings of Excel into a third party system; for example, Google AdWords or a content authoring tool. In addition, the data may not be as easily, reliably, and securely accessed as server-based applications.

The use of web analytics programs such as Google Analytics, Omniture, Enquisite, and CoreMetrics may provide valuable insights into the day-to-day operations of a web site. Various features help to analyze and segment website traffic data in order to create reports about website visitor patterns; for example, what time of the day, what browsers, or what pages on a website are being/have been viewed and for how long (etc.). The ability to trend these various segmentations graphically over time is also a valuable feature. However, these programs may not be immediately actionable; i.e., the tools may provide reports on historical trends and help a search marketing professional diagnose or analyze an issue by providing actionable insights, but in order to truly “act” on the data or to improve or optimize something about the web site or ad campaigns that were being analyzed may involve interacting with separate and disconnected systems. For example, a search marketer might use a Web Analytics application to run a keyword report that determines the most popular keywords that are driving traffic to a Website. Acting on this keyword data might involve logging into a separate search engine marketing platform such as Google AdWords. The search marketer might mentally make note of what changes or work is needed based on the results of the report, or might use a third party application such as Microsoft Excel™ to help organize the data contained in the keyword report provided by the Web Analytics application, and then manually make the optimizations to the ad campaigns by raising or lowering maximum bids, adding or deleting keywords, and adding or deleting negative keywords. Alternatively, a search marketer might choose to act on the data provided by the keyword report by logging into a separate Content Management System (CMS) for the purpose of authoring new destination pages or optimizing existing ones, manually leveraging insights gleaned from mentally processing the data presented in the keyword report provided by the web Analytics application. The disconnect between the web analytics application and the other systems such as search marketing and content publishing systems which are required to act on the web analytics data may present a significant barrier to action; valuable insights may often be lost because data isn't made available in a way that is immediately actionable. Furthermore, acting on web Analytics data is a time consuming and manual process involving one or more human operators, even though much of this work may be semi or even fully automated by a software application. In addition, web analytics may be slow because of the huge volume of data being analyzed and often may not provide data for complex reports in real-time, leading to high latency in the system. For example, a user may have to schedule daily or weekly reports for various statistics that they are interested in monitoring; the report may take minutes or even hours to complete. High latencies create another barrier to action in the form of proportionality between the time it takes for a search marketer to find the data that they need and the likelihood of data usage. For example, most software tools geared towards doing work provide real-time (or near-real-time) feedback.

Other Search Engine Optimization Software Tools currently available in the market include keyword generation tools, Rapid PPC Campaign Creation tools, website ranking tools, and automated bid management tools.

However, the keyword generation tools have limited keyword resolution i.e., the number of keyword suggestions is generally limited to only the more obvious keyword suggestions and not to other relevant keyword permutations and combinations.

Also, these tools only suggest the most popular keywords based on overall search volume. Therefore, these keywords may or may not actually be important to a particular business; i.e., the most popular keywords may not be the same thing as the most important keywords—different organizations value keywords differently.

Further, the keyword tools are not immediately actionable and they do not provide automated tools for analyzing, organizing, and grouping the keywords, and do not provide a means to programmatically leverage the keyword data to inform and optimize a Paid Search Marketing campaign and/or a Natural Search Marketing initiative.

In addition, these tools do not provide any way to detect Negative Keywords. Further, the data provided by Keyword Generation Tools is not exclusive. Every advertiser who signs up for the aforementioned paid or free keyword tools has access to the exact same keyword suggestions, and thus it is not possible for an advertiser to leverage a more in-depth understanding of the data provided by Keyword Generation Tools in such a way as to gain a competitive advantage over competing advertisers.

The Rapid PPC Campaign Creation Tools offer software tools to simplify PPC campaign creation in a way that may potentially improve relevance and Quality Score. Efficient PPC uses the following example on their website: suppose you are an online provider of “Spanish dating services” across cities in the USA. If you provide lists of similar words, such as cities (e.g., Boston, New York, Chicago, etc.), dating words (e.g., dating, find singles, love, match-making, etc.), and “Spanish” words (e.g., Hispanic, Spanish, Latin, Brazilian, Mexican, etc.) These products will “mash-up” the different keyword lists to create a list of every single possible permutation and combination (for example: “Hispanic Singles Boston”, “Latin Dating New York”, etc.) from a list of potentially millions of keywords. They also provide ad template tools, Destination URL creation tools to automatically create ads, and potential Destination URLs that speak specifically of the different keywords.

The website ranking tools such as WebPosition Gold and certain keyword ranking features in HubSpot can produce reports which detail where an organization's web pages and/or sponsored links show up in different Search Engine Result Pages (SERP) for a specified list of keywords. These tools only tell their users how their campaigns are performing; they do not provide any tools or insight on how to automatically improve the performance of ad campaigns or search engine rankings. Additionally, website and ad rankings are personalized by search engines based on a variety of different user-specific criteria, including the geographic location or browsing history of the searcher, to highlight local businesses or other resources deemed to be relevant to a particular user based on their profile. Therefore, the website positioning data reported by Website ranking tools may not necessarily be indicative of what other users are actually seeing in their browsers. Furthermore, such tools may be in violation of certain website's terms of use policy.

Similarly, the automated bid management tools such as Atlas, SendTec, SearchForce, Omniture, Clickable, Marin Software, Google Conversion Optimizer, and others, let advertisers specify various objectives in terms of a desired target Cost-Per-Action (CPA) or Return-On-Advertisement-Spend (ROAS). These tools track keywords that generate specific outcomes (such as sales, downloads, or other lead generation activities); compute how much was spent to achieve that objective; and leverage that data to automatically raise or lower the Maximum Bids on keyword campaigns in order to try to align actual results with target objectives. Bid management tools are bidding algorithms which operate on an existing search engine marketing campaign and do not address the challenges of automating the manual work involved with the continuous creation and maintenance of new high Quality Score search engine advertising campaigns, including finding and grouping of relevant keywords, authoring relevant ads, and the creation of relevant destination URLs. Furthermore, they may also not provide any tools for programmatically optimizing natural search marketing efforts, which is an equally important part of any organization's overall search engine marketing efforts.

All documents mentioned herein are hereby incorporated in their entirety by reference.

### SUMMARY OF THE INVENTION

Various embodiments of the present invention disclose methods and systems for building and optimizing paid search and natural search activities.

In embodiments, the systems and methods may provide for the creation and optimization of the high quality score for paid search engine marketing campaigns and automate the publishing of the search engine optimized web pages. Provided herein is a built-in mechanism to define goals and measure goal conversions so that a search marketer may easily identify the outcomes specific keywords may lead to. It also provides data in such a way as to inform and optimize various aspects of search marketing campaign creation including search marketing workfiow.

In embodiments, the methods and systems may provide browsing and manipulation of the keyword data stored in the taxonomy database.

In embodiments, the method and systems may provide automated, continuous, and keyword discovery; keyword visualization and analysis tools; hierarchical keyword organization tools and data models; keyword grouping tools; keyword grouping suggestion tools; negative keyword discovery tools; keyword de-duplication tools; automatic, rules-based categorization of new keywords; direct integration with search engine advertising platform for building and optimizing paid search engine marketing in an automated way; tools to automate various best practices involved in creating and optimizing high quality score ads for paid-search; keyword goal conversion and ROI measurement tools; search marketing workflow tools; integration with content management and web publishing systems for natural search optimization; and integration with third-party keyword tools. In addition, integration of paid search engine marketing tools with natural search engine marketing tools may provide an amalgamation of two separate yet highly related and synergistic web marketing activities. The integration may provide a powerful and productive tool for minimizing the organization's search engine marketing requirements, saving time and money, and increasing return on investment.

The embodiments of the present invention may enable a search marketer to compile a private keyword database. The private keyword database may represent a tangible business asset similar to a customer list or proprietary customer survey data.

In embodiments, the systems and methods may enable use of real search queries (i.e., keywords) which lead to the discovery of the targeted web site. In addition, keywords provided by third-party keyword tools may be used for discovering targeted websites. By using real keyword searches as input data, the present invention can also use real keyword properties, such as keyword frequencies and goal conversion statistics associated with keywords.

In embodiments, the use of real keywords as search inputs may leverage keyword data to provide intelligent workflow suggestions which are derived by analyzing real keyword statistics and properties.

In embodiments, suggestions for groupings and segmentations of keywords and separation of negative keywords from an analysis of real keyword data may be provided.

In embodiments, a search engine campaign development tool may be provided. The tool may be designed to meet the challenges of creating, building, growing, and optimizing high quality score search engine marketing campaigns. The tool may be configured to automate repetitive tasks, enforce best practices and thereby increase ROI, provide an optimal workflow to maximize the impact of time spent working on campaign optimization, and work in co-operation with an organization's natural search marketing efforts.

In embodiments, a keyword exploration facility 112 may be provided to automate the time-consuming process of finding large volumes of keywords that are specifically relevant to an organization's business activities.

In embodiments, a server facility [described in a separate patent filing] may analyze the keyword data contained in web server log files. The Web servers may include Microsoft Internet Information Server (IIS), Apache Web Server, and other Web servers. The user search queries may be parsed in at least one language, along with other relevant information. The parsed information may be stored in a database, a flat file, an XML file, a memory, a buffer, or some other type of storage facility. Alternatively, live keyword data streams may be sent to the server facility in real-time by adding a snippet of JavaScript code on an organization's website. A visitor may find the website through search; the keyword used by the searcher may be automatically transmitted in real-time to server facility for subsequent data processing. A scheduler associated with the server facility may run periodic updates that may process the newly captured keywords that may have been used by website visitors in order to find the organization's web site since the last system update. This process/method may enable assimilation and integration of the new keywords discovered into a keyword database. This may facilitate dynamic creation of keywords.

In embodiments, the keyword exploration facility 112 may provide integrated keyword reviewing tools, enabling a search marketer to review, accept, or reject the newly discovered keywords, and to optionally set rules by either black-listing or white-listing certain keywords to automate the accepting or rejecting of certain keywords with discriminating characteristics (i.e., keyword tokens or strings that are deemed to be obviously relevant or obviously irrelevant to an organization's activities).

In embodiments, the keyword exploration facility 112 may provide the ability to visualize and browse the keyword data indexed in the server facility. For example, a keyword frequency distribution pattern may conform to a “long tail” distribution pattern. In another example, keyword exploration facility 112 may be data-driven Rich Internet Application (RIA), providing a highly interactive, web-browser-based client interface based on Adobe flash and flex technologies designed to analyze and act on keyword data in real-time.

In embodiments, the keyword exploration facility 112 may allow users to visualize all the available keyword data, and then visually organize keywords into keyword groups (a grouping of semantically related keywords) in a tree-like hierarchy of unlimited depth. The hierarchical keyword groupings may then be mapped to the tabular data model employed by search engine marketing systems. In addition, the keyword exploration facility 112 may allow the users to create Ad Campaigns and Ad Groups by selecting different keyword groups from a user-defined taxonomy hierarchy consisting of a tree of nested keyword groups, and then associating the keywords belonging to the selected keyword group for use as keywords in a new or existing ad group. This may provide better support for keyword classification and organization. Hierarchical keyword organizational structures provide numerous advantages over current campaign and ad group organizational structures which only support two levels of nesting because of the inheritance (and polymorphism) of properties such as maximum cost per click, destination URLs, ad copy, negative keywords, and other settings. As an example, more specific keyword groupings, such as “canned cat food” could optionally inherit these properties from their parent keyword groups, “cat food”), and result in less repetitive work required for the search marketer in building campaigns and ad groups.

In embodiments, the keyword exploration facility 112 may provide the ability to group related keywords into keyword groups. Keyword grouping may involve using the long-tail keyword visualization and analysis tools for search marketing which may enable the user to specify setting various rules (i.e., keyword properties) and running these rules against the large volumes of keywords created by the automated keyword discovery tools for determining the set of all known keywords which may satisfy all the user-specified rules. Additionally, the keyword exploration facility 112 may enable the search marketer to leverage the hierarchical keyword organization tools and data model to intuitively save and organize keyword groups in an efficient manner that may preserve the hierarchical relationships between related keyword groups.

The keyword exploration facility 112 may provide automated tools that automatically suggest relevant keyword groupings by programmatically analyzing keyword data for commonly occurring keywords (including common mis-spellings, plurals, and similar keyword variations). This may be based on user-defined keyword properties (such as goal conversions) deemed to be important by the search marketer, as well as property-specific weightages to indicate the relative importance of each of those keyword properties. The automated keyword grouping tools may suggest how to group together un-categorized keyword data, and also how to segment (i.e., break-up, for the purpose of better organizing) larger keyword groups into smaller, more targeted and relevant keyword groupings. The automated keyword grouping tools are self-learning; its ability to suggest relevant and important keyword groupings improves over time because the suggested keyword groupings are based on an analysis of keyword data, which in turn requires the presence of keyword data to be analyzed. Over time, the aforementioned Automated Keyword Discovery tools results in the generation of more and more keyword data, which makes for better (i.e., more statistically accurate) keyword grouping suggestions.

In embodiments, the keyword exploration facility 112 may provide an intuitive user interface for accepting/rejecting the newly discovered and categorized keywords. The newly organized keyword data may be automatically acted on in a variety of ways to optimize both paid and natural search engine marketing.

In embodiments, the keyword exploration facility 112 may be directly integrated with the search engine advertising platforms of major search engines, including Google, Yahoo!, and MSN. An operator of this facility may simply analyze and segments keywords into keyword groups and associate them with Ad Groups. In addition, the changes made to keyword groups are automatically synchronized with the underlying search engine marketing/advertising platforms. For example, keyword exploration facility 112 may automatically add or delete keywords, or automatically add or delete negative keywords, all based on various user-defined rules. The operator merely has to accept or reject the suggested actions; thus by integrating keyword analytics and research tools with underlying search engine marketing systems, the user can leverage a highly actionable framework for automating the work required to continuously build and optimize high quality score search engine marketing campaigns. The keyword exploration facility 112 may also provide a variety of account export features to enable the creation of ad campaigns via the bulk-upload mechanisms supported by major search engine advertising platforms.

In embodiments, the keyword exploration facility 112 may provide tools that suggest the most optimized workflow for a search marketer to follow when working on creating and optimizing high quality score ad campaigns on an ongoing basis.

In embodiments, the keyword exploration facility 112 may enable search marketing professionals to unify their paid search and natural search marketing efforts by also providing integration of keyword research and analytics tools with various commercial and open source content management systems and other web publishing systems, including blogs, wiki's, and the like.

In embodiments, the keyword exploration facility 112 may simplify the publishing of highly relevant destination URLs (i.e., Web pages) for at least grouping of keywords by providing a user interface that seamlessly invokes the web page creation method of an underlying CMS or web publishing system from directly within the keyword exploration facility. In embodiments, various best-practices may automatically be enforced, including the automatic use of relevant file names, meta keywords, page title, headings, and the like, thus increasing the relevancy of a destination URL, while reducing the work required to do so, and also simultaneously improving Quality Score.

In embodiments, the keyword exploration facility 112 may provide integrated support for invoking an editor or a program capable of editing files. A search-friendly editor (described in a separate patent application) automates much of the work required to create Web pages that are specifically designed to score highly in the natural search results for searches for keywords in a particular keyword grouping. The integration between the keyword exploration facility 112 and the editor may be based on the ability to visually define associations between keyword groups and web pages—these relationships can in turn be used to configure the editor to automatically suggest relevant hyper-links for cross-referencing related web pages as well as enforce or promote certain Search Engine Optimization (SEO) best practices which can greatly help in increasing the natural search result ranking of the newly published Web page.

In embodiments, the keyword exploration facility 112 may provide an advanced keyword visualization tool for creating keyword groupings for paid search marketing campaigns. Further, these tools may provide actionable workflow insights into what are the most popular topics which ought to be targeted for content authoring to increase natural search traffic. The natural search engine optimization workflow tools base their workflow calculations based on various user-defined settings that reflect the operator's preferences and objectives.

In addition to the ability to generate keyword suggestion terms based on historical and live web server analytics data, the keyword exploration facility 112 may provide a user interface for integrating with various third-party keyword suggestion tools to import new keywords that were not automatically discovered through log file and Web traffic analysis, directly into the server facility. This may allow rendering the new keyword data provided by third-party keyword suggestion tools more immediately actionable by providing integration of the aforementioned keyword grouping and organization tools with search engine marketing platforms for engaging in Search Engine Marketing (SEM) and with web publishing systems for engaging in SEO. The ability to import keyword data from third-party keyword tools marks a significant differentiating feature from other keyword analytics tools (such as Enquisite or HitTails) which only allow you to analyze keyword data based on a website's past history.

In accordance with an embodiment of the present invention, tools for assessment, segregation, and grouping of negative keywords may be provided.

In accordance with another embodiment of the present invention, automatic keyword data analysis to suggest both relevant and irrelevant terms may be provided. In addition, the optimized keyword lists and simplified keyword reviewing methods may be provided.

In accordance with yet another embodiment of the invention, workflow tools may be provided to help prioritize the negative keyword discovery efforts for maximizing potential ROI from campaign optimization.

The keyword exploration facility 112 also features an integrated suite of many other powerful and productive search engine marketing automation tools, described in the “detailed description” section of this application.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating at least one of the suggested keywords and the traffic-generating keywords into a working keyword data set, continuously and automatically incrementing the working keyword data set for new periods of time based on retrieval of at least one of new traffic-generating keywords and new suggested keywords, and presenting the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization. The method may further include grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The method may further include allowing user-definition of rules that automatically govern at least one of addition of new keywords to keyword groups, deletion of keywords from the working keyword data set, and grouping of keywords into keyword groups.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time, and a data set of suggested keywords, a processor for associating at least one of the suggested keywords and the traffic-generating keywords into a working keyword data set and continuously and automatically incrementing the working keyword data set for new periods of time based on retrieval of at least one of new traffic-generating keywords and new suggested keywords, and a presentation facility for presenting the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization. In the system, the processor may group keywords in the working keyword data set into a plurality of multi-dimensional, hierarchical keyword groups, wherein at least some keyword groups are segmented into sub-groups, and enables users to add keywords to and delete keywords from keyword groups and sub-groups. The system may further include user-defined rules that automatically govern at least one of addition of new keywords to keyword groups, deletion of keywords from the working keyword data set, and grouping of keywords into keyword groups.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating at least one of the suggested keywords and the traffic-generating keywords into a working keyword data set, storing in a keyword data set a property indicative of the performance of each keyword from the working keyword data set, and presenting in a visual user interface information representing the keyword performance properties, thereby facilitating analysis as to what keywords should be used to optimize at least one of search engine results and search engine marketing for the website. In the method, the performance property is selected from the group consisting of the frequency with which a keyword is used to access a web resource, the frequency that a desired action is undertaken by a user who has accessed the web resource by using the keyword, the historical value of actions taken by users who have accessed by web resource by using the keyword and the expected value of future actions that are predicted to be taken by users who have accessed the resource using the keyword. The method may further comprising grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The method may further comprise allowing user-definition of rules that automatically govern at least one of addition of new keywords to keyword groups, deletion of keywords from the working keyword data set, and grouping of keywords into keyword groups. The method may further comprise allowing users to transform the working keyword data set into a private keyword data set by at least one of adding keywords to and deleting keywords from the working keyword data set, the private keyword data set being adapted for use in a workflow associated with at least one of search engine marketing and search engine optimization.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords, a processor for associating at least one of the suggested keywords and the traffic-generating keywords into a working keyword data set, a memory facility for storing in a keyword data set a property indicative of the performance of each keyword from the working keyword data set, and a visual user interface for presenting information representing the keyword performance properties, thereby facilitating analysis as to what keywords should be used to optimize at least one of search engine results and search engine marketing for the website. In the system, the performance property may be selected from the group consisting of the frequency with which a keyword is used to access a web resource, the frequency that a desired action is undertaken by a user who has accessed the web resource by using the keyword, the historical value of actions taken by users who have accessed by web resource by using the keyword and the expected value of future actions that are predicted to be taken by users who have accessed the resource using the keyword. In the system, the processor may group keywords in the working keyword data set into a plurality of multi-dimensional, hierarchical keyword groups, wherein at least some keyword groups are segmented into sub-groups, and enables users to add keywords to and delete keywords from keyword groups and sub-groups. The system may further include user-defined rules that automatically govern at least one of addition of new keywords to keyword groups, deletion of keywords from the working keyword data set, and grouping of keywords into keyword groups. In the system, the processor may enable users to transform the working keyword data set into a private keyword data set by at least one of adding keywords to and deleting keywords from the working keyword data set, the private keyword data set being adapted for use in a workflow associated with at least one of search engine marketing and search engine optimization.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating at least one of the suggested keywords and the traffic-generating keywords into a working keyword data set, presenting a keyword group of the working keyword data set in a hierarchical tree that relates at least one keyword group to one or more subgroups of the keyword group, and allowing a user to interact with a keyword group to view and modify a subgroup made up of a sub-set of members of the keyword group. In the method, at least one subgroup may be further segmented into additional sub-groups.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords, a processor for associating at least one of the suggested keywords and the traffic-generating keywords into a working keyword data set, a presentation facility for presenting a keyword group of the working keyword data set in a hierarchical tree that relates at least one keyword group to one or more subgroups of the keyword group, and a user interface for allowing a user to interact with a keyword group to view and modify a subgroup made up of a sub-set of members of the keyword group. In the system, at least one subgroup may be further segmented into additional sub-groups.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating at least one of the suggested keywords and the traffic-generating keywords into a working keyword data set, presenting a plurality of keywords and keyword groups of the working keyword data set in a hierarchical tree structure having at least three levels of depth, and providing a keyword grouping interface for allowing a user to modify keyword groups in the hierarchical tree structure.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords, a processor for associating at least one of the suggested keywords and the traffic-generating keywords into a working keyword data set, a presentation facility for presenting a plurality of keywords and keyword groups of the working keyword data set in a hierarchical tree structure having at least three levels of depth, and a keyword grouping interface for allowing a user to modify keyword groups in the hierarchical tree structure.

In an aspect of the invention, a computer-implemented method applicable to a computer facility adapted to facilitate a workflow for at least one of a search engine optimization campaign and a search engine marketing campaign may include collecting a working data set of keywords, analyzing the working keyword data set for commonly occurring keywords, and automatically suggesting relevant keyword groupings based on at least one of a set of weightings assigned to indicate the importance of a keyword property and the frequency of occurrence of sub-words within keywords appearing in the keyword data set. The method may further include applying a self-learning module to adjust the weightings used to automatically suggest keyword groupings. In the method, the weightings may be user-defined. The method may further include grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The method may further include allowing user-definition of rules that automatically govern at least one of addition of new keywords to keyword groups, deletion of keywords from the working keyword data set, and grouping of keywords into keyword groups. The method may further include allowing users to transform the working keyword data set into a private keyword data set by at least one of adding keywords to and deleting keywords from the working keyword data set, the private keyword data set being adapted for use in a workflow associated with at least one of search engine marketing and search engine optimization. The method may further include collecting a data set of traffic-generating keywords, the traffic-generating keyword data set representing keywords used to access a web resource during different periods of time; collecting a data set of suggested keywords; and associating at least one of the suggested keywords and the traffic-generating keywords to form the working keyword data set.

In an aspect of the invention, a system adapted to facilitate a workflow for at least one of a search engine optimization campaign and a search engine marketing campaign may include a data collection facility for collecting a working data set of keywords, a processor for analyzing the working keyword data set for commonly occurring keywords and automatically suggesting relevant keyword groupings based on at least one of a set of weightings assigned to indicate the importance of a keyword property and the frequency of occurrence of sub-words within keywords appearing in the keyword data set. The system may further include a self-learning module to adjust the weightings used to automatically suggest keyword groupings. In the system, the weightings may be user-defined. In the system, the processor groups keywords in the working keyword data set into a plurality of multi-dimensional, hierarchical keyword groups, wherein at least some keyword groups are segmented into sub-groups, and allowing users to add keywords to and delete keywords from keyword groups and sub-groups. The system may further include user-defined rules that automatically govern at least one of addition of new keywords to keyword groups, deletion of keywords from the working keyword data set, and grouping of keywords into keyword groups. In the system, the processor enables users to transform the working keyword data set into a private keyword data set by at least one of adding keywords to and deleting keywords from the working keyword data set, the private keyword data set being adapted for use in a workflow associated with at least one of search engine marketing and search engine optimization. In the system, the data collection facility is used to collect a data set of traffic-generating keywords, the traffic-generating keyword data set representing keywords used to access a web resource during different periods of time; collecting a data set of suggested keywords; and associating at least one of the suggested keywords and the traffic-generating keywords to form the working keyword data set.

In an aspect of the invention, a computer-implemented method applicable to a computer facility adapted to facilitate a workflow for at least one of a search engine optimization campaign and a search engine marketing campaign may include collecting a data set of keywords, analyzing the data set to automatically identify terms not relevant to accessing a website, and presenting to a user, in a workflow for selecting and rejecting keywords, a set of negative keywords to omit from a search engine optimization campaign.

In an aspect of the invention, a system adapted to facilitate a workflow for at least one of a search engine optimization campaign and a search engine marketing campaign may include a data collection facility for collecting a data set of keywords, a processor for analyzing the data set to automatically identify terms not relevant to accessing a website, and a presentation facility for presenting to a user, in a workflow for selecting and rejecting keywords, a set of negative keywords to omit from a search engine optimization campaign.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating at least one of the suggested keywords and the traffic-generating keywords into a working keyword data set, allowing a user to define a rule set by which a keyword may be grouped with a keyword group of the working keyword data set according to at least one property of the keyword, allowing a user to define a rule by which a keyword may be rejected based on an extent of relevance, and automatically grouping relevant new keywords with keyword groups and automatically deleting irrelevant keywords to transform the working keyword data set into a hierarchically grouped data set of relevant keywords. In the method, the property used to group a keyword with a keyword grouping may be selected from the group consisting of what words the keyword contains, what words the keyword does not contain, traffic derived from the keyword, the number of terms in the keyword, and the achievement of an objective based on use of the keyword by users to access the web resource. The method may further include providing a facility for highlighting new keywords in the working keyword data set. The method may further include providing a keyword manipulation facility by which a user may accept or reject new keywords for inclusion in the working keyword data set. The method may further include allowing a user to define rules by which new keywords are automatically added to the working keyword data set. The method may further include a user to define rules by which new keywords are automatically omitted or deleted from the working keyword data set. The method may further include providing a new keyword reviewing facility by which a user may define rules according to which new keywords are classified for automatic inclusion, automatic exclusion, manual inclusion or manual exclusion with respect to the working keyword data set.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating at least one of the suggested keywords and the traffic-generating keywords into a working keyword data set, allowing a user to define a rule set by which a keyword may be grouped with a keyword group of the working keyword data set according to at least one property of the keyword, allowing a user to define a rule by which a keyword may be rejected based on an extent of relevance, and automatically grouping relevant new keywords with keyword groups and automatically deleting irrelevant keywords to transform the working keyword data set into a hierarchically grouped data set of relevant keywords. In the method, the property used to group a keyword with a keyword grouping may be selected from the group consisting of what words the keyword contains, what words the keyword does not contain, traffic derived from the keyword, the number of terms in the keyword, and the achievement of an objective based on use of the keyword by users to access the web resource. The method may further include providing a facility for highlighting new keywords in the working keyword data set. The method may further include providing a keyword manipulation facility by which a user may accept or reject new keywords for inclusion in the working keyword data set. The method may further include allowing a user to define rules by which new keywords are automatically added to the working keyword data set. The method may further include a user to define rules by which new keywords are automatically omitted or deleted from the working keyword data set. The method may further include providing a new keyword reviewing facility by which a user may define rules according to which new keywords are classified for automatic inclusion, automatic exclusion, manual inclusion or manual exclusion with respect to the working keyword data set.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and collecting a data set of suggested keywords, a processor for associating at least one of the suggested keywords and the traffic-generating keywords into a working keyword data set, a rules server for storing a user-defined rule set by which a keyword may be grouped with a keyword group of the working keyword data set according to at least one property of the keyword and by which a keyword may be rejected based on an extent of relevance, and a processor for automatically grouping relevant new keywords with keyword groups and automatically deleting irrelevant keywords to transform the working keyword data set into a hierarchically grouped data set of relevant keywords. In some embodiments, the data collection facility, processor, and rules server may be embodied in a single unit while in other embodiments they may be embodied as separate components of a distributed system. In the system, the property used to group a keyword with a keyword grouping is selected from the group consisting of what words the keyword contains, what words the keyword does not contain, traffic derived from the keyword, the number of terms in the keyword, and the achievement of an objective based on use of the keyword by users to access the web resource. In the system, the data collection facility highlights new keywords in the working keyword data set. The system may further include a keyword manipulation facility by which a user may accept or reject new keywords for inclusion in the working keyword data set. The system may further include a user-defined rule by which new keywords are automatically added to the working keyword data set. The system may further include a user-defined rule by which new keywords are automatically omitted or deleted from the working keyword data set. The system may further include a new keyword reviewing facility by which a user may define rules according to which new keywords are classified for automatic inclusion, automatic exclusion, manual inclusion or manual exclusion with respect to the working keyword data set.

In an aspect of the invention, a computer-implemented method applicable to a computer facility adapted to facilitate a workflow for at least one of search engine optimization and search engine marketing may include providing a set of keyword analysis tools, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and using the keyword analysis tools to develop a data set of preferred keywords; and automatically synchronizing the preferred keyword data sets with a search marketing advertising platform, facilitating purchase of preferred keyword groups via the advertising platform. In forming the working keyword data set, it is optional to associate both suggested keywords and traffic-based keywords. In some embodiments, only one set of keywords may be needed to form the working keyword data set.

In an aspect of the invention, a system adapted to facilitate a workflow for at least one of search engine optimization and search engine marketing may include a set of keyword analysis tools, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and a database for storing data set of preferred keywords developed using the keyword analysis tools; and a processor for automatically synchronizing the preferred keyword data sets with a search marketing advertising platform, facilitating purchase of preferred keyword groups via the advertising platform. In forming the working keyword data set, it is optional to associate both suggested keywords and traffic-based keywords. In some embodiments, only one set of keywords may be needed to form the working keyword data set. In some embodiments, the keyword analysis tools, database, and processor may be embodied in a single unit while in other embodiments they may be embodied as separate components of a distributed system.

In an aspect of the invention, a computer-implemented method applicable to a computer facility adapted to facilitate a workflow for at least one of search engine optimization and search engine marketing may include providing a set of keyword analysis tools, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and using the keyword analysis tools to develop a data set of preferred keywords organized in keyword groups; and automatically generating a first draft advertisement having text that uses keywords from a preferred keyword group. In forming the working keyword data set, it is optional to associate both suggested keywords and traffic-based keywords. In some embodiments, only one set of keywords may be needed to form the working keyword data set.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time; collecting a data set of suggested keywords; associating at least one of the suggested keywords and the traffic-generating keywords into a working keyword data set; assessing the likely impact of the use of a keyword on the quality score attributed in an advertising platform to an advertisement that uses the keyword; and automatically generating suggested advertising text using keywords likely to generate a high quality score.

In an aspect of the invention, a system adapted to facilitate a workflow for at least one of search engine optimization and search engine marketing may include a set of keyword analysis tools, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and a database for storing a data set of preferred keywords organized in keyword groups developed using the keyword analysis tools; and an authoring interface for automatically generating a first draft advertisement having text that uses keywords from a preferred keyword group. In forming the working keyword data set, it is optional to associate both suggested keywords and traffic-based keywords. In some embodiments, only one set of keywords may be needed to form the working keyword data set. In some embodiments, the keyword analysis tools, database, and authoring interface may be embodied in a single unit while in other embodiments they may be embodied as separate components of a distributed system.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords; a processor for associating at least one of the suggested keywords and the traffic-generating keywords into a working keyword data set; an assessment facility for assessing the likely impact of the use of a keyword on the quality score attributed in an advertising platform to an advertisement that uses the keyword; and an authoring interface for automatically generating suggested advertising text using keywords likely to generate a high quality score. In some embodiments, the keyword analysis tools, database, assessment facility, and authoring interface may be embodied in a single unit while in other embodiments they may be embodied as separate components of a distributed system.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time; collecting a data set of suggested keywords; associating at least one of the suggested keywords and the traffic-generating keywords into a working keyword data set; determining and ranking the impact of the use of keyword groupings by their estimated contribution to user-specified objectives by members of the keyword groupings; providing a set of workflow tools, the workflow tools facilitating at least one of: (a) tools for suggesting what keyword groups should be segmented into sub-groupings; (b) tools for suggesting what ad groups should be created; (c) tools for suggesting what ad groups should be optimized; (d) tools for suggesting what ad groups, if optimized, would generate a high amount of advertising traffic; (e) tools for suggesting what keywords should be eliminated; (f) tools for suggesting what web resources should be created; and (g) tools for suggesting de-duplication of keyword groups; and providing, in the workflow, a prioritization of the activities based on which activities will have the most impact on an objective sought by the user of the workflow. In forming the working keyword data set, it is optional to associate both suggested keywords and traffic-based keywords. In some embodiments, only one set of keywords may be needed to form the working keyword data set. In the method, the objective sought by the user is selected from the group consisting of obtaining a favorable quality score for an advertisement in an advertising platform; improving likelihood of interaction by a user with an advertisement that uses preferred keywords; increasing the amount of traffic to a web resource; and improving likelihood of purchase by a user of goods or services advertised in an advertisement that uses preferred keywords.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords; a processor for associating at least one of the suggested keywords and the traffic-generating keywords into a working keyword data set and determining and ranking the impact of the use of keyword groupings by their estimated contribution to user-specified objectives by members of the keyword groupings; a set of workflow tools, the workflow tools facilitating at least one of: (a) tools for suggesting what keyword groups should be segmented into sub-groupings; (b) tools for suggesting what ad groups should be created; (c) tools for suggesting what ad groups should be optimized; (d) tools for suggesting what ad groups, if optimized, would generate a high amount of advertising traffic; (e) tools for suggesting what keywords should be eliminated; (f) tools for suggesting what web resources should be created; and (g) tools for suggesting de-duplication of keyword groups; and a processor for prioritizing, provided in the workflow, the activities based on which activities will have the most impact on an objective sought by the user of the workflow. In some embodiments, the data collection facility, processor, and workflow tools may be embodied in a single unit while in other embodiments they may be embodied as separate components of a distributed system. In the system, the objective sought by the user may be selected from the group consisting of obtaining a favorable quality score for an advertisement in an advertising platform; improving likelihood of interaction by a user with an advertisement that uses preferred keywords; increasing the amount of traffic to a web resource; and improving likelihood of purchase by a user of goods or services advertised in an advertisement that uses preferred keywords.

In an aspect of the invention, a computer-implemented method applicable to a computer facility adapted to facilitate a workflow for at least one of search engine optimization and search engine marketing may include providing a set of workflow tools, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups and automatically generating a first draft advertisement having text that uses keywords from a preferred keyword group; and integrating the keyword analysis workflow with at least one of a content management facility, a web publishing facility and a desktop authoring tool. In forming the working keyword data set, it is optional to associate both suggested keywords and traffic-based keywords. In some embodiments, only one set of keywords may be needed to form the working keyword data set.

In an aspect of the invention, a system adapted to facilitate a workflow for at least one of search engine optimization and search engine marketing may include a set of workflow tools, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups and automatically generating a first draft advertisement having text that uses keywords from a preferred keyword group; and at least one of a content management facility, a web publishing facility and a desktop authoring tool integrated with the keyword analysis workflow. In forming the working keyword data set, it is optional to associate both suggested keywords and traffic-based keywords. In some embodiments, only one set of keywords may be needed to form the working keyword data set. In some embodiments, the workflow tools, content management facility, web publishing facility and desktop authoring tool may be embodied in a single unit while in other embodiments they may be embodied as separate components of a distributed system.

In an aspect of the invention, a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time; collecting a data set of suggested keywords; associating at least one of the suggested keywords and the traffic-generating keywords into a working keyword data set; allowing a user to define a rule set by which a keyword may be grouped with a keyword group according to a property of the keyword; allowing a user to define a rule by which a keyword may be rejected based on an extent of relevance; automatically grouping relevant new keywords with keyword groups and automatically deleting irrelevant keywords to transform the keyword data set into a grouped data set of relevant keywords; automatically organizing the grouped keyword data set into hierarchical groups, wherein a user may interact with a group to view keywords associated with the group; collecting statistics relating to the frequency with which each keyword group in the data set is used to access a website; presenting a visual representation of the frequency distribution of the keyword groups; developing a data set of preferred keywords organized in keyword groups; automatically generating a first draft advertisement having text that uses keywords from a preferred keyword group; and integrating the workflow with at least one of an advertising platform, a content management facility and a web publishing facility.

In an aspect of the invention, a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords; a processor for associating at least one of the suggested keywords and the traffic-generating keywords into a working keyword data set; a rules server for storing a user-defined rule set by which a keyword may be grouped with a keyword group according to a property of the keyword; a rules server for storing a user-defined rule by which a keyword may be rejected based on an extent of relevance; a processor for automatically grouping relevant new keywords with keyword groups and automatically deleting irrelevant keywords to transform the keyword data set into a grouped data set of relevant keywords; a processor for automatically organizing the grouped keyword data set into hierarchical groups, wherein a user may interact with a group to view keywords associated with the group; a data collection facility for collecting statistics relating to the frequency with which each keyword group in the data set is used to access a website; a presentation facility for presenting a visual representation of the frequency distribution of the keyword groups; a database for storing a data set of preferred keywords organized in keyword groups; an authoring interface for automatically generating a first draft advertisement having text that uses keywords from a preferred keyword group; and at least one of an advertising platform, a content management facility and a web publishing facility integrated with the workflow. In some embodiments, the data collection facility, processor, rules server, presentation facility, database, authoring interface, content management facility, web publishing facility and advertising platform may be embodied in a single unit while in other embodiments they may be embodied as separate components of a distributed system.

In an aspect of the invention, a computer-implemented method applicable to a computer facility adapted to facilitate a workflow for at least one of a search engine optimization campaign and a search engine marketing campaign may include collecting a data set of keywords, analyzing the data set to automatically identify terms relevant to accessing a website, and presenting to a user, in a workflow for selecting and rejecting keywords, a set of relevant keywords to include in at least one of a search engine optimization campaign and a search engine marketing campaign. In an aspect of the invention, a system adapted to facilitate a workflow for at least one of a search engine optimization campaign and a search engine marketing campaign, may include a data collection facility for collecting a data set of keywords, a processor for analyzing the data set to automatically identify terms relevant to accessing a website, and a presentation facility for presenting to a user, in a workflow for selecting and rejecting keywords, a set of relevant keywords to include in at least one of a search engine optimization campaign and a search engine marketing campaign.

In an aspect of the invention, a computer-implemented method applicable to a computer facility adapted to facilitate a workflow for at least one of a search engine optimization campaign and a search engine marketing campaign may include collecting a data set of keywords, analyzing the data set to automatically identify terms that are at least one of relevant or irrelevant to accessing a website, and automatically grouping relevant new keywords with a relevant keyword group and automatically grouping irrelevant keywords with an irrelevant keyword group to transform the keyword data set into a grouped data set of relevant and irrelevant keywords. The method may further include allowing a user to define a rule set by which a keyword is grouped with a keyword group according to a relevance of the keyword. In an aspect of the invention, a system adapted to facilitate a workflow for at least one of a search engine optimization campaign and a search engine marketing campaign may include a data collection facility for collecting a data set of keywords, a processor for analyzing the data set to automatically identify terms that are at least one of relevant or irrelevant to accessing a website, and a processor for automatically grouping relevant new keywords with a relevant keyword group and automatically grouping irrelevant keywords with an irrelevant keyword group to transform the keyword data set into a grouped data set of relevant and irrelevant keywords. The system may further include a rules server to store a user-defined rule set by which a keyword is grouped with a keyword group according to a relevance of the keyword.

In an aspect of the invention, a system and computer-implemented method applicable to a computer facility adapted to facilitate a workflow for at least one of search engine optimization and search engine marketing may include providing a set of keyword analysis workflow tools, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword is grouped with a keyword group according to a property of the new keyword; (e) allowing a user to define a rule by which a new keyword is rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups, and integrating the keyword analysis workflow with at least one of a content management facility, a web publishing facility and a desktop authoring tool and presenting to a user, in at least one of the content management facility, the web publishing facility and the desktop authoring tool, at least one of the keyword groups comprising the preferred keywords to include in content authoring.

In an aspect of the invention, a system and computer-implemented method applicable to a computer facility adapted to facilitate a workflow for at least one of search engine optimization and search engine marketing may include providing a set of keyword analysis workflow tools, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword is grouped with a keyword group according to a property of the new keyword; (e) allowing a user to define a rule by which a new keyword is rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups; and integrating the keyword analysis workflow with at least one of a content management facility, a web publishing facility and a desktop authoring tool, and hyperlinking the preferred keywords within content authored using at least one of the content management facility, the web publishing facility and the desktop authoring tool.

In an aspect of the invention, a system and computer-implemented method applicable to a computer facility adapted to facilitate a workflow for at least one of search engine optimization and search engine marketing may include aggregating a data set of traffic-generating keywords, the traffic-generating keyword data set representing keywords used to access a web resource during different periods of time, and a data set of suggested keywords, wherein the keywords are aggregated from at least one of a private data source and a public data source, associating the suggested keywords and the traffic-generating keywords into a working keyword data set, continuously and automatically incrementing the working keyword data set for new periods of time based on retrieval of at least one of new traffic-generating keywords and new suggested keywords, and presenting the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization. The system and method may further include grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The system and method may further include allowing user-definition of rules that automatically govern at least one of addition of new keywords to keyword groups, deletion of keywords from the working keyword data set, and grouping of keywords into keyword groups. The system may include a data collection facility for aggregating a data set of traffic-generating keywords, the traffic-generating keyword data set representing keywords used to access a web resource during different periods of time, and a data set of suggested keywords, wherein the keywords are aggregated from at least one of a private data source and a public data source, a processor for associating the suggested keywords and the traffic-generating keywords into a working keyword data set and continuously and automatically incrementing the working keyword data set for new periods of time based on retrieval of at least one of new traffic-generating keywords and new suggested keywords, and a presentation facility for presenting the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization.

In an aspect of the invention, a system and a computer-implemented method applicable to a computer facility adapted to facilitate a workflow for at least one of search engine optimization and search engine marketing may include collecting a working keyword data set comprising at least one of traffic-generating keywords, the traffic-generating keyword data set representing keywords used to access a web resource during different periods of time, and suggested keywords, allowing a user to search the working keyword data set using a full text query, allowing a user to define a rule set by which a keyword is grouped with a keyword group of the working keyword data set according to a text match in the search result, and automatically grouping new keywords with keyword groups in accordance with the rule set. The full text query may be directed at identifying keywords that contain at least one of a certain word, a word pattern, one or more words, a specific word combination and ordering, the absence of certain words, the absence of certain word combinations, and the absence of certain word patterns. The system may include a data collection facility for collecting a working keyword data set comprising at least one of traffic-generating keywords, the traffic-generating keyword data set representing keywords used to access a web resource during different periods of time, suggested keywords, and keywords leading to the achievement of an objective based on use of the keyword by users to access the web resource, a search facility for allowing a user to search the working keyword data set using a full text query, a user-defined rule set by which a keyword is grouped with a keyword group of the working keyword data set according to a text match in the search result, and a processor for automatically grouping new keywords with keyword groups in accordance with the rule set.

In an aspect of the invention, a system and a computer-implemented method applicable to a computer facility adapted to facilitate a workflow for at least one of search engine optimization and search engine marketing may include collecting a working keyword data set comprising at least one of traffic-generating keywords, the traffic-generating keyword data set representing keywords used to access a web resource during different periods of time, suggested keywords, and keywords leading to the achievement of an objective based on use of the keyword by users to access the web resource, and allowing a user to search the working keyword data set using at least one of a full text query and a keyword property query. The full text query may be directed at identifying keywords that contain at least one of a certain word, a word pattern, one or more words, a specific word combination and ordering, the absence of certain words, the absence of certain word combinations, and the absence of certain word patterns. The property used to group a keyword with a keyword grouping may be selected from the group consisting of what words the keyword contains, what words the keyword does not contain, traffic derived from the keyword, the number of terms in the keyword, keywords discovered during a specified date range, and the achievement of an objective based on use of the keyword by users to access the web resource. The system may include a data collection facility for collecting a working keyword data set comprising at least one of traffic-generating keywords, the traffic-generating keyword data set representing keywords used to access a web resource during different periods of time, and suggested keywords, and a search facility for allowing a user to search the working keyword data set using at least one of a full text query and a keyword property query.

In an aspect of the invention, a system and a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating the suggested keywords and the traffic-generating keywords into a working keyword data set, allowing a user to define a rule set by which a keyword is grouped with a keyword group of the working keyword data set according to at least one property of the keyword, allowing a user to define a rule by which a keyword is rejected based on an extent of relevance, automatically grouping relevant new keywords with keyword groups and automatically deleting irrelevant keywords to transform the working keyword data set into a hierarchically grouped data set of relevant keywords, and allowing a user to search the grouped data set using at least one of a full text query and a keyword property query. The full text query may be directed at identifying keywords that contain at least one of a certain word, a word pattern, one or more words, a specific word combination and ordering, the absence of certain words, the absence of certain word combinations, and the absence of certain word patterns. The property used to group a keyword with a keyword grouping may be selected from the group consisting of what words the keyword contains, what words the keyword does not contain, traffic derived from the keyword, the number of terms in the keyword, keywords discovered during a specified date range, and the achievement of an objective based on use of the keyword by users to access the web resource.

In an aspect of the invention, a system and a computer-implemented method applicable to a computer facility adapted to facilitate a workflow for at least one of search engine optimization and search engine marketing may include collecting a working keyword data set comprising at least one of traffic-generating keywords, the traffic-generating keyword data set representing keywords used to access a web resource during different periods of time, and suggested keywords, allowing a user to search the working keyword data set using a keyword property query, allowing a user to define a rule set by which a keyword is grouped with a keyword group of the working keyword data set according to a keyword property match in the search result, and automatically grouping new keywords with keyword groups in accordance with the rule set.

In an aspect of the invention, a system and a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, collecting a data set of suggested keywords, associating the suggested keywords and the traffic-generating keywords into a working keyword data set, allowing a user to define a rule set by which a keyword is grouped with a keyword group of the working keyword data set according to at least one property of the keyword, allowing a user to define a rule by which a keyword is rejected based on an extent of relevance, automatically grouping relevant new keywords with keyword groups and automatically deleting irrelevant keywords to transform the working keyword data set into a hierarchically grouped data set of relevant keywords, detecting keywords that are overlapping with multiple keyword group memberships, and automatically suggesting one or more possible modifications to the rule set that governs membership into a particular keyword grouping in order to de-duplicate a keyword grouping. The property used to group a keyword with a keyword grouping may be selected from the group consisting of what words the keyword contains, what words the keyword does not contain, traffic derived from the keyword, the number of terms in the keyword, and the achievement of an objective based on use of the keyword by users to access the web resource. The system and method may further include providing a facility for highlighting new keywords in the working keyword data set. The system and method may further include providing a keyword manipulation facility by which a user may accept or reject new keywords for inclusion in the working keyword data set. The system and method may further include allowing a user to define rules by which new keywords are automatically added to the working keyword data set. The system and method may further include providing a new keyword reviewing facility by which a user may define rules according to which new keywords are classified for automatic inclusion, automatic exclusion, manual inclusion or manual exclusion with respect to the working keyword data set.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

The invention and the following detailed description of certain embodiments thereof may be understood by reference to the following figures:

FIG. 1 depicts various components of the system, in accordance with an embodiment of the present invention;

FIG. 2 depicts a snapshot of a keyword exploration facility, in accordance with an embodiment of the present invention;

FIG. 3 depicts a default view of a keyword exploration facility, in accordance with an embodiment of the present invention;

FIGS. 4a and 4b depict an axis control tool and a zoom control tool, in accordance with an embodiment of the present invention;

FIG. 5 depicts a keyword query box, in accordance with an embodiment of the present invention;

FIG. 6 depicts an interface for an advanced keyword search, in accordance with an embodiment of the present invention;

FIG. 7 depicts a keyword data grid, in accordance with an embodiment of the present invention;

FIG. 8 depicts an interface for creating a keyword group, in accordance with an embodiment of the present invention;

FIG. 9 depicts a keyword group explorer, in accordance with an embodiment of the present invention;

FIG. 10 depicts various keyword group visualization options, in accordance with an embodiment of the present invention;

FIG. 11 depicts the process of deleting a keyword grouping from the keywords group explorer, in accordance with an embodiment of the present invention;

FIG. 12 depicts the process of renaming an existing keyword group, in accordance with an embodiment of the present invention;

FIG. 13 depicts segmenting the keyword groupings, in accordance with an embodiment of the present invention;

FIG. 14 depicts a review and blacklist keywords dialog box, in accordance with an embodiment of the present invention;

FIG. 15 depicts searching a keyword directly from the keyword data grid, in accordance with an embodiment of the present invention;

FIG. 16 depicts an interface for performing various operations on positive and negative terms, in accordance with an embodiment of the present invention;

FIG. 17 depicts the process of downloading a copy of search engine marketing campaigns, in accordance with an embodiment of the present invention;

FIG. 18 depicts the process of associating an ad group to a keyword group, in accordance with an embodiment of the present invention;

FIG. 19 depicts tools for automating the creation of high quality score text ads, in accordance with an embodiment of the present invention;

FIG. 20 depicts configuring a goal conversion, in accordance with an embodiment of the present invention;

FIG. 21 depicts publishing search optimized web content directly from the keyword group explorer, in accordance with an embodiment of the present invention;

FIG. 22 depicts exporting data into a specified format, in accordance with an embodiment of the present invention;

FIG. 23 depicts an import keywords wizard, in accordance with an embodiment of the present invention; and

FIG. 24 depicts a keywords discovery tool, in accordance with an embodiment of the present invention.

FIG. 25 depicts a flow diagram of a method relating to automated keyword discovery tools.

FIG. 26 depicts a flow diagram of a method relating to long-tail keyword visualization & analysis tools for search marketing.

FIG. 27 depicts a flow diagram of a method relating to hierarchical keyword organization tools and data model.

FIG. 28 depicts a flow diagram of a method relating to hierarchical keyword grouping tools.

FIG. 29 depicts a flow diagram of a method relating to automated, self-learning keyword grouping & segmentation suggestion tools.

FIG. 30 depicts a flow diagram of a method relating to negative keyword detection tools.

FIG. 31 depicts a flow diagram of a method relating to automated rules-based categorization and organization of keywords.

FIG. 32 depicts a flow diagram of a method relating to fully actionable via direct integration (synchronization) of keyword analysis and workbench tools with the search engines advertising platforms.

FIG. 33 depicts a flow diagram of a method relating to ad text authoring tools optimized for quality score.

FIG. 34 depicts a flow diagram of a method relating to ad text authoring tools optimized for quality score.

FIG. 35 depicts a flow diagram of a method relating to search marketing workflow tools.

FIG. 36 depicts a flow diagram of a method relating to integration with content management and web publishing systems for search engine optimization.

FIG. 37 depicts a flow diagram of a method relating to a combination of search engine marketing tools.

FIG. 38 depicts a flow diagram of a method relating to relevant keyword detection tools.

FIG. 39 depicts a flow diagram of a method relating to automatic whitelisting and blacklisting of keywords.

FIG. 40 depicts a flow diagram of a method relating to keyword analysis tools with content management for keyword-focused content authoring.

FIG. 41 depicts a flow diagram of a method relating to keyword analysis tools with content management for hyperlinking keywords in authored content.

FIG. 42 depicts a high level overview of the server facility in accordance with various embodiments of the present invention.

FIG. 43 depicts the implementation of an editor facility to author search engine friendly content in accordance with various embodiments of the present invention.

FIG. 44 depicts an exemplary full text search query operators in accordance with various embodiments of the present invention.

FIG. 45 depicts a method for suggesting relevant keyword groupings in accordance with various embodiments of the present invention.

FIG. 46 depicts a method for suggesting and prioritizing search marketing workflow for paid and natural search marketing in accordance with an embodiment of the present invention.

FIG. 47 depicts a method for parsing the data in accordance with an embodiment of the present invention.

### DESCRIPTION OF THE PREFERRED EMBODIMENTS

When advertising on the Internet was first made available around 1998, it was not initially a Pay-Per-Click system; rather, it was a pay-per-impression system. Advertisers had to contact a sales representative, come up with a list of words, and then negotiate a certain dollar amount to pay for every thousand times the advertisement was displayed, also known as a Cost Per Thousand (CPM—where M is the Roman Numeral for 1000). For example, a CPM of $20 would mean that the advertiser agreed to pay $20 for each thousand times the advertisement was displayed, regardless of whether or not a user actually clicked on the advertisement. Around 2002, the process migrated to a self-serve, Cost-Per-Click system where ad impressions became free, but clicks cost money. Advertisers could directly log into a web-based advertising system to specify their own keyword lists, write their own ads, view statistics, generate reports, pay bills, and more. The price paid by the advertisers for each click was initially determined by an auction system. Because impressions were free, advertisers could bid on just about any keyword and get their ads displayed free, regardless of relevancy. Within the next few years, a new ‘Quality Score’ based system was introduced where the price paid by the advertisers per click, minimum bids, and the relative placement of advertisements (also known as ad rank) were all proportionate to relevancy. Changes to the ‘Quality Score’ algorithms have been made over the past several years, but in general, keyword, ad group, and destination URL combinations deemed to be highly relevant are assigned higher ‘Quality Scores.’ More relevant ads could be displayed relatively higher in a list of ads if there were multiple competing ads for a particular keyword. Conversely, keyword and ad group combinations deemed to have low relevancy were assigned low ‘Quality Scores;’ these lower relevancy ads would be placed in relatively lower average positions in the event that there were more than one ad for a particular keyword search. Later in time, the search marketing engines also changed their pay-per-click advertising from pure auction-based platforms to relevancy and overall ad quality-based systems.

‘Quality Score’ based systems for determining minimum cost per click and ad rank (ad positioning) that are now employed by all major search engine companies effectively discourage the practice of bidding on non-relevant keywords by creating economic disincentives in the form of high minimum cost-per-clicks and lower ad positioning. Conversely, significant opportunities are provided for to advertisers who are willing to invest the time and effort into creating highly relevant ad and keyword groups in order to realize higher return on investment.

Despite these major changes in pricing policies of the late 90's, the tools provided by major search engine companies and third-party vendors at the time of this patent filing are similar in structure to the tools that were offered before the roll-out of the Quality Score algorithms that are currently in use today. These tools include an HTML web-based interface or desktop software application for creating ad groups, inputting keywords, writing ad copy, specifying budgets, and some other types of tools. However, the creation of high ‘Quality Score’ ad groups is still quite challenging, requiring a lot of manual work due to reasons that include, but are not limited to, lack of automated systems for campaign development, using action tracking data solely to optimize bid manipulation, deficient automated negative keyword detection tools, lack of automation tools for acting on the long-tail of search, poor support for semantically organizing keywords, poor support for authoring and publishing landing pages, lack of tools to automatically enforce best practices and simplify the creation of high quality score search marketing campaigns, disconnect between analytics/reporting and campaign management/web publishing systems, lack of integrated tools for both paid and natural search marketing, and lack of search marketing workflow tools. Each of these reasons has been explained in detail below.

There is no automated way to continuously discover and assign more specific, new keywords and keyword groupings, to create more relevant ad groups, and author more relevant ad text and destination URLs. It should be understood that throughout this specification, the term “keyword” may include one or more terms that can be used as part of a query that can retrieve a web resource; that is, a keyword may encompass not just a single word, but a phrase that has several terms in it.

There is no automated system that leverages the keyword action-tracking data for the purposes of automatically improving ‘Quality Score.’ Specifically, the data that arises from the various action-tracking analytics applications available today which provide a means of associating actual keyword searches arising from either paid or natural search engine marketing to real outcomes, such as a completed sale, downloads or other desirable conversion in terms of lead generation efforts, are currently widely used by automated bid-management software systems for the purposes of raising or lowering Maximum Bids. An alternative and potentially more productive usage for this very same action-tracking data would be to automatically identify important keywords and to automatically suggest the creation of more relevant keywords, closely-related keyword groupings (keyword segmentations), negative keywords, relevant ad text, and destination URL's which in turn lends itself to higher ‘Quality Score’ and thus, lower minimum bids, and relatively higher ad rank. In addition, there may be an automatic workflow (i.e., a relative prioritization of tasks based on importance) for the aforementioned campaign optimization methods based on the notion that a search marketer should focus optimization efforts on productive (i.e., goal-producing) keyword groupings rather than non-productive (i.e., non-goal-producing) keyword groupings.

There is a lack of automated tools for automatically discovering and setting Negative Keywords, which may be an important means for improving Click-Through-Rate and thereby enhancing ‘Quality Score.’

Further, there may be a lack of a programmatic way of both visualizing and seamlessly acting on keyword data and properties contained in the ‘long tail’ of keywords (a statistical distribution of all of the different keywords used by visitors to find an organization's website, graphed using keyword frequency as the y-axis, and individual keywords on the x-axis, ordered from most popular keywords to least popular). For example, long-tail keyword grouping and organization better optimize and inform both paid and natural search optimization efforts.

There is no way to easily create hierarchical groupings of semantically-related keywords, which is also a requirement for creating high ‘Quality Score’ paid search engine marketing campaigns.

Search engine advertising platforms require that advertisers create highly relevant destination URLs, yet there is little in the way of integrated tools support to programmatically assist advertisers with their creation.

In general, the search engine campaign management tools provide a blank slate for creating ad campaigns; advertisers can create ad groups consisting of any combination of keywords, ad copy, and destination URLs. The use of these tools by less-knowledgeable operators can often result in ads with low ‘Quality Score.’Further, there are no tools to automate and enforce the various best practices that result in the creation of predictably high ‘Quality Score’ campaigns.

While search engines provide the ability to create reports to view trends and other important statistics, the reports themselves are not immediately actionable. An advertiser often needs to first schedule and run a particular report, mentally analyze and synthesize the results, then log back into the search engine campaign management tools to manually make changes (i.e., the back and forth between the static analytics contained in the reports and the dynamic campaign management applications can consume considerable time and effort and often results in a failure to act on the analytics data contained in search marketing reports.)

Organizations need to dedicate time and effort on both paid search marketing and natural search marketing work, yet search engines only provide tools for interacting with these on their own search engine marketing platform. Vendors of third-party tools provide Paid Search Engine Marketing tools that work across different paid search engine marketing platforms but do not provide integrated tools for simplifying and automating natural search marketing work. The lack of a unified and automated software system for paid and natural search means that users do not realize the benefits of fundamental synergies that exist between natural search and paid search marketing, which results in decreased Return on Investment (ROI). For example, keyword data gleaned from paid search engine marketing activities can be leveraged to inform and optimize natural search engine marketing efforts, and vice versa.

There is potentially an unlimited amount of work that can go into creating and optimizing high ‘Quality Score’ search engine advertising campaigns because there is really no limit to the amount of work that can be put into the creation and optimization of advertising campaigns; yet there is a lack of workflow tools to clearly show search marketing professionals specifically where they should dedicate their limited time and efforts to achieve the greatest return for time spent on optimization.

In light of the above discussion, methods and systems are disclosed that facilitate browsing and manipulation of keyword data with the help of search engine marketing tools and expert workflow solutions.

Various embodiments of the present invention provide a keyword exploration facility 112 which is data-driven and is a Rich Interactive Application (RIA) that may work in any web browser that supports Flash technologies or other dynamic animation compilation facilities, providing search engine marketing tools and expert workflow systems to automate and prioritize the tasks involved in building and optimizing Paid Search and Natural Search activities.

The keyword exploration facility 112 may consist of keyword generation, analysis and organization tools which may be seamlessly integrated with search engine marketing platforms and web publishing systems, providing a search marketer with a dynamic and highly actionable platform for engaging in various paid and natural search marketing activities. This application may automate the discovery of new keywords and provide various integrated keyword analysis and organization tools. The data contained in organized keyword groups may be seamlessly leveraged in a variety of different ways. For example, the search marketer could automate the creation and continuous optimization of high ‘Quality Score’ paid Search Engine Marketing (SEM) campaigns in order to improve ROI on search engine marketing spending. Further, the search marketer may automate the publishing of Search Engine Optimized (SEO) web pages which are designed to rank highly in natural search results for popular keywords in order to drive more traffic to an organization's web site. In addition, the marketer may automate or optimize other SEO, SEM, and Web marketing applications.

The keyword exploration facility 112 may gather and analyze historical keyword data to recommend one or more courses of action for the user to follow (i.e., an optimal workflow) in order to grow and optimize an organization's search engine marketing efforts. The recommended workflow may be based on an algorithm that may combine various paid and natural search marketing best practices, and user preferences which may reflect the operator's search marketing objectives. This may lead the paid or natural search engine marketing campaigns to an optimized state and may generate more web traffic and other actionable data points. Further, the additional data may be repeatedly analyzed and acted upon, generating additional actionable data for each subsequent iteration. Because the facility workflow suggestions are driven in part based on analytics data, the statistical accuracy of the recommended workflow as well as the automation provided by the search marketing automation tools may continuously improve over time.

The keyword exploration facility 112 may be a data-driven Rich-Internet-Application that provides a dynamic, self-learning suite of actionable search marketing tools that provide an operator with a high degree of productivity and automation, as well as software workflow tools for prioritizing the endless work involved in developing and optimizing both paid and natural search engine marketing campaigns. The effectiveness of both the productivity tools and suggested workflow constantly improves over time.

If regularly acted upon, this application may provide both the tools and workflow to perpetually grow and optimize paid and natural search engine marketing efforts, resulting in perpetual website traffic growth.

In accordance with the embodiments of the present invention, a new type of search engine campaign development tool is provided to meet the challenges of creating and continuously building, growing, and optimizing high ‘Quality Score’ search engine marketing campaigns in a way that automates repetitive tasks, enforces best practices and thereby increases ROI, provides an optimal workflow to maximize the impact of time spent working on campaign optimization, and works in co-operation with an organization's natural search marketing efforts. This described exploration facility may provide numerous key features such as automated keyword discovery, long-tail keyword visualization & analysis tools for search marketing, hierarchical keyword organization tools and data model, hierarchical keyword grouping, automated self-learning keyword grouping & segmentation suggestion, negative keyword detection, automated rule-based categorization of keywords, fully actionable via direct integration (synchronization) of keyword analysis, ad text authoring tools optimized for quality score, and search marketing workflow tools, each of which is described in detail below.

Keyword exploration facility 112 may automate the time-consuming process of finding large volumes of keywords that are specifically relevant to an organization's business activities. Server facility 102 may analyze the keyword data contained in Web server log files, including Microsoft Internet Information Server (IIS), Apache Web Server, and other Web servers. It may parse out user search queries in any language, along with other relevant information, and store the data in a highly-efficient, embedded flat file database.

In another embodiment, live keyword data streams may be dynamically sent to the server facility 102 by adding a snippet of JavaScript code on an organization's website. For example, whenever a visitor finds the website through search, the keyword used by the searcher may be automatically transmitted in real-time to the server facility 102 for subsequent data processing. A scheduled update may run periodically, processing all the new keywords that were used by the website visitors in order to find the organization's Web site since the last system update; therefore, new keywords may be constantly discovered, and the keyword database may keep growing automatically every day. Additionally, the keyword exploration facility 112 may provide integrated keyword reviewing tools, enabling a search marketer to review and either accept or reject the newly discovered keywords, and to optionally set rules by either black-listing or white-listing certain keywords to automate the acceptation or rejection of certain keywords with discriminating characteristics (i.e., keyword tokens or strings that are deemed to be obviously relevant or obviously irrelevant to an organization's activities).

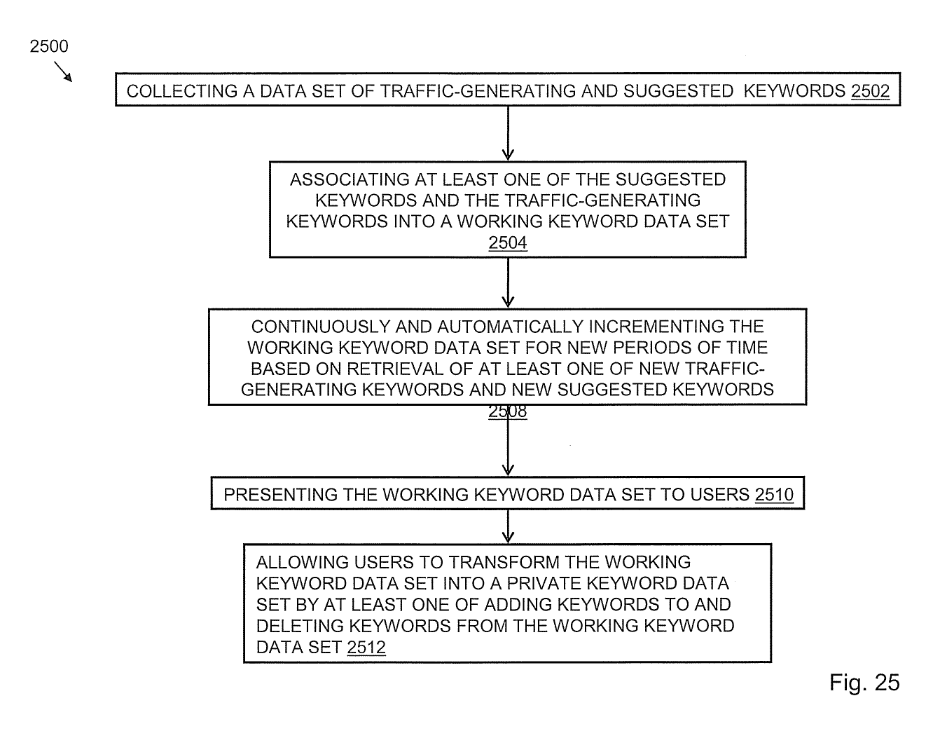

Referring to FIG. 25, a method for generating a private keyword data set adapted for use in a workflow associated with at least one of search engine marketing and search engine optimization is depicted in a flow diagram. In an embodiment, the keyword discovery tools may be automated, continuous, and integrated. The keyword discovery tools may relate to a computer-implemented method applicable to a computer facility adapted to facilitate a workflow for at least one of search engine optimization and search engine marketing may include collecting a data set of traffic-generating keywords, the traffic-generating keyword data set representing keywords used to access a web resource during different periods of time, and collecting a data set of suggested keywords 2502, associating at least one of the suggested keywords and the traffic-generating keywords into a working keyword data set 2504, continuously and automatically incrementing the working keyword data set for new periods of time based on retrieval of at least one of new traffic-generating keywords and new suggested keywords 2508, and presenting the working keyword data set to users 2510, thereby allowing users to transform the working keyword data set into a private keyword data set by at least one of adding keywords to and deleting keywords from the working keyword data set 2512, the private keyword data set being adapted for use in a workflow associated with at least one of search engine marketing and search engine optimization. In forming the working keyword data set, it is optional to associate both suggested keywords and traffic-based keywords. In some embodiments, only one set of keywords may be needed to form the working keyword data set. The keyword discovery tools may further include grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The keyword discovery tools may further include allowing user-definition of rules that automatically govern at least one of addition of new keywords to keyword groups, deletion of keywords from the working keyword data set, and grouping of keywords into keyword groups.

The keyword discovery tools may embodied in a system adapted to facilitate a workflow for at least one of search engine optimization and search engine marketing which may include a data collection facility for collecting a data set of traffic-generating keywords, the traffic-generating keyword data set representing keywords used to access a web resource during different periods of time, and a data set of suggested keywords, a processor for associating at least one of the suggested keywords and the traffic-generating keywords into a working keyword data set and continuously and automatically incrementing the working keyword data set for new periods of time based on retrieval of at least one of new traffic-generating keywords and new suggested keywords, and a presentation facility for presenting the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization. In some embodiments, the data collection facility, processor, and presentation facility may be embodied in a single unit while in other embodiments they may be embodied as separate components of a distributed system. In the system, the processor may group keywords in the working keyword data set into a plurality of multi-dimensional, hierarchical keyword groups, wherein at least some keyword groups are segmented into sub-groups, and enables users to add keywords to and delete keywords from keyword groups and sub-groups. The system may further include user-defined rules that automatically govern at least one of addition of new keywords to keyword groups, deletion of keywords from the working keyword data set, and grouping of keywords into keyword groups.

The keyword exploration facility 112 may provide visual browsing of the keyword data indexed in the server facility 102. Keyword frequency distribution patterns may typically conform to a ‘long tail’ distribution pattern.

In accordance with an embodiment of the present invention, the keyword exploration facility 112 may be a data-driven Rich Internet Application (RIA), providing a highly interactive, Web-browser-based client interface based on Adobe Flash and Flex technologies, or another dynamic animation compilation facility, that is significantly more advanced than those based on HTML and JavaScript alone, and is designed for analyzing and acting on keyword data in real-time. The exploration facility 112 may include keyword visualization features such as advanced data display and visualization options, including the ability to scroll back and forth to view different sections of the ‘long tail’ keyword distributions either by scrolling a mouse wheel or displacing a horizontal scroll widget, the ability to zoom into or out of a particular section of a ‘long tail’ of keywords, browsing capabilities including the ability to navigate backwards and forwards throughout the keyword analysis process, just like a Web browser, and the ability to query one or more groupings of keywords based on a full-text search expression. Further, the exploration facility 112 may be provided with an ability to filter out keywords based on a specified date range, the length of the keyword phrase, the minimum keyword frequency, the nature of the keyword, a minimum or maximum dollar amount spent per keyword, if the keyword was a result of paid search, a minimum or maximum page depth corresponding to how deep into the natural search engine results pages the user was searching when they clicked on the search result which led to their visit, different data visualization options for viewing conversion data (i.e., what keywords produced what user-defined conversions or goals (e.g.: completed sales, product downloads, email signup, etc.)), high scalability and low-latency for data query and processing operations, supporting multi-threaded query fetching and real-time display processing, an integrated, configurable data grid view that displays keyword information including keyword frequency, state, and other metrics, supporting copy & paste, and a variety of data export options.

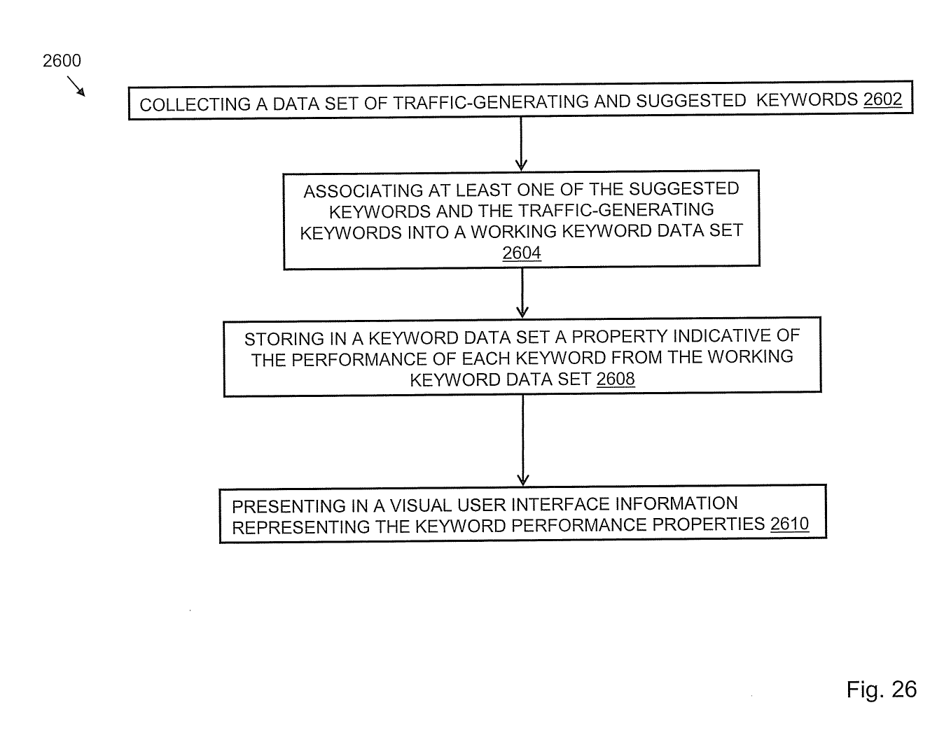

Referring to FIG. 26, a method for facilitating analysis as to what keywords should be used to optimize at least one of search engine results and search engine marketing for a website is depicted in flow diagram form. The method may relate to long-tail keyword visualization and analysis tools. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 2602, associating at least one of the suggested keywords and the traffic-generating keywords into a working keyword data set 2604, storing in a keyword data set a property indicative of the performance of each keyword from the working keyword data set 2608, and presenting in a visual user interface information representing the keyword performance properties 2610, thereby facilitating analysis as to what keywords should be used to optimize at least one of search engine results and search engine marketing for the website. In forming the working keyword data set, it is optional to associate both suggested keywords and traffic-based keywords. In some embodiments, only one set of keywords may be needed to form the working keyword data set. In the method, the performance property is selected from the group consisting of the frequency with which a keyword is used to access a web resource, the frequency that a desired action is undertaken by a user who has accessed the web resource by using the keyword, the historical value of actions taken by users who have accessed by web resource by using the keyword and the expected value of future actions that are predicted to be taken by users who have accessed the resource using the keyword. The method may further comprising grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The method may further comprise allowing user-definition of rules that automatically govern at least one of addition of new keywords to keyword groups, deletion of keywords from the working keyword data set, and grouping of keywords into keyword groups. The method may further comprise allowing users to transform the working keyword data set into a private keyword data set by at least one of adding keywords to and deleting keywords from the working keyword data set, the private keyword data set being adapted for use in a workflow associated with at least one of search engine marketing and search engine optimization.

The long-tail keyword visualization and analysis tools may be embodied in a system adapted to facilitate a workflow for at least one of search engine optimization and search engine marketing. The system may include a data collection facility for collecting a data set of traffic-generating keywords, the traffic-generating keyword data set representing keywords used to access a web resource during different periods of time and a data set of suggested keywords, a processor for associating at least one of the suggested keywords and the traffic-generating keywords into a working keyword data set, a memory facility for storing in a keyword data set a property indicative of the performance of each keyword from the working keyword data set, and a visual user interface for presenting information representing the keyword performance properties, thereby facilitating analysis as to what keywords should be used to optimize at least one of search engine results and search engine marketing for the website. In some embodiments, the data collection facility, processor, memory facility and visual user interface may be embodied in a single unit while in other embodiments they may be embodied as separate components of a distributed system. In the system, the performance property may be selected from the group consisting of the frequency with which a keyword is used to access a web resource, the frequency that a desired action is undertaken by a user who has accessed the web resource by using the keyword, the historical value of actions taken by users who have accessed by web resource by using the keyword and the expected value of future actions that are predicted to be taken by users who have accessed the resource using the keyword. In the system, the processor may group keywords in the working keyword data set into a plurality of multi-dimensional, hierarchical keyword groups, wherein at least some keyword groups are segmented into sub-groups, and enables users to add keywords to and delete keywords from keyword groups and sub-groups. The system may further include user-defined rules that automatically govern at least one of addition of new keywords to keyword groups, deletion of keywords from the working keyword data set, and grouping of keywords into keyword groups. In the system, the processor may enable users to transform the working keyword data set into a private keyword data set by at least one of adding keywords to and deleting keywords from the working keyword data set, the private keyword data set being adapted for use in a workflow associated with at least one of search engine marketing and search engine optimization.

Some search engine advertising platforms only support a single level of nesting when it comes to organizing Pay-Per-Click campaigns. For example, Google™ AdWords requires that a campaign consists of one or more Ad Groups, but Ad Groups cannot have sub-groups. Microsoft Excel™, which is widely used for keyword organization work, may be sub-optimal because it is disconnected from the Google AdWords or other search engine marketing systems, thus the data contained in the spreadsheet may not automatically be a live data feed, nor is the data immediately actionable, and it relies on tabular data structures (which consist of rows and columns). The tabular data structures are not well suited for organizing keyword taxonomies because they are hierarchical in structure. For example, an online Pet Store might sell products related to “birds,” “dogs” “cats,” “fish,” etc. Within the “cat” category, there may be many sub-categories, including “cat food,” “cat litter,” “cat toys,” “cat collars,” etc. And within any one of these sub-categories, say for example, the “cat food” category, there could be hundreds of additional sub-categories, including different brands of cat foods, different types of cat food—“canned” or “dry” cat food; cat food for “young” or “old” cats; etc.

Keyword exploration facility 112 may let users visualize all the available keyword data, and then visually organize keywords into keyword groups (a grouping of semantically related keywords) in a tree-like hierarchy of unlimited depth. The hierarchical keyword groupings can then be mapped to the tabular data model employed by search engine marketing systems. Keyword exploration facility 112 may let users create ad campaigns and ad groups by selecting different keyword groups from a user-defined taxonomy hierarchy consisting of a tree of nested keyword groups, and then associating the keywords belonging to the selected keyword group for use as keywords in a new or existing Ad Group.

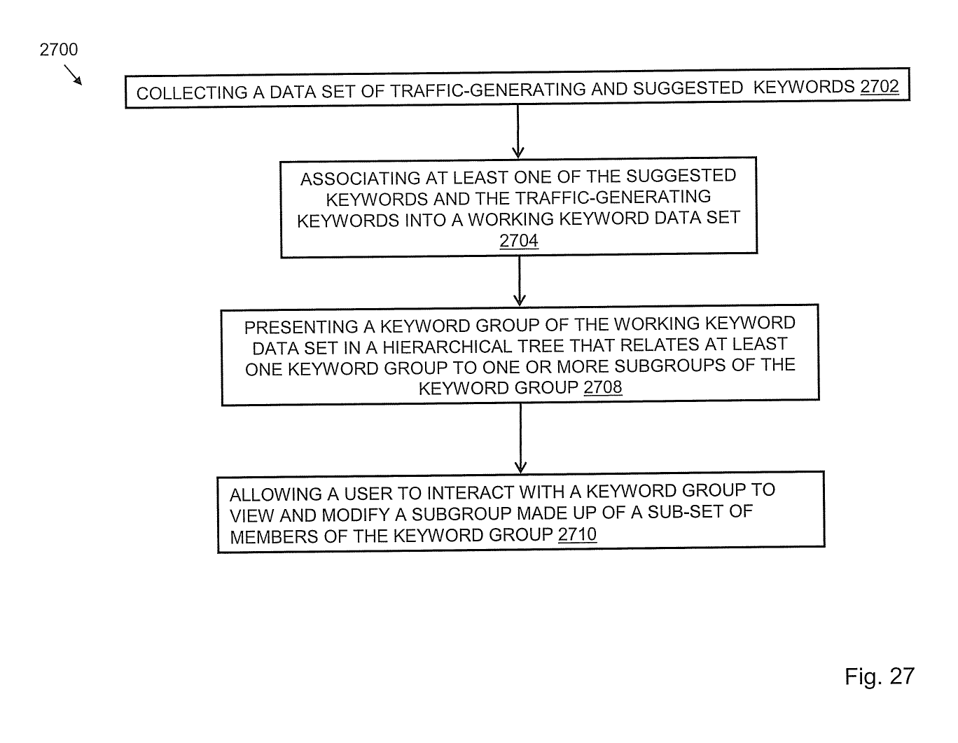

Referring to FIG. 27, a method of the hierarchical keyword organization tools and data model is depicted in a flow diagram. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 2702, associating at least one of the suggested keywords and the traffic-generating keywords into a working keyword data set 2704, presenting a keyword group of the working keyword data set in a hierarchical tree that relates at least one keyword group to one or more subgroups of the keyword group 2708, and allowing a user to interact with a keyword group to view and modify a subgroup made up of a sub-set of members of the keyword group 2710. In forming the working keyword data set, it is optional to associate both suggested keywords and traffic-based keywords. In some embodiments, only one set of keywords may be needed to form the working keyword data set. In the method, at least one subgroup may be further segmented into additional sub-groups.

The hierarchical keyword organization tools and data model may be embodied in a system adapted to facilitate a workflow for at least one of search engine optimization and search engine marketing may include a data collection facility for collecting a data set of traffic-generating keywords, the traffic-generating keyword data set representing keywords used to access a web resource during different periods of time and a data set of suggested keywords, a processor for associating at least one of the suggested keywords and the traffic-generating keywords into a working keyword data set, a presentation facility for presenting a keyword group of the working keyword data set in a hierarchical tree that relates at least one keyword group to one or more subgroups of the keyword group, and a user interface for allowing a user to interact with a keyword group to view and modify a subgroup made up of a sub-set of members of the keyword group. In some embodiments, the data collection facility, processor, presentation facility, and user interface may be embodied in a single unit while in other embodiments they may be embodied as separate components of a distributed system. In the system, at least one subgroup may be further segmented into additional sub-groups.

Keyword exploration facility 112 may provide the ability to organize keywords by enabling the search marketer to group together keywords deemed to be related. Keyword grouping may involve the ‘Long-Tail Keyword Visualization & Analysis Tools for Search Marketing’ which may enable the user to specify setting various rules (i.e., keyword properties) and running these rules against the large volumes of keywords created by the aforementioned ‘Automated Keyword Discovery Tools,’ to determine the set of all known keywords which satisfy all the user-specified rules. Additionally, keyword exploration facility 112 may enable the search marketer to leverage the aforementioned ‘Hierarchical Keyword Organization Tools and Data Model’ to intuitively save and organize keyword groups in an efficient manner that preserves the hierarchical relationships between related keyword groups.

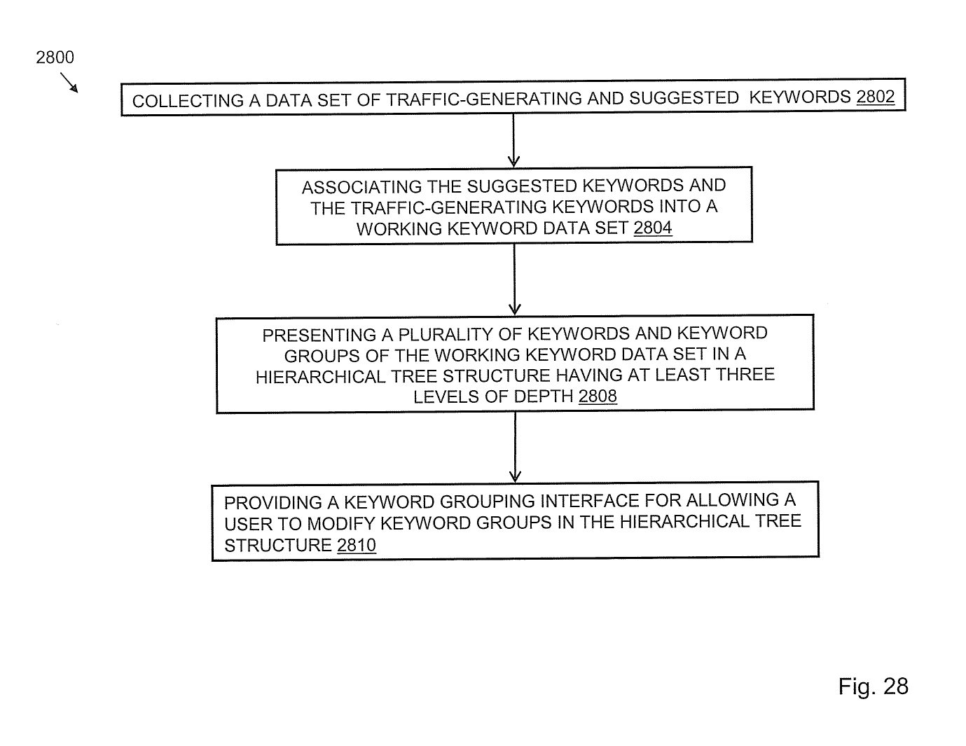

Referring to FIG. 28, a method relating to the hierarchical keyword grouping tools is depicted in a flow diagram. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 2802, associating at least one of the suggested keywords and the traffic-generating keywords into a working keyword data set 2804, presenting a plurality of keywords and keyword groups of the working keyword data set in a hierarchical tree structure having at least three levels of depth 2808, and providing a keyword grouping interface for allowing a user to modify keyword groups in the hierarchical tree structure 2810. In forming the working keyword data set, it is optional to associate both suggested keywords and traffic-based keywords. In some embodiments, only one set of keywords may be needed to form the working keyword data set.

The hierarchical keyword grouping tools may be embodied in a system adapted to facilitate a workflow for at least one of search engine optimization and search engine marketing. The system may include a data collection facility for collecting a data set of traffic-generating keywords, the traffic-generating keyword data set representing keywords used to access a web resource during different periods of time and a data set of suggested keywords, a processor for associating at least one of the suggested keywords and the traffic-generating keywords into a working keyword data set, a presentation facility for presenting a plurality of keywords and keyword groups of the working keyword data set in a hierarchical tree structure having at least three levels of depth, and a keyword grouping interface for allowing a user to modify keyword groups in the hierarchical tree structure. In some embodiments, the data collection facility, processor, presentation facility, and keyword grouping interface may be embodied in a single unit while in other embodiments they may be embodied as separate components of a distributed system.

In addition to providing tools to enable users to create keyword groups based on a user's analysis of a stream of keywords based on various keyword properties, keyword exploration facility 112 may provide automated tools that automatically suggest relevant keyword groupings by programmatically analyzing keyword data for commonly occurring keywords (including common mis-spellings, plurals, and similar keyword variations), and also based on user-defined keyword properties (such as goal conversions) deemed to be important by the search marketer, as well as property-specific weightings to indicate the relative importance of each of those keyword properties. The automated keyword grouping tools may suggest how to group together un-categorized keyword data, and how to segment (i.e., break-up, for better organizing) larger keyword groups into smaller, more targeted, and relevant keyword groupings.

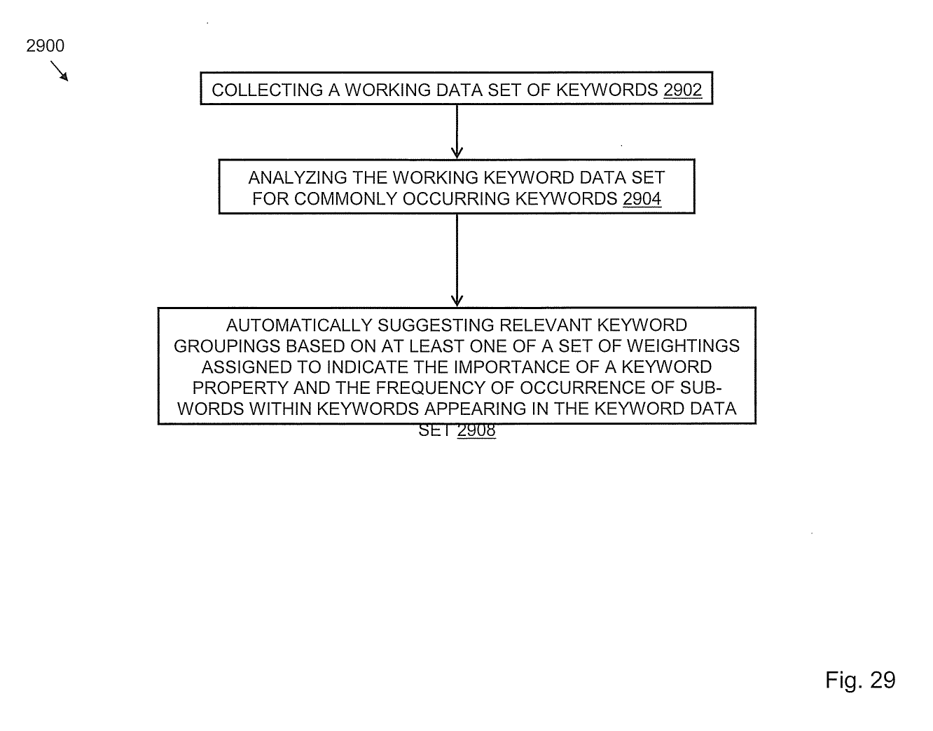

Referring to FIG. 29, a method relating to automated, self-learning keyword grouping and segmentation suggestion tools is depicted in a flow diagram. The computer-implemented method may be applicable to a computer facility adapted to facilitate a workflow for at least one of a search engine optimization campaign and a search engine marketing campaign. The method may include collecting a working data set of keywords 2902, analyzing the working keyword data set for commonly occurring keywords 2904, and automatically suggesting relevant keyword groupings based on at least one of a set of weightings assigned to indicate the importance of a keyword property and the frequency of occurrence of sub-words within keywords appearing in the keyword data set 2908. The method may further include applying a self-learning module to adjust the weightings used to automatically suggest keyword groupings. In the method, the weightings may be user-defined. The method may further include grouping keywords in the working keyword data set into a plurality of multi-dimensional, hierarchical keyword groups, wherein at least some keyword groups are segmented into sub-groups, and allowing users to add keywords to and delete keywords from keyword groups and sub-groups. The method may further include allowing user-definition of rules that automatically govern at least one of addition of new keywords to keyword groups, deletion of keywords from the working keyword data set, and grouping of keywords into keyword groups. The method may further include allowing users to transform the working keyword data set into a private keyword data set by at least one of adding keywords to and deleting keywords from the working keyword data set, the private keyword data set being adapted for use in a workflow associated with at least one of search engine marketing and search engine optimization. The method may further include collecting a data set of traffic-generating keywords, the traffic-generating keyword data set representing keywords used to access a web resource during different periods of time; collecting a data set of suggested keywords; and associating the suggested keywords and the traffic-generating keywords to form the working keyword data set.

The automated, self-learning keyword grouping and segmentation suggestion tools may be embodied in a system adapted to facilitate a workflow for at least one of a search engine optimization campaign and a search engine marketing campaign may include a data collection facility for collecting a working data set of keywords, a processor for analyzing the working keyword data set for commonly occurring keywords and automatically suggesting relevant keyword groupings based on at least one of a set of weightings assigned to indicate the importance of a keyword property and the frequency of occurrence of sub-words within keywords appearing in the keyword data set. In some embodiments, the data collection facility and processor may be embodied in a single unit while in other embodiments they may be embodied as separate components of a distributed system. The system may further include a self-learning module to adjust the weightings used to automatically suggest keyword groupings. In the system, the weightings may be user-defined. In the system, the processor groups keywords in the working keyword data set into a plurality of multi-dimensional, hierarchical keyword groups, wherein at least some keyword groups are segmented into sub-groups, and allowing users to add keywords to and delete keywords from keyword groups and sub-groups. The system may further include user-defined rules that automatically govern at least one of addition of new keywords to keyword groups, deletion of keywords from the working keyword data set, and grouping of keywords into keyword groups. In the system, the processor enables users to transform the working keyword data set into a private keyword data set by at least one of adding keywords to and deleting keywords from the working keyword data set, the private keyword data set being adapted for use in a workflow associated with at least one of search engine marketing and search engine optimization. In the system, the data collection facility is used to collect a data set of traffic-generating keywords, the traffic-generating keyword data set representing keywords used to access a web resource during different periods of time; collecting a data set of suggested keywords; and associating at least one of the suggested keywords and the traffic-generating keywords to form the working keyword data set.

Negative Keywords may be a component of building a successful keyword list and PPC campaign optimization, especially for search engine advertising platforms (search engine marketing). Specifying one or more negative keywords to an ad group or campaign means that your ads will not show for keyword searches containing those keywords. By filtering out unwanted ‘Impressions and Clicks,’ negative keywords can help search marketers reach the most appropriate prospects, which can result in improved ROI due to optimization of limited search marketing advertising budget, improved Click-Through-Rates, reduced Cost-Per-Click (CPC), and improved ad rank.

Various embodiments of the present invention may provide three types of negative keyword tools: ‘Rules-based Keyword Reviewing,’ ‘Negative and Positive Keyword Generation,’ and Negative Keyword Workflow Tools.

The ‘Rules-based Keyword Reviewing’ tools may help a search marketer to quickly review keyword lists for relevancy and to make the keyword review process in a perpetual, on-going effort wherein negative keywords are constantly being discovered and set. Similarly, the ‘Negative and Positive Keyword Generation’ tool may automatically analyze keyword data to suggest both relevant and irrelevant terms, further optimizing keyword lists and simplifying the keyword reviewing process. Further, the ‘Negative Keyword Workflow’ tools may help prioritizing where negative keyword discovery efforts should be prioritized, in order to maximize potential ROI from campaign optimization.

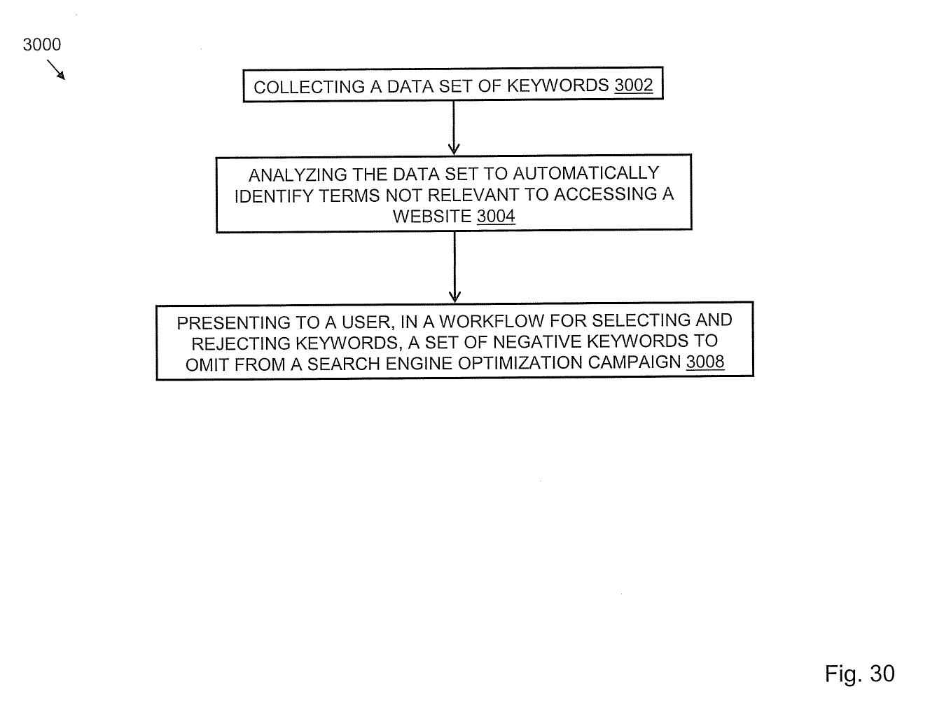

Referring to FIG. 30, a method relating to negative keyword detection tools is depicted in a flow diagram. The computer-implemented method may be applicable to a computer facility adapted to facilitate a workflow for at least one of a search engine optimization campaign and a search engine marketing campaign. The method may include collecting a data set of keywords 3002, analyzing the data set to automatically identify terms not relevant to accessing a website 3004, and presenting to a user, in a workflow for selecting and rejecting keywords, a set of negative keywords to omit from a search engine optimization campaign 3008.

The negative keyword detection tools may be embodied in a system adapted to facilitate a workflow for at least one of a search engine optimization campaign and a search engine marketing campaign may include a data collection facility for collecting a data set of keywords, a processor for analyzing the data set to automatically identify terms not relevant to accessing a website, and a presentation facility for presenting to a user, in a workflow for selecting and rejecting keywords, a set of negative keywords to omit from a search engine optimization campaign. In some embodiments, the data collection facility, processor, and presentation facility may be embodied in a single unit while in other embodiments they may be embodied as separate components of a distributed system.

The process of working with keywords may involve reviewing a list of keywords. The keyword list may comprise relevant keywords and irrelevant keywords, using relevant terms and irrelevant terms. For example, if you are selling pet products, the term “kitty” might be relevant, while the term “Hello Kitty” may not be because it typically relates to a line of children's products. In conventional tools, a user may go through manually to figure out what should be left out of the working keyword list. In the methods and systems described herein, the system may segment a working keyword list into subsets of keywords that use the most commonly occurring words and phrases (e.g., the relevant term “litter” might show up 50 times, while the irrelevant term “hello” may show up 200 times). Rather than requiring a user to manually review the entire list, the user can review a subset of the working keyword list, because the same terms or tokens that show up over and over again can be associated with large groups of keywords that use those terms. The methods and systems disclosed herein may therefore allow a user to white list or black list those commonly occurring terms. A black list is for terms that are obviously bad in some way. For example, the presence of “hello” in any keywords for pet products may lead a user to conclude that whatever the keyword phrase is, the presence of “hello” is an indicator that the keyword should not be used. The black list can then be used to automatically trim a working keyword group for review, so that every instance of a keyword in a keyword list containing that word can be filtered out before manual review, dramatically reducing the time required to review a working group of keywords. Similarly, a user may white list a keyword that is discriminating in a positive sense, such as the word “litter,” which makes it very likely that the keyword has something to do with cats. The user can white list the term litter, in which case the method and systems disclosed herein can automatically include in a keyword group any keyword that that contains the term “litter.” As with the black list, this white list reduces the size of the working keyword data set that needs manual review. Thus, defining positive and negative keyword terms helps reduce a working keyword data set by automatically black listing or white listing words. Those keywords may be removed from a data set of keywords that needs to be reviewed.

Page:

Based on terms previously blacklisted or whitelisted terms, additional terms for either list may be suggested by the system. The methods and systems may analyze words that the user may have previously rejected. If a word such as “Purina” or “cat” shows up after the term “litter” has been whitelisted, then the system may suggest “Purina” or “cat” as additional whitelist terms. Similarly, the system may perform an analysis of blacklisted terms after a term such as “hello” has been added to the blacklist, as in the example above. Other keywords associated with “hello” that continue to show up, such as “cellphone accessories” or “pencil case”, may be suggested for blacklisting.

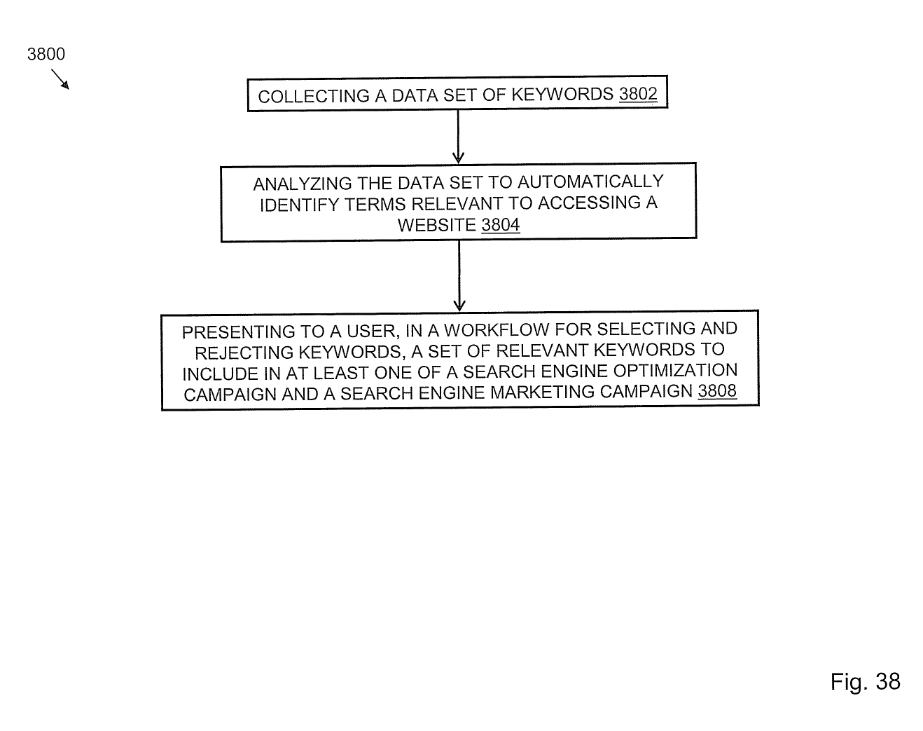

Referring to FIG. 38, a method relating to relevant keyword detection tools is depicted in a flow diagram. The computer-implemented method may be applicable to a computer facility adapted to facilitate a workflow for at least one of a search engine optimization campaign and a search engine marketing campaign. The method may include collecting a data set of keywords 3802, analyzing the data set to automatically identify terms relevant to accessing a website 3804, and presenting to a user, in a workflow for selecting and rejecting keywords, a set of relevant keywords to include in at least one of a search engine optimization campaign and a search engine marketing campaign 3808.

The relevant keyword detection tools may be embodied in a system adapted to facilitate a workflow for at least one of a search engine optimization campaign and a search engine marketing campaign. The system may include a data collection facility for collecting a data set of keywords, a processor for analyzing the data set to automatically identify terms relevant to accessing a website, and a presentation facility for presenting to a user, in a workflow for selecting and rejecting keywords, a set of relevant keywords to include in at least one of a search engine optimization campaign and a search engine marketing campaign. In some embodiments, the data collection facility, processor, and presentation facility may be embodied in a single unit while in other embodiments they may be embodied as separate components of a distributed system.

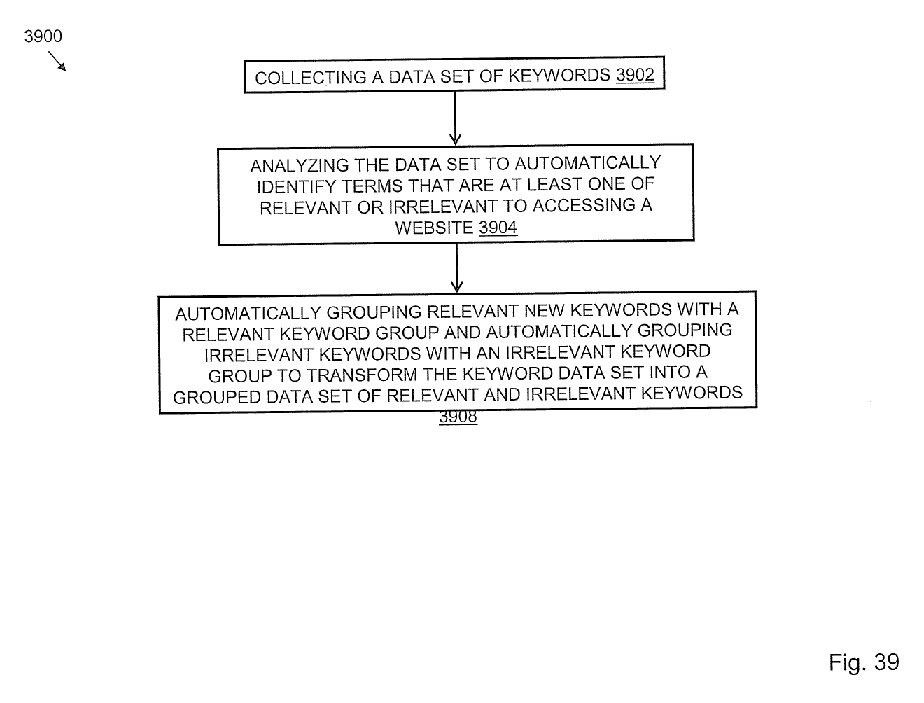

Referring to FIG. 39, a method relating to automatic whitelisting and blacklisting of keywords is depicted in a flow diagram. The computer-implemented method may be applicable to a computer facility adapted to facilitate a workflow for at least one of a search engine optimization campaign and a search engine marketing campaign. The method may include collecting a data set of keywords 3902, analyzing the data set to automatically identify terms that are at least one of relevant or irrelevant to accessing a website 3904, and automatically grouping relevant new keywords with a relevant keyword group and automatically grouping irrelevant keywords with an irrelevant keyword group to transform the keyword data set into a grouped data set of relevant and irrelevant keywords 3908. The method may further include allowing a user to define a rule set by which a keyword is grouped with a keyword group according to a relevance of the keyword.

Automatic whitelisting and blacklisting of keywords may be embodied in a system adapted to facilitate a workflow for at least one of a search engine optimization campaign and a search engine marketing campaign. The system may include a data collection facility for collecting a data set of keywords, a processor for analyzing the data set to automatically identify terms that are at least one of relevant or irrelevant to accessing a website, and a processor for automatically grouping relevant new keywords with a relevant keyword group and automatically grouping irrelevant keywords with an irrelevant keyword group to transform the keyword data set into a grouped data set of relevant and irrelevant keywords. The system may further include a rules server to store a user-defined rule set by which a keyword is grouped with a keyword group according to a relevance of the keyword. In some embodiments, the data collection facility, processor, and presentation facility may be embodied in a single unit while in other embodiments they may be embodied as separate components of a distributed system

Keyword organization and categorization is an important and time consuming component of search marketing. The aforementioned automated keyword discovery mechanism may result in a constant flow of new keyword data. This steady stream of new keyword data is automatically organized and categorized according to user-defined rules that may be set using the aforementioned keyword grouping tools and negative keyword tools. Newly discovered keywords that match rules (i.e., the keyword properties) for one or more existing keyword groups may be automatically categorized by means of being associated with those keyword group(s). An equally important component of keyword organization and categorization may involve deleting irrelevant keywords, and so newly discovered keywords that match existing negative keyword filters set by the aforementioned negative keyword detection tools may be categorized by virtue of having them removed automatically.

Keyword exploration facility 112 may provide an intuitive user interface for accepting/rejecting the newly discovered and categorized keywords. The newly organized keyword data can then be automatically acted on in a variety of different ways to optimize both paid and natural search engine marketing.

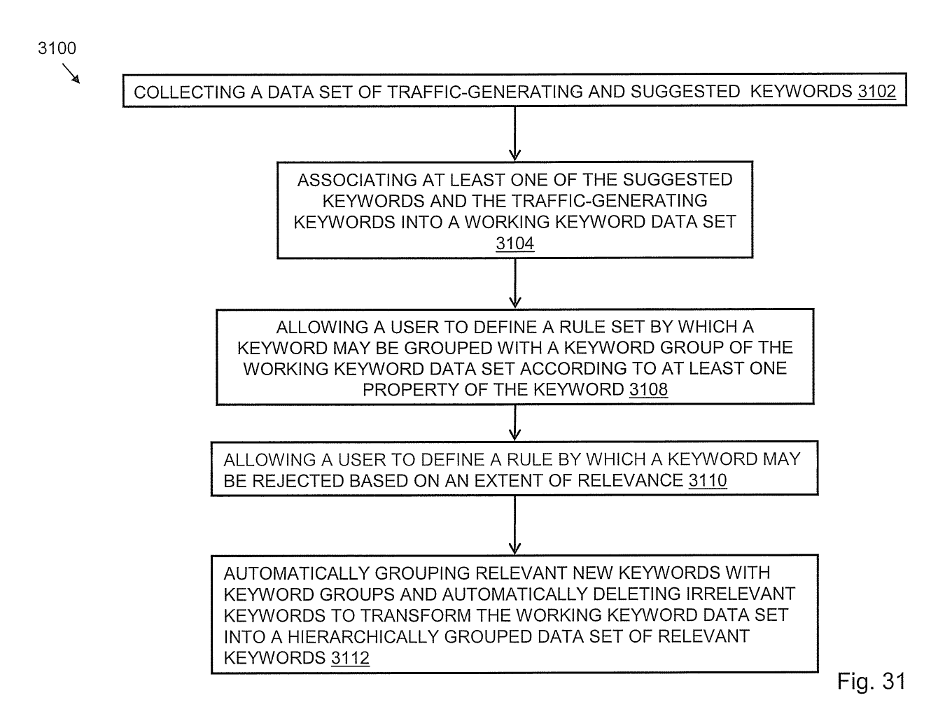

Referring to FIG. 31, a method relating to automated rules-based categorization of keywords is depicted in the flow diagram. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 3102, associating at least one of the suggested keywords and the traffic-generating keywords into a working keyword data set 3104, allowing a user to define a rule set by which a keyword may be grouped with a keyword group of the working keyword data set according to at least one property of the keyword 3108, allowing a user to define a rule by which a keyword may be rejected based on an extent of relevance 3110, and automatically grouping relevant new keywords with keyword groups and automatically deleting irrelevant keywords to transform the working keyword data set into a hierarchically grouped data set of relevant keywords 3112. In forming the working keyword data set, it is optional to associate both suggested keywords and traffic-based keywords. In some embodiments, only one set of keywords may be needed to form the working keyword data set. In the method, the property used to group a keyword with a keyword grouping may be selected from the group consisting of what words the keyword contains, what words the keyword does not contain, traffic derived from the keyword, the number of terms in the keyword, and the achievement of an objective based on use of the keyword by users to access the web resource. The method may further include providing a facility for highlighting new keywords in the working keyword data set. The method may further include providing a keyword manipulation facility by which a user may accept or reject new keywords for inclusion in the working keyword data set. The method may further include allowing a user to define rules by which new keywords are automatically added to the working keyword data set. The method may further include a user to define rules by which new keywords are automatically omitted or deleted from the working keyword data set. The method may further include providing a new keyword reviewing facility by which a user may define rules according to which new keywords are classified for automatic inclusion, automatic exclusion, manual inclusion or manual exclusion with respect to the working keyword data set.

Automated rules-based categorization of keywords may be embodied in a system adapted to facilitate a workflow for at least one of search engine optimization and search engine marketing. The system may include a data collection facility for collecting a data set of traffic-generating keywords, the traffic-generating keyword data set representing keywords used to access a web resource during different periods of time and collecting a data set of suggested keywords, a processor for associating at least one of the suggested keywords and the traffic-generating keywords into a working keyword data set, a rules server for storing a user-defined rule set by which a keyword may be grouped with a keyword group of the working keyword data set according to at least one property of the keyword and by which a keyword may be rejected based on an extent of relevance, and a processor for automatically grouping relevant new keywords with keyword groups and automatically deleting irrelevant keywords to transform the working keyword data set into a hierarchically grouped data set of relevant keywords. In some embodiments, the data collection facility, processor, and rules server may be embodied in a single unit while in other embodiments they may be embodied as separate components of a distributed system. In the system, the property used to group a keyword with a keyword grouping is selected from the group consisting of what words the keyword contains, what words the keyword does not contain, traffic derived from the keyword, the number of terms in the keyword, and the achievement of an objective based on use of the keyword by users to access the web resource. In the system, the data collection facility highlights new keywords in the working keyword data set. The system may further include a keyword manipulation facility by which a user may accept or reject new keywords for inclusion in the working keyword data set. The system may further include a user-defined rule by which new keywords are automatically added to the working keyword data set. The system may further include a user-defined rule by which new keywords are automatically omitted or deleted from the working keyword data set. The system may further include a new keyword reviewing facility by which a user may define rules according to which new keywords are classified for automatic inclusion, automatic exclusion, manual inclusion or manual exclusion with respect to the working keyword data set.

Keyword exploration facility 112 may be directly integrated with the search engine advertising platforms of major search engines. An operator may simply analyze and segment keywords into keyword groups, then associate them with ad groups. From that point on, changes made to keyword groups may be automatically synchronized with the underlying Search Engine Marketing advertising platforms. For example, keyword exploration facility 112 may automatically add or delete keywords, or automatically add or delete negative keywords, all based on various user-defined rules. The operator merely has to accept or reject the suggested actions; thus, by integrating keyword analytics and research tools with underlying search engine marketing systems, the user can leverage a highly actionable framework for automating the work required to continuously build out and optimize high ‘Quality Score’ search engine marketing campaigns. Keyword exploration facility 112 also provides a variety of different account export features to enable the creation of ad campaigns via the bulk-upload mechanisms supported by major search engine advertising platforms.

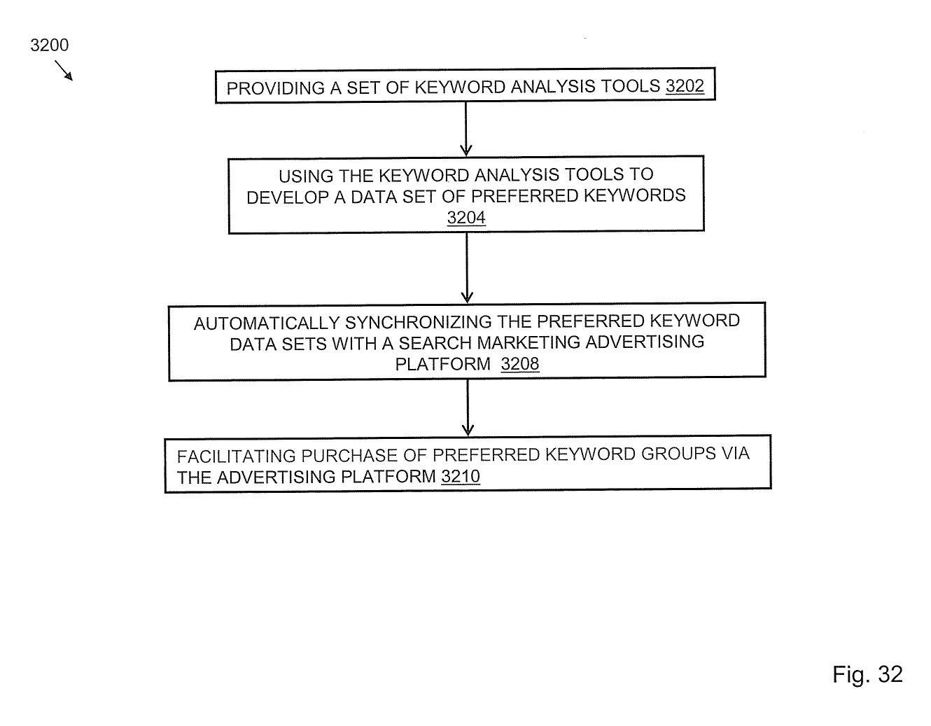

Referring to FIG. 32, a method that is fully actionable via direct integration (synchronization) of keyword analysis tools with the search engines advertising platforms is depicted in a flow diagram. The computer-implemented method may be applicable to a computer facility adapted to facilitate a workflow for at least one of search engine optimization and search engine marketing. The method may include providing a set of keyword analysis tools 3202, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and using the keyword analysis tools to develop a data set of preferred keywords 3204; and automatically synchronizing the preferred keyword data sets with a search marketing advertising platform 3208, facilitating purchase of preferred keyword groups via the advertising platform 3210. In forming the working keyword data set, it is optional to associate both suggested keywords and traffic-based keywords. In some embodiments, only one set of keywords may be needed to form the working keyword data set.

The fully actionable system of direct integration (synchronization) of keyword analysis tools with the search engines advertising platforms may be embodied in a system adapted to facilitate a workflow for at least one of search engine optimization and search engine marketing including a set of keyword analysis tools, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and a database for storing data set of preferred keywords developed using the keyword analysis tools; and a processor for automatically synchronizing the preferred keyword data sets with a search marketing advertising platform, facilitating purchase of preferred keyword groups via the advertising platform. In forming the working keyword data set, it is optional to associate both suggested keywords and traffic-based keywords. In some embodiments, only one set of keywords may be needed to form the working keyword data set. In some embodiments, the keyword analysis tools, database, and processor may be embodied in a single unit while in other embodiments they may be embodied as separate components of a distributed system.

Two factors that are known to affect ‘Quality Score’ are the relevance of the keyword to the Ads in its Ad Group, and the relevance of the keyword and the matched ad to the search query. Put another way, Text Ads (consisting of a headline, and descriptive text) should try to reflect the keywords that are being bid on, in order to realize a high Quality Score. Keyword exploration facility 112 may provide intelligent Ad Text authoring tools which may automatically suggest the most relevant wording to use within Ad Copy which helps improve relevancy scores by automatically promoting best practices, while also reducing the amount of typing (and time) taken to author a Text Ad.

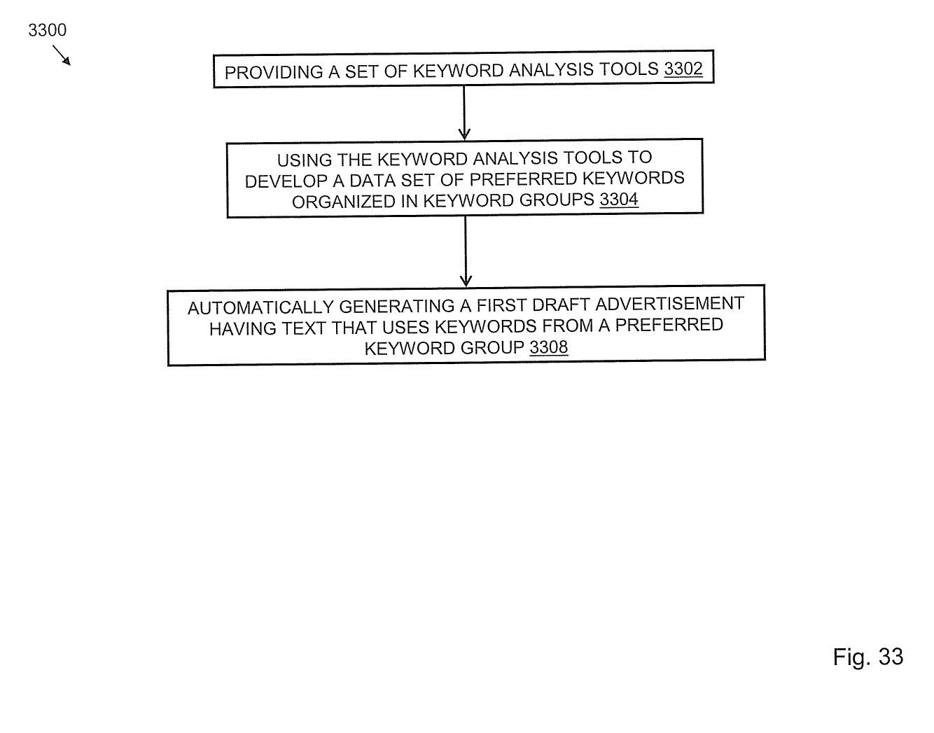

Referring to FIG. 33, a method relating to the ad text authoring tools optimized for quality score is depicted in a flow diagram. The computer-implemented method may be applicable to a computer facility adapted to facilitate a workflow for at least one of search engine optimization and search engine marketing. The method may include providing a set of keyword analysis tools 3302, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and using the keyword analysis tools to develop a data set of preferred keywords organized in keyword groups 3304; and automatically generating a first draft advertisement having text that uses keywords from a preferred keyword group 3308. In forming the working keyword data set, it is optional to associate both suggested keywords and traffic-based keywords. In some embodiments, only one set of keywords may be needed to form the working keyword data set.

The ad text authoring tools may be embodied in a system adapted to facilitate a workflow for at least one of search engine optimization and search engine marketing. The system may include a set of keyword analysis tools, the keyword analysis tools capable of at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; and (i) presenting a visual representation of the frequency distribution of the keywords used to access a web site; and a database for storing a data set of preferred keywords organized in keyword groups developed using the keyword analysis tools; and an authoring interface for automatically generating a first draft advertisement having text that uses keywords from a preferred keyword group. In forming the working keyword data set, it is optional to associate both suggested keywords and traffic-based keywords. In some embodiments, only one set of keywords may be needed to form the working keyword data set. In some embodiments, the keyword analysis tools, database, and authoring interface may be embodied in a single unit while in other embodiments they may be embodied as separate components of a distributed system.

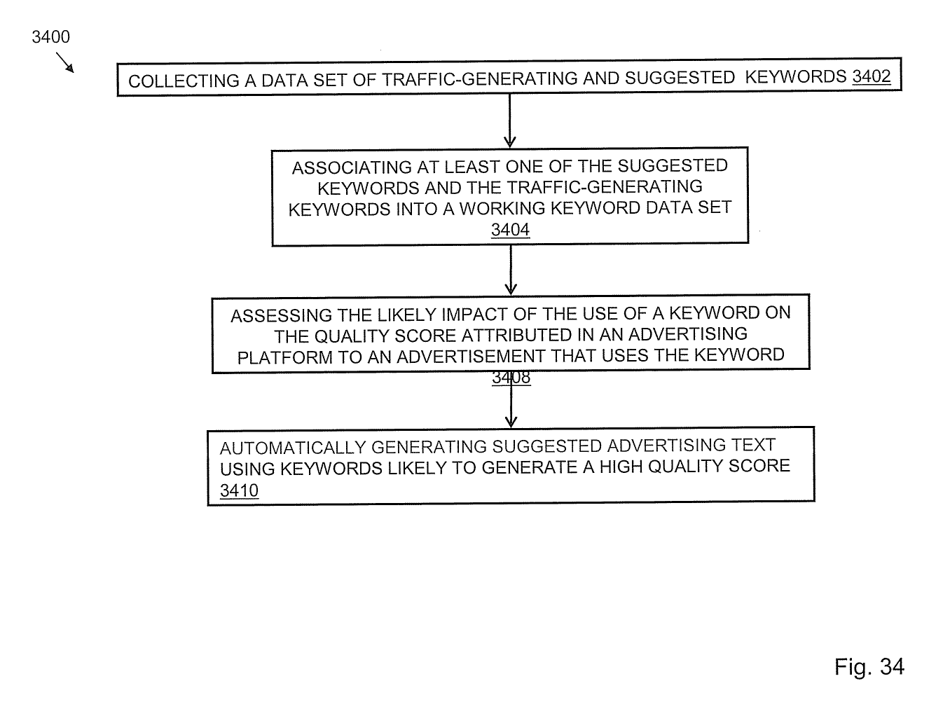

Referring now to FIG. 34, another method relating to the ad text authoring tools optimized for quality score is depicted in a flow diagram. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 3402; associating at least one of the suggested keywords and the traffic-generating keywords into a working keyword data set 3404; assessing the likely impact of the use of a keyword on the quality score attributed in an advertising platform to an advertisement that uses the keyword 3408; and automatically generating suggested advertising text using keywords likely to generate a high quality score 3410. In forming the working keyword data set, it is optional to associate both suggested keywords and traffic-based keywords. In some embodiments, only one set of keywords may be needed to form the working keyword data set.

The ad text authoring tools may be embodied in a system adapted to facilitate a workflow for at least one of search engine optimization and search engine marketing. The system may include a data collection facility for collecting a data set of traffic-generating keywords, the traffic-generating keyword data set representing keywords used to access a web resource during different periods of time and a data set of suggested keywords; a processor for associating at least one of the suggested keywords and the traffic-generating keywords into a working keyword data set; an assessment facility for assessing the likely impact of the use of a keyword on the quality score attributed in an advertising platform to an advertisement that uses the keyword; and an authoring interface for automatically generating suggested advertising text using keywords likely to generate a high quality score. In some embodiments, the keyword analysis tools, database, assessment facility, and authoring interface may be embodied in a single unit while in other embodiments they may be embodied as separate components of a distributed system.

One of the biggest challenges of search marketing is prioritization of workflow. Keyword exploration facility 112 may provide tools that suggest the most optimized workflow for a search marketer to follow when working on creating and optimizing high ‘Quality Score’ ad campaigns on an ongoing basis. These search engine marketing workflow tools may employ user-defined calculations to determine importance, which takes into consideration a user's weighting for different keyword data points. The criteria used by the keyword exploration facility 112 may be to determine that the search engine marketing insights to be acted on are calculated based on a set of user-specified rules which in turn reflect the search marketer's objectives and preferences. The keyword exploration facility 112 is a continuous learning, decision support system, that may automate the analysis of Web analytics data. Overall, search engine marketing workflow tools may employ self-learning, customizable algorithms and tools to help the search marketer quickly understand what work should be done to grow and optimize a search marketing campaign, with the goal of realizing the greatest positive outcome for the limited amount of time spent on search engine marketing account optimization.

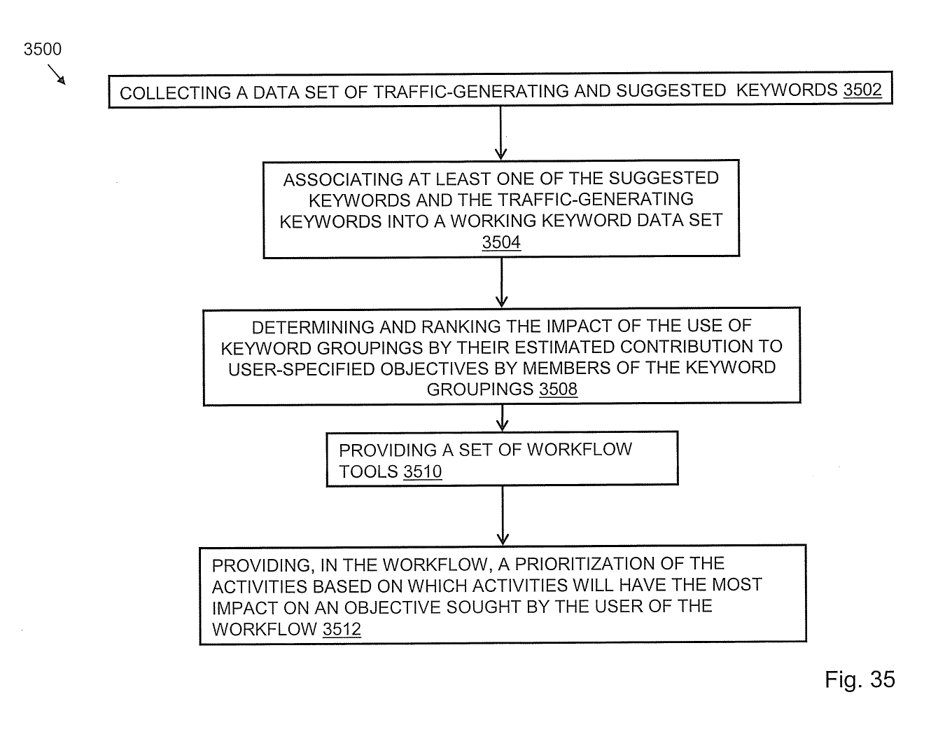

Referring to FIG. 35, a method relating to search marketing workflow tools is depicted in a flow diagram. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 3502; associating at least one of the suggested keywords and the traffic-generating keywords into a working keyword data set 3504; determining and ranking the impact of the use of keyword groupings by their estimated contribution to user-specified objectives by members of the keyword groupings 3508; providing a set of workflow tools 3510, the workflow tools facilitating at least one of: (a) tools for suggesting what keyword groups should be segmented into sub-groupings; (b) tools for suggesting what ad groups should be created; (c) tools for suggesting what ad groups should be optimized; (d) tools for suggesting what ad groups, if optimized, would generate a high amount of advertising traffic; (e) tools for suggesting what keywords should be eliminated; (f) tools for suggesting what web resources should be created; and (g) tools for suggesting de-duplication of keyword groups; and providing, in the workflow, a prioritization of the activities based on which activities will have the most impact on an objective sought by the user of the workflow 3512. In forming the working keyword data set, it is optional to associate both suggested keywords and traffic-based keywords. In some embodiments, only one set of keywords may be needed to form the working keyword data set. In the method, the objective sought by the user is selected from the group consisting of obtaining a favorable quality score for an advertisement in an advertising platform; improving likelihood of interaction by a user with an advertisement that uses preferred keywords; increasing the amount of traffic to a web resource; and improving likelihood of purchase by a user of goods or services advertised in an advertisement that uses preferred keywords.

The search marketing workflow tools may be embodied in a system adapted to facilitate a workflow for at least one of search engine optimization and search engine marketing. The system may include a data collection facility for collecting a data set of traffic-generating keywords, the traffic-generating keyword data set representing keywords used to access a web resource during different periods of time and a data set of suggested keywords; a processor for associating at least one of the suggested keywords and the traffic-generating keywords into a working keyword data set and determining and ranking the impact of the use of keyword groupings by their estimated contribution to user-specified objectives by members of the keyword groupings; a set of workflow tools, the workflow tools facilitating at least one of: (a) tools for suggesting what keyword groups should be segmented into sub-groupings; (b) tools for suggesting what ad groups should be created; (c) tools for suggesting what ad groups should be optimized; (d) tools for suggesting what ad groups, if optimized, would generate a high amount of advertising traffic; (e) tools for suggesting what keywords should be eliminated; (f) tools for suggesting what web resources should be created; and (g) tools for suggesting de-duplication of keyword groups; and a processor for prioritizing, provided in the workflow, the activities based on which activities will have the most impact on an objective sought by the user of the workflow. In some embodiments, the data collection facility, processor, and workflow tools may be embodied in a single unit while in other embodiments they may be embodied as separate components of a distributed system. In the system, the objective sought by the user may be selected from the group consisting of obtaining a favorable quality score for an advertisement in an advertising platform; improving likelihood of interaction by a user with an advertisement that uses preferred keywords; increasing the amount of traffic to a web resource; and improving likelihood of purchase by a user of goods or services advertised in an advertisement that uses preferred keywords.

The keyword exploration facility 112 may enable search marketing professionals to unify their paid search marketing and natural search marketing efforts by also providing integration of keyword research and analytics tools with various commercial and open source Content Management Systems and other Web publishing systems, including Blogs, Wiki's, etc. Some of the key features of this integration are described herein. There is paid search marketing and natural search marketing, which may be related by keyword organization efforts. Just as a user would select a narrowly focused grouping of keywords to publish and write a relevant ad, the same holds true for natural search marketing, where a user may prepare content or documents that are narrow in scope, using the relevant keywords. With respect to relevancy in natural search engine ranking algorithms, the pages likely to win are pages that are narrow in scope and topic, so they are specifically authored around that topic (e.g., natural dog food). There are natural synergies between topic selection for pages crafted for natural SEO work and words used for placing an advertisement. Integration with content management and web publishing systems for search engine optimization enables narrowly creating a web page around a topic that uses the keywords. The integration results in a product that is an actionable workbench where keywords can be collected, grouped and organized, then acted on in two ways, to publish ads and to publish content. The system enables keyword organization data accessible via an API that integrates with desktop editing tools, web publishing tools, or anything used to author web content either online or offline, such as Microsoft Word) and the like. The system may leverage the organizational structures to define and prioritize content creation topics (web pages) that a user may author, then the system may suggest what keywords to use in those documents. The system enables creating web pages that are narrowly focused around the keywords in keyword groupings, such as a relevant keyword grouping. The focus may be around keywords that are deemed to result in a beneficial effect on arrival at the web page. The system enables prioritizing content creation around the keywords that are most relevant (or have the highest ROI). The system enables exposing the organized keyword data to content authoring tools, so users can have insight as to what keywords to include in search-optimized content, in a seamless and integrated way. The system may be embodied in software that is integrated via an API, so that the keyword list is available in the content authoring environment. For example, if a user has authored a document on kitty litter, then if those words appear in a document, the software can scan and suggest links to those words in the related document. The software may also suggest, such as within the content authoring tools, hyperlinking of documents based on having relevant keyword anchor text linked.

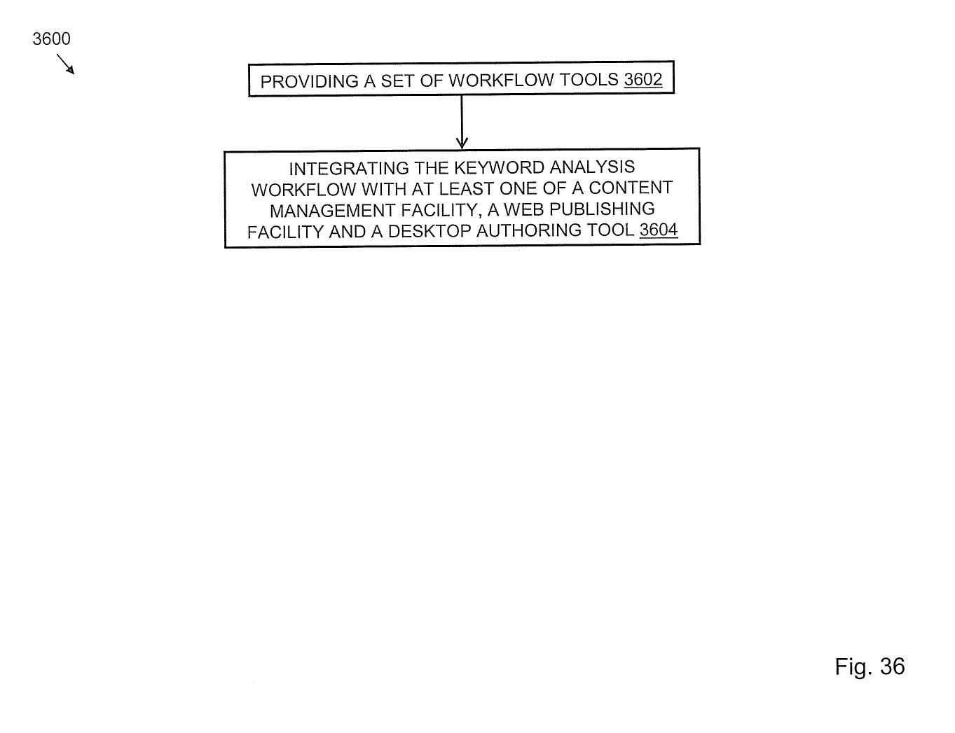

Referring to FIG. 36, a method relating to integration with content management and web publishing systems for search engine optimization is depicted in a flow diagram. The computer-implemented method may be applicable to a computer facility adapted to facilitate a workflow for at least one of search engine optimization and search engine marketing. The method may include providing a set of workflow tools 3602, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups and automatically generate a first draft advertisement having text that uses keywords from a preferred keyword group; and integrating the keyword analysis workflow with at least one of a content management facility, a web publishing facility and a desktop authoring tool 3604. In forming the working keyword data set, it is optional to associate both suggested keywords and traffic-based keywords. In some embodiments, only one set of keywords may be needed to form the working keyword data set.

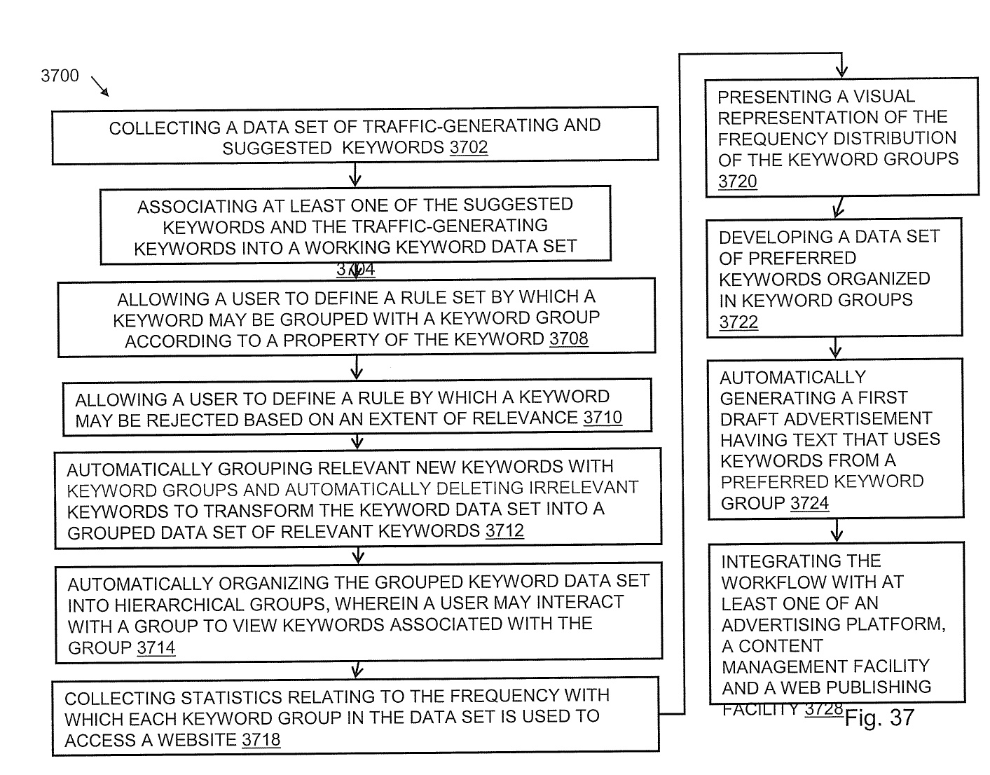

Integration with content management and web publishing systems for search engine optimization may be embodied in a system adapted to facilitate a workflow for at least one of search engine optimization and search engine marketing. The system may include a set of workflow tools, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword may be grouped with a keyword group according to a property of the new keyword; (e) allowing a user to define a rule by which a new keyword may be rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups and automatically generating a first draft advertisement having text that uses keywords from a preferred keyword group; and at least one of a content management facility, a web publishing facility and a desktop authoring tool integrated with the keyword analysis workflow. In forming the working keyword data set, it is optional to associate both suggested keywords and traffic-based keywords. In some embodiments, only one set of keywords may be needed to form the working keyword data set. In some embodiments, the workflow tools, content management facility, web publishing facility and desktop authoring tool may be embodied in a single unit while in other embodiments they may be embodied as separate components of a distributed system. Referring now to FIG. 37, a method relating to a combination of search engine marketing tools is depicted in a flow diagram. The computer-implemented method may be applicable to a computer facility adapted to facilitate a workflow for at least one of search engine optimization and search engine marketing. The method may include collecting a data set of traffic-generating keywords, the traffic-generating keyword data set representing keywords used to access a web resource during different periods of time, and collecting a data set of suggested keywords 3702; associating at least one of the suggested keywords and the traffic-generating keywords into a working keyword data set 3704; allowing a user to define a rule set by which a keyword may be grouped with a keyword group according to a property of the keyword 3708; allowing a user to define a rule by which a keyword may be rejected based on an extent of relevance 3710; automatically grouping relevant new keywords with keyword groups and automatically deleting irrelevant keywords to transform the keyword data set into a grouped data set of relevant keywords 3712; automatically organizing the grouped keyword data set into hierarchical groups, wherein a user may interact with a group to view keywords associated with the group 3714; collecting statistics relating to the frequency with which each keyword group in the data set is used to access a website 3718; presenting a visual representation of the frequency distribution of the keyword groups 3720; developing a data set of preferred keywords organized in keyword groups 3722; automatically generating a first draft advertisement having text that uses keywords from a preferred keyword group 3724; and integrating the workflow with at least one of an advertising platform, a content management facility and a web publishing facility 3728. In forming the working keyword data set, it is optional to associate both suggested keywords and traffic-based keywords. In some embodiments, only one set of keywords may be needed to form the working keyword data set.

The combination of search engine marketing tools may be embodied in a system adapted to facilitate a workflow for at least one of search engine optimization and search engine marketing. The system may include a data collection facility for collecting a data set of traffic-generating keywords, the traffic-generating keyword data set representing keywords used to access a web resource during different periods of time and a data set of suggested keywords; a processor for associating at least one of the suggested keywords and the traffic-generating keywords into a working keyword data set; a rules server for storing a user-defined rule set by which a keyword may be grouped with a keyword group according to a property of the keyword; a rules server for storing a user-defined rule by which a keyword may be rejected based on an extent of relevance; a processor for automatically grouping relevant new keywords with keyword groups and automatically deleting irrelevant keywords to transform the keyword data set into a grouped data set of relevant keywords; a processor for automatically organizing the grouped keyword data set into hierarchical groups, wherein a user may interact with a group to view keywords associated with the group; a data collection facility for collecting statistics relating to the frequency with which each keyword group in the data set is used to access a website; a presentation facility for presenting a visual representation of the frequency distribution of the keyword groups; a database for storing a data set of preferred keywords organized in keyword groups; an authoring interface for automatically generating a first draft advertisement having text that uses keywords from a preferred keyword group; and at least one of an advertising platform, a content management facility and a web publishing facility integrated with the workflow. In some embodiments, the data collection facility, processor, rules server, presentation facility, database, authoring interface, content management facility, web publishing facility and advertising platform may be embodied in a single unit while in other embodiments they may be embodied as separate components of a distributed system.

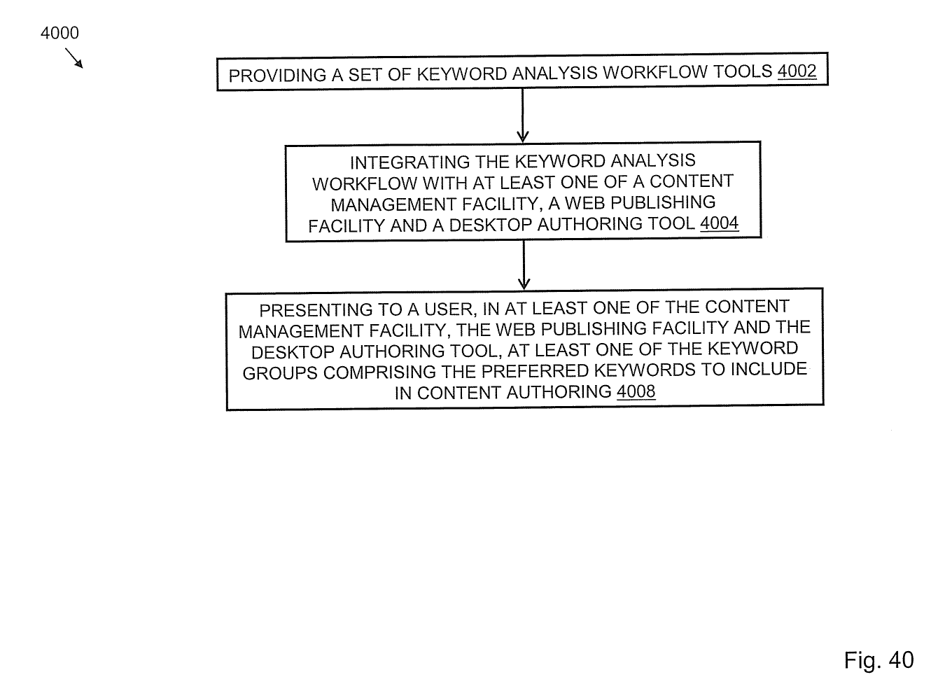

Referring to FIG. 40, a system and computer-implemented method may be applicable to a computer facility adapted to facilitate a workflow for at least one of search engine optimization and search engine marketing. The system and method may include providing a set of keyword analysis workflow tools 4002, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword is grouped with a keyword group according to a property of the new keyword; (e) allowing a user to define a rule by which a new keyword is rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups, and integrating the keyword analysis workflow with at least one of a content management facility, a web publishing facility and a desktop authoring tool 4004 and presenting to a user, in at least one of the content management facility, the web publishing facility and the desktop authoring tool, at least one of the keyword groups comprising the preferred keywords to include in content authoring 4008.

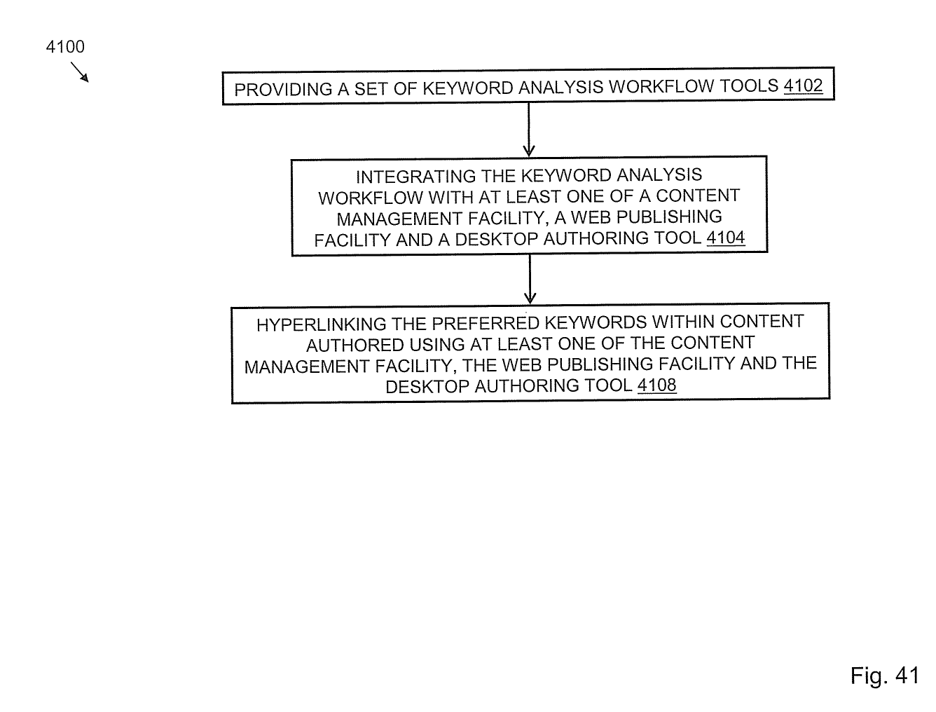

Referring to FIG. 41, a system and computer-implemented method may be applicable to a computer facility adapted to facilitate a workflow for at least one of search engine optimization and search engine marketing. The system and method may include providing a set of keyword analysis workflow tools 4102, the set of workflow tools enabling at least one of: (a) collecting a data set of traffic-generating keywords, the traffic-generating keyword data set representing keywords used to access a web resource during different periods of time; (b) collecting a data set of suggested keywords; (c) associating at least one of the suggested keywords and the traffic-generating keywords into a working keyword data set; (d) allowing a user to define a rule set by which a new keyword is grouped with a keyword group according to a property of the new keyword; (e) allowing a user to define a rule by which a new keyword is rejected based on an extent of relevance; (f) automatically grouping relevant new keywords with keyword groups; (g) automatically deleting irrelevant keywords to transform an unfiltered keyword data set into a data set of relevant keywords; (h) collecting statistics relating to the frequency with which each keyword in a data set is used to access a website; (i) presenting a visual representation of the frequency distribution of the keywords used to access a web site; and (j) using the keyword analysis tools to develop a data set of preferred keywords organized in keyword groups; and integrating the keyword analysis workflow with at least one of a content management facility, a web publishing facility and a desktop authoring tool 4104, and hyperlinking the preferred keywords within content authored using at least one of the content management facility, the web publishing facility and the desktop authoring tool 4108.

The keyword exploration facility 112 may simplify publishing of highly relevant destination URLs (i.e., Web pages) for any grouping of keywords by providing a user interface that seamlessly invokes the Web page creation method of an underlying CMS or Web publishing system from directly within the keyword exploration facility. Various best-practices may be automatically enforced, including the automatic use of relevant file names, meta keywords, page title, headings, etc., thus increasing the relevancy of a destination URL, while reducing the work required to do so, and also simultaneously improving ‘Quality Score’.

The keyword exploration facility 112 may provide integrated support for invoking an editor, such as a search-friendly editor, that automates much of the work required to create Web pages that are specifically designed to score highly in the natural search results for keyword searches in a particular keyword grouping. The integration between keyword exploration facility 112 and the editor may be based on the ability to visually define associations between keyword Groups and Web pages. These relationships can in turn be used to configure the editor to automatically suggest relevant hyper-links for cross-referencing related Web pages as well as enforce or promote certain Search Engine Optimization (SEO) best practices which overall greatly help in increasing the natural search result ranking of the newly published Web page.

The keyword exploration facility 112 may provide advanced keyword visualization tools that may not only be ideal for creating keyword groupings for paid search marketing campaigns but also for providing actionable workflow insights into what are the most popular topics which ought to be targeted for content authoring to increase natural search traffic. The natural search engine optimization workflow tools may base their workflow calculations on various user-defined settings that reflect the operator's preferences and objectives.

In addition to the ability to generate keyword suggestion terms based on historical and live web server analytics data, the keyword exploration facility 112 may also provide a user interface for integrating with various third-party keyword suggestion tools to import new keywords that were not automatically discovered through log file and Web traffic analysis, directly into server facility. This may render the new keyword data provided by third-party keyword suggestion tools more immediately actionable by providing integration of the aforementioned keyword grouping and organization tools with Search Engine Marketing platforms for engaging in Search Engine Marketing (SEM) and with Web publishing systems for engaging in Search Engine Optimization (SEO). The ability to import keyword data from third party keyword tools marks a significant differentiating feature from other keyword analytics tools which only allow you to analyze keyword data based on a website's past history.

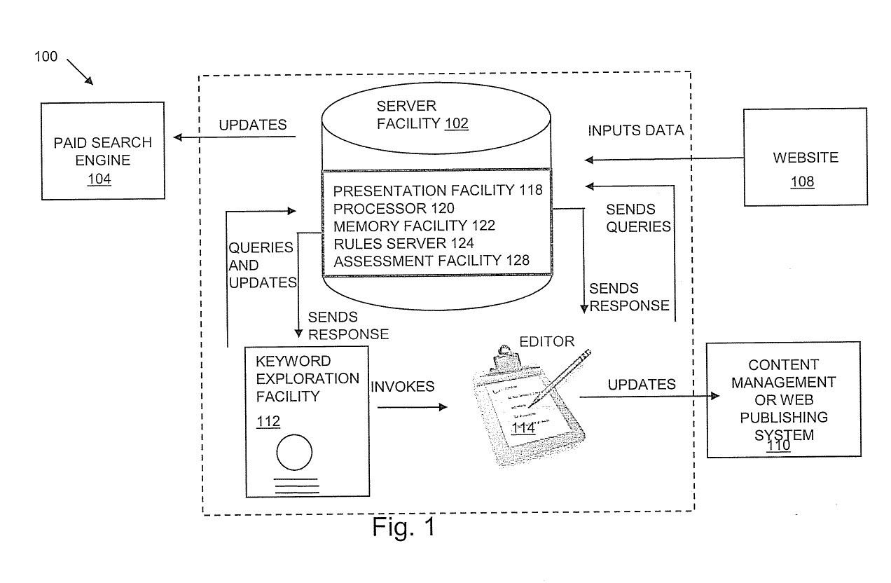

The keyword exploration facility 112 is one of three main components of application described in conjunction with various embodiments of the present invention. FIG. 1 depicts the various components as well as their interactions with each other.

Referring to FIG. 1, the system 100 may include a server facility 102, the keyword exploration facility 112, and an editor 114. The server facility 102 may be associated with the keyword exploration facility 112 and may be coupled with the editor 114. The server facility 102 may receive inputs from a user browsing a website, such as through a data collection facility, which may belong to a particular organization. It should be understood that throughout this specification, the term “website” is understood to encompass any kind of web resource that can be accessed by a search. The received inputs may be processed at the server facility 102 and the updated information may be forwarded to a paid search engine marketing platform 104, including Google, Yahoo, MSM, and other Web sites. The keyword exploration facility 112 may query the server facility 102 or provide an update to the server facility 102. Based on the queried information, the server facility 102 may provide updates to the keyword exploration facility 112. Similarly, the editor 114 may send queries to the server facility 102 and receive responses from it to be used for updating the content management/web publishing system 110.

The server facility 102 may include a high-performance, embedded taxonomy database for storing keywords and related keyword statistics and properties, including frequencies, keyword groupings, the ad groups with which they are associated; a parser for automatically extracting and indexing keywords from web server log files; a JavaScript-based tracker and keyword update service for establishing a live keyword stream from client websites; a secure Web service Application Program Interface (API) for invoking queries, updates, and other operations from any client, editor 114, and other third party tools; an account management server for managing account information, including users, billing, user configuration options, etc; and a change management and search engine synchronization engine for transmitting changes made to search engine advertising campaigns to search engines via their web service APIs. In some embodiments, the database is not embedded. The server facility 102 may include a presentation facility 118, a processor 120, a memory facility 122, a rules server 124, and an assessment facility 128.

The keyword exploration facility 112 may provide a rich-internet application for browsing the keyword data contained in the server facility 102. The keyword exploration facility 112 may consist of tools for querying and visualizing keywords, reviewing and accepting/rejecting keywords, continuously discovering new keywords, finding and specifying negative keywords, creating hierarchies of organized keyword groupings, assigning keyword groupings to ad groups and/or landing pages, as well as workflow management tools, and integrated tools for invoking editor 114 for search-optimized web publishing.

The editor 114 may be a search engine friendly, web-based or desktop-based content authoring tool designed to be easily embeddable into any commercial or open source Content Management, Web publishing system or content authoring program such as Microsoft Word. The editor 114 may support integration with the server facility 102 for providing content authors with real-time access to popular keyword distributions, as well as automated hyperlink suggestion tools to assist with authoring of both high quality score destination URLs and search-optimized pages designed to rank highly in natural search engine result pages for popular keywords. The editor 114 may be invoked from keyword exploration facility 112, thus providing a more seamless effort when it comes to creating high quality score ad groups.

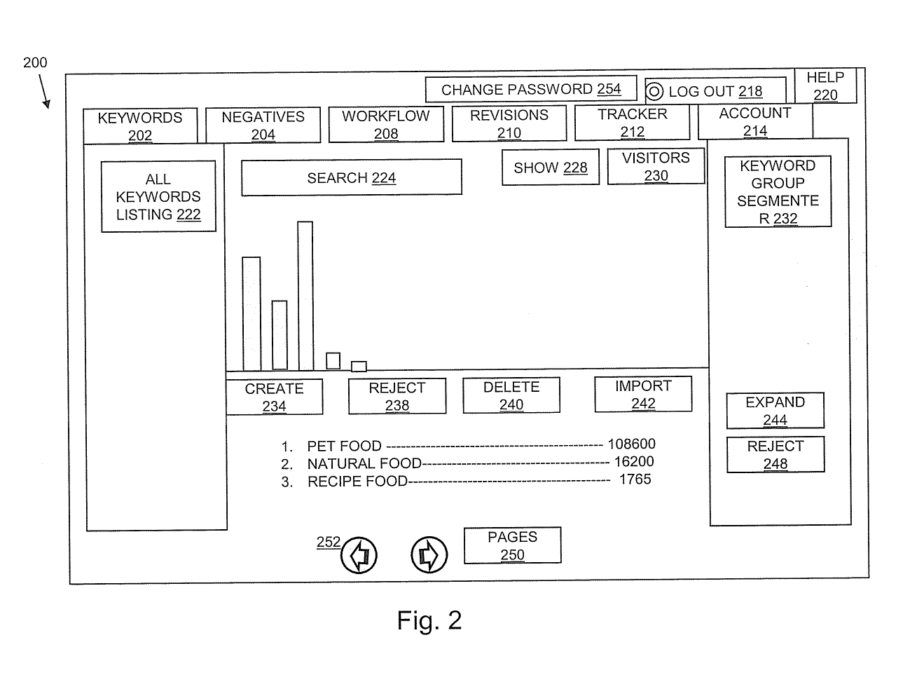

FIG. 2 depicts a snapshot of the keyword exploration facility 112 for querying and visualizing keywords; filtering; generating; and grouping keywords for the purpose of informing, optimizing, and automating search engine marketing.

In embodiments, the keyword exploration facility 112 may operate as a browser-based, hosted, Software-as-a-Service (SaaS) application. Alternatively, an organization may elect to host the application on their internal servers. This may provide users with a Secure Sockets Layer (SSL) encrypted interface to perform various account management functions such as sign up for a free trial account; login and logout of the application; enter and update user information including billing address, credit card information, contact information, account passwords, etc.; create different account profiles (for example, a customer who is a search marketing consultant working on three different customer accounts could set up three separate data profiles to analyze and act on) and create additional users for an account to enable multiple people to work on the same campaigns, as well as the ability to grant different permission levels to different users.

Referring to FIG. 2, a webpage for account is provided. The webpage may include various frames such as all keyword listing 222, keyword group segmenter 232, and other frames. In addition, the keyword exploration facility 112 may include tabs such as keywords 202, negatives 204, workflow 208, revisions 210, tracker 212, account 214, and settings. These tabs may provide access to different administrative and management functions. For example, the keyword 202, when accessed, may display a plurality of textboxes and buttons in a frame of the webpage for monitoring various statistics stored in the server facility 102. In addition, within the keyword 202 is accessed, the webpage frame may include buttons such as create 234, reject 238, delete 240, and import 242 for manipulating and/or displaying the information within the frame.

The keyword exploration facility 112 may provide a user interface for configuring and modifying these and other account settings which are stored by the server facility 102.

The keyword exploration facility 112 may provide the ability to visually explore and act on an organization's keywords via an advanced Web interface that supports browsing, grouping, deleting, and other tools and operations described in this section.

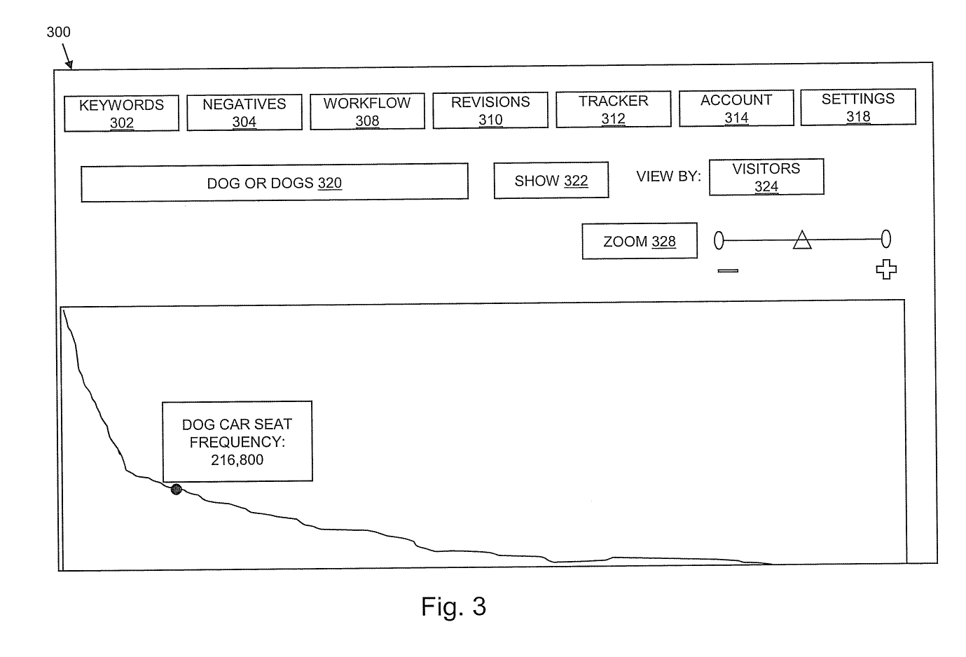

For example, the keyword exploration facility 112 may display the top 500 unassigned search terms and plot them on a standard X-Y graph by default (Keyword Frequency vs. Keyword) to form a ‘long tail’ distribution as illustrated in FIG. 3.

In order to graphically render the keyword data depicted in FIG. 3, the keyword exploration facility 112 may invoke a web service query against server facility 102, which may authenticate the request and return the requested query results.

For example, a list of keywords and their frequencies that match the user-specified criteria may be considered. The data may be subsequently rendered in real-time on the client-side by the keyword exploration facility 112. If the user's mouse pointer is placed on the chart, for example, on a keyword, information about the selected keyword including keyword frequency and other information is rendered on the chart in real-time.

Referring to FIG. 3, the default view of the keyword exploration facility 112 may significantly differ from other search analytics products because: keyword exploration facility 112 may properly render ‘long tail’ of keywords using keyword frequency (or other key metrics) as the Y-Axis and graphs different keywords on the X-axis in descending keyword frequency order. Conversely, the other applications display keyword data as a ‘long table’ rendering keywords and their frequency data in a tabular format. These applications are built using HTML whereas the keyword exploration facility 112 may be built using Flash technologies which may provide a far more visually interactive user experience.

In accordance with an embodiment of the present invention, the keyword exploration facility 112 may provide several other features, including organizing and grouping keywords, finding negative keywords, suggesting keyword workflow, keyword de-duplication, keyword goal tracking, and subsequently acting on organized keyword data for optimizing both paid and natural search engine optimization efforts which are described in detail throughout this patent application.

The keyword exploration facility 112 may employ various advanced programming techniques to minimize latency from the time a query is issued to the time it is visually rendered, including the features such as ‘Multi-Threaded Query Execution and Rendering,’ ‘Query Result Caching,’ and ‘Query Processing Status Bar.’

The ‘Multi-Threaded Query Execution and Rendering’ may involve a multi-threaded query execution and rendering architecture that may enable the keyword exploration facility 112 to start rendering the chart as soon as it receives the minimum amount of data needed to render a portion of the query results.

Similarly, the ‘Query Result Caching’ may enable a user to scroll forwards and backwards within a ‘long tail’ keyword distribution, as well as navigate back and forth to view past queries, without having to re-issue the query on every change.

Also, in the ‘Query Processing Status Bar,’ the status of a query processing may be displayed in a status bar. An hour glass icon may be displayed on the mouse cursor if the keyword exploration facility 112 is awaiting a response from the Server facility.

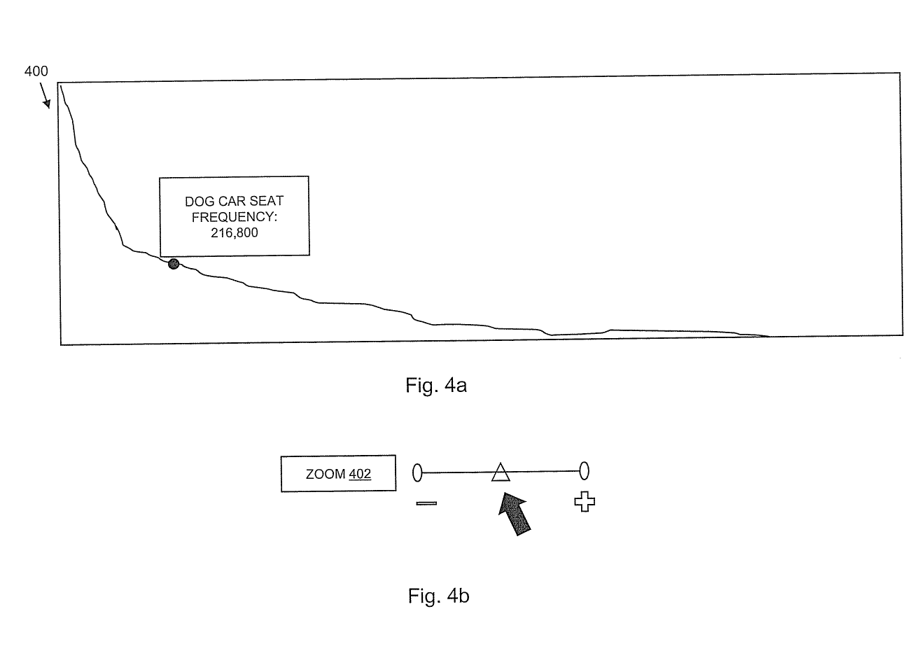

Referring to FIGS. 4A and 4B, an X-Axis Control for the keyword exploration facility 112 may be provided.

The X-Axis Control for the keyword exploration facility 112 may be located below the main keyword frequency chart. It may consist of a horizontal slider which can be dragged from left to right, enabling the user to scroll the chart. Alternatively, the user may simply click on the chart and drag it back and forth to change the X-axis range. As the range is modified, both the Y-axis scale and the range of keyword amplitudes that are displayed on the chart may be automatically updated.

Additionally, the keyword exploration facility 112 may also provide a means for zooming in and out of a section of the keyword chart by providing a zoom widget for a user to manipulate, or by scrolling the mouse wheel (as shown in FIG. 4B).

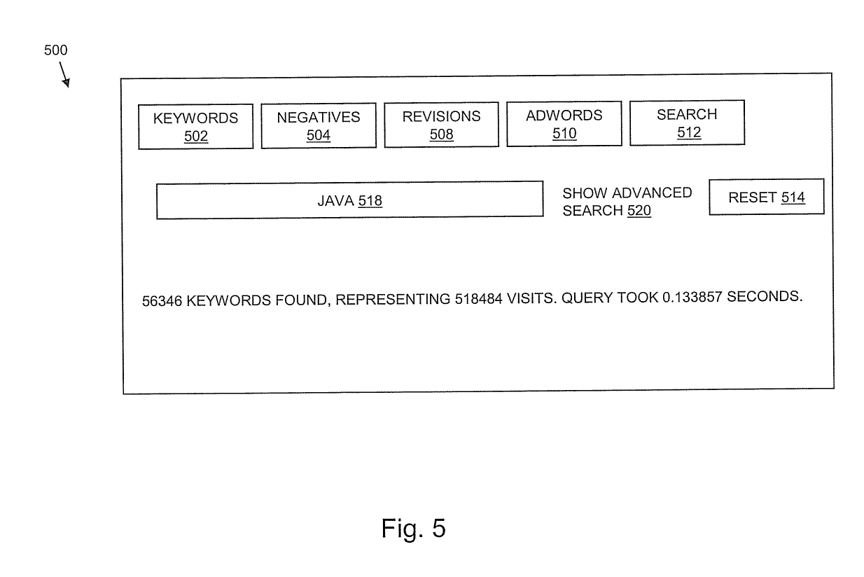

FIG. 5 depicts a querying of a server facility 102 using keyword exploration facility 112. The webpage may include tabs such as keywords 502, negatives 504, revisions 508, ad words 510, and search 512. In response to a click on the keyword 502, the tab may display a keyword query box 518 that may enable the user to query the server facility 102 for specific queries. To execute a query, the user may type the query into the query box. Queries are sent from the keyword exploration facility 112 to the server facility 102 automatically as soon as the user stops typing, or hits the enter key on the keyboard (i.e., there is no need to click on a “search” button).

For example, in FIG. 5, the user is querying the server facility 102 for all keywords containing the word “java”. The results of a query may be processed by the server facility 102, and then sent back to the keyword exploration facility 112 for visual rendering. In addition, the webpage may provide options for advanced search 520 and a reset button 522. The reset button 522 may be clear the data entered previously in the keyword query box 518.

In embodiments, the state of the query being executed can be inferred by the background color of the Query Box; a green background may mean that the query processing is complete; a yellow background may indicate that the user is in the process of typing a query; and a red background may indicate that a query is in the process of being executed. Additionally, a status bar may display various statistics, including the number of keywords that were found to match the user's query, the number of visits represented by those keywords, and the total time taken to process the query. As a convenience, past queries may be saved on the client side, and the user may scroll through them, and optionally clear the query history.

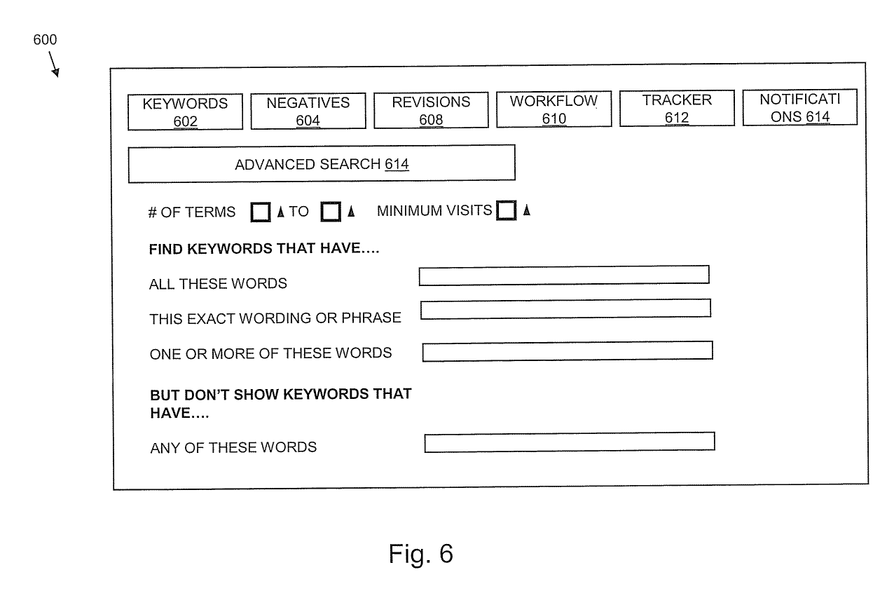

The keyword exploration facility 112 may support efficient execution of full-text search queries. By default, a query containing multiple search terms may be processed using the logical ‘AND’ operator. For example, a query for used cars would return all keywords containing both the words “used” and “cars,” in any order. An exact match will return keywords containing an exact match for “used cars,” a negative match will return keywords that contain “cars” and does not contain “used,” a starting with match type will return keywords that contain both “used” and keywords starting with “car” or “cars.” To assist with the creation of advanced, full-text keyword searches, an advanced Keyword Search tool may be used, to simplify queries, as illustrated in FIG. 6. The advanced keyword search menu options may appear in keyword exploration facility 112 Options Panel upon clicking the ‘advanced search’ button, such as number of terms; minimum visits; find keywords that have all of these words, this exact wording or phrase, one or more of these words; but don't show keywords that have any of these words, and the like. The webpage may include tabs such as keywords 602, negatives 604, revisions 608, workflow 610, tracker 612 and notifications 614.

In addition to providing full-text search for querying the keyword database of server facility 102, it may allow users to query based on many other keyword properties and filters.

This property may let a user query for keywords that have a minimum frequency equal or greater than a specified value. For examples, a user could filter query results to show only those keywords that have received at least five web hits.

This filter may let users define different goals (such as completed sales or lead signups) so that they can attribute what keywords lead to what outcomes. The advanced query interface 600 (shown in FIG. 6) may support the ability to query for keywords that lead to a minimum number of successful goal outcomes, to help identify the most productive keywords and keyword groupings.

This may enable a search marketer to apply weightings to different keyword properties, including goals in order to visualize the keyword distributions based on a customized calculation to determine keyword importance.

This filter may let a user filter query results by time; for example, the current month, current quarter, current year, or all available data.

This filter may let users specify the minimum and maximum number of terms that may appear in the keyword. For example, a user could filter a query result to display only those keywords that were made up of between 2-5 words.

Keywords can be filtered according to their states; for example, active, inactive, paused, pending review (this state pertains to newly discovered keywords from the JavaScript tracker), reviewed (this state pertains to new keywords that have been accepted), etc.

This filter would display only search terms that are assigned a specific Keyword Group, or a tree of Keyword Groups.

This filter may display searches that were the result of natural search or paid search or both.

This filter may specify a page range corresponding to how deep into the natural Search Engine Result Pages (SERP) a user was at the point they clicked on a link which led to them finding the website.

This filter may display the keywords which cost within a specified dollar range (either in total dollars spent or an average amount per click) from paid search marketing for each keyword.

The keyword exploration facility 112 may also provide a drill-down mechanism for visually exploring and browsing keyword distributions. For example, if a user clicks on a keyword on the chart, the keyword exploration facility may query the server facility 102 for other keywords containing those keywords and may visually render the distribution of all similar keywords. This drill-down feature, combined with integrated support for using the browser's “back” and “forwards” buttons, provides a user-friendly, highly responsive, Web browser-like experience for exploring and finding different keyword distributions.

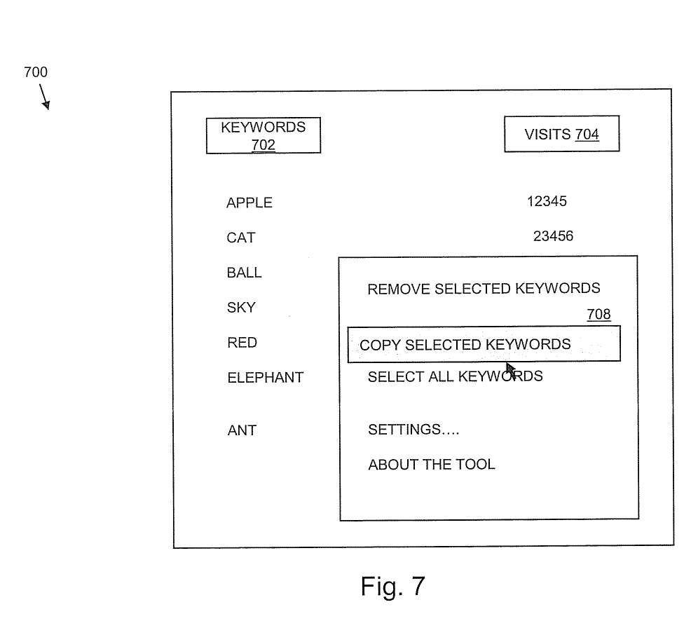

In addition to the visual display of keywords in a chart format, the underlying keyword data that was used to render the chart may be displayed in a tabular format in a data grid located directly under the chart and shown in FIG. 7. The data grid may allow the user to create a customized view of different keyword properties, including the keywords 702, frequency of visits 704, Keyword State, Keyword Grouping, and many other user-defined keyword properties. The keyword data grid may also support select-all, copy-to-clipboard, and many other operations from the short-cut menu, and may provide tools for sorting by different columns (ascending or descending sort), and for exporting data into various output formats, including comma separated values (CSV), Microsoft Excel™, and other common data output formats.

In addition to the manual keyword export functionality (via copy & paste operations), an account export wizard may also be included that may enable a user to export their organized keyword groupings and keyword properties into a variety of different output formats, including Tab-Separated Values (TSV) and Comma Separated Values (CSV) formats.

In accordance with the embodiments of the present invention, all the previously described tools for filtering, querying, and visualizing keywords are designed to enable the discovery of related Keywords which, when identified, are intended to be assigned into Keyword Groups.

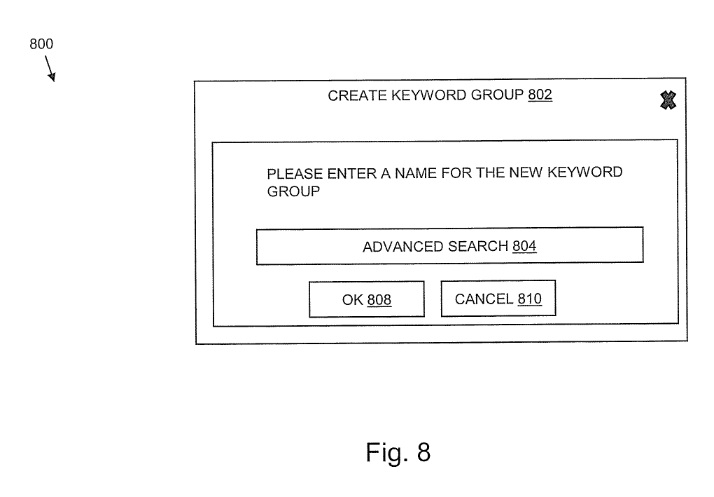

FIG. 8 depicts the creation of a keyword group in accordance with an embodiment of the present invention. To assign a collection of related keywords into a Keyword Group, the server facility 102 is queried using any of the previously described keyword querying and filtering tools, and then the “Create Group” button 802 may be clicked. The keyword exploration facility 112 may prompt the user to provide a name for the new Keyword Group.

The keyword exploration facility 112 may automatically use the most popular keyword in the keyword group as the default name for the newly created Keyword Group. Subsequently, the user can either accept the default name, or change it, and then click “OK” 808 to create the keyword group, Cancel 810 to cancel the action, or advanced search 804 to initiate a search from the screen.

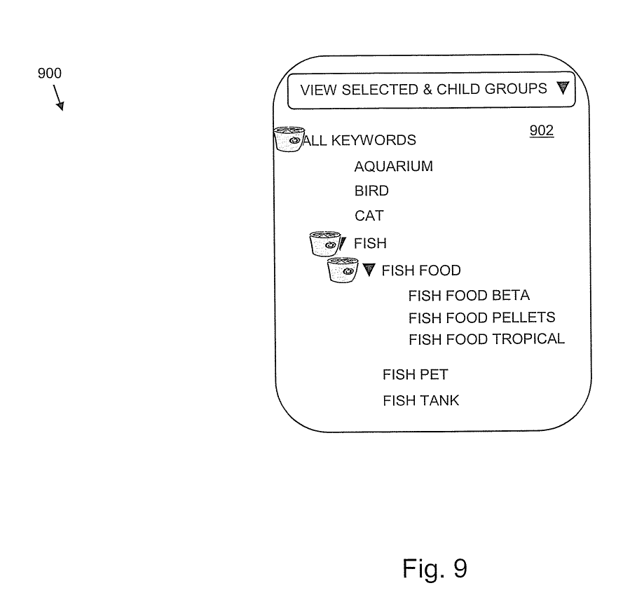

The keyword exploration facility 112 may also provide a “Keyword Group Explorer” as shown in FIG. 9. It is a hierarchical tree-view control for visualizing trees of keyword groups. Initially, there may be only one keyword group, the “All Keywords” group 902, located at the root of the keyword group tree, which may initially contain all the keywords in the taxonomy database of server facility 102 for a particular user profile. Suppose the user queries the “All Keywords” group for all keywords containing the word “fish,” and then creates a Keyword Group called “fish.” The Keyword Group Explorer visually displays the newly created Keyword Group as a child of the “All Keywords” group. If the user clicks on the “Fish” keyword group in the Keyword Group Explorer, the keyword exploration facility 112 will only display the keywords in the “Fish” keyword group. With the “Fish” keyword group selected, the user can then sub-query the keyword group for even more specific terms; for example, terms involving “aquariums” or “food,” etc., thus creating even more specific keyword groupings which are rendered as child folders under the “Fish” keyword group. This type of nested keyword querying and grouping may be supported for as many levels as required; for example, the “Fish Food” sub group can be further sub-grouped according to even more specific search terms, such as “pellets” or “tropical.”

The Keyword Group Explorer may visually depict keyword groupings as bright yellow buckets. If a Keyword Group has sub-groups, then an arrow appears directly to the right of the bucket. If a user wishes to visually expand a Keyword Group (to view its subgroups), the user may simply click on the arrow, which tips over the bucket. A “tipped-over” bucket shows water flowing out of itself, into its sub-groupings. The reason for the bucket metaphor is that the application establishes a live keyword stream between itself and a client's website. Newly discovered keywords flow directly into the All Keywords bucket, but then automatically trickle down into more specific keyword groupings, if they have been defined.

Querying of a server facility 102, keyword database, as well as the creation of keyword groups may be relative to the currently selected keyword group, as well as the currently selected keyword group visibility option.

The user may tell which Keyword Group is currently selected because it may be highlighted in blue; for example, in FIG. 9, the “fish” Keyword Group is selected. The currently selected keyword grouping affects viewing, querying, and grouping operations. If the user has the “All Keywords” group selected in the Keyword Group Explorer, then the keyword exploration facility 112 may display all of the available keywords, and possibly its subgroups too, depending on the currently specified Keyword Group Visibility Option setting. Similarly, keyword queries may be executed against those keywords in scope; i.e., keywords that are members of the specified Keyword Group (and possibly its subgroups, depending on the Keyword Group Visibility Option setting). Also, when a user creates one or more Keyword Groups, the newly created Keyword Group(s) will be placed underneath the currently selected Keyword Group.

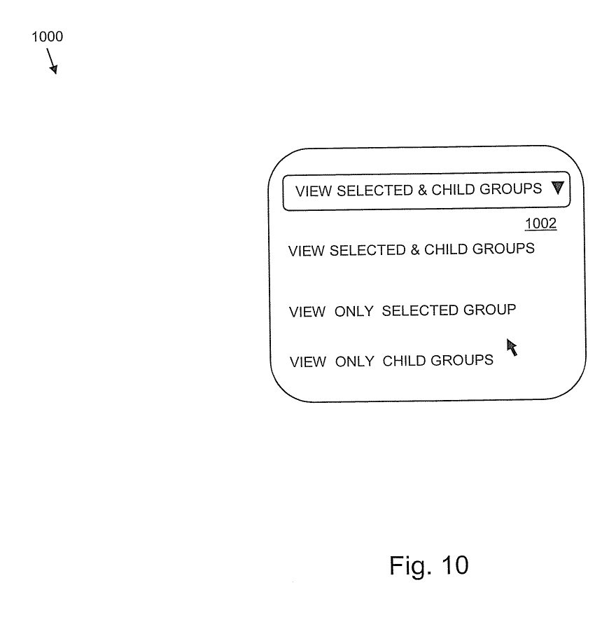

FIG. 10 depicts the keyword group visualization options, in accordance with an embodiment of the present invention. The Keyword Group Explorer supports at least three different Keyword display options which may be picked from a pull-down menu 1002.

The keyword group visualization options may include viewing selected and child groups, only selected groups, and only child groups.

The Keyword Group Explorer may also provide powerful integrated visualization tools to enable a search marketer to quickly see what Keyword Groupings have been acted on, or alternatively, what Keyword Groups have not been acted on, in order to determine work that remains to be done.

For example, an option, ‘Highlight Keyword Groups with Associated Ad Groups’ may light up all the Keyword Groups that have one or more associated Ad Group(s)—which means that the user has placed bids on the keywords contained in the highlighted Keyword Groups—the user has “acted” on those Keyword Groups from a Paid Search sense.

Similarly, another option ‘Highlight Keyword Groups with Associated Landing Pages’ may light up all the Keyword Groups that have one or more associated landing page(s) (or simply content pages). This means that the user has authored one or more page(s) that speak to the keywords contained in the highlighted Keyword Groups—the user has therefore “acted” on those keyword groups from a Natural Search sense.

These keyword group highlighting tools may enable a search marketer to visually map out an entire keyword taxonomy that makes it possible for a search marketer to divide and conquer the entire map by showing what keyword groups have been acted on and what have yet to be acted on. Furthermore, by having a single, live application hosting this information, it may enable collaboration for teams of search marketers to work in conjunction with each other, enabling them to reduce duplication of efforts.

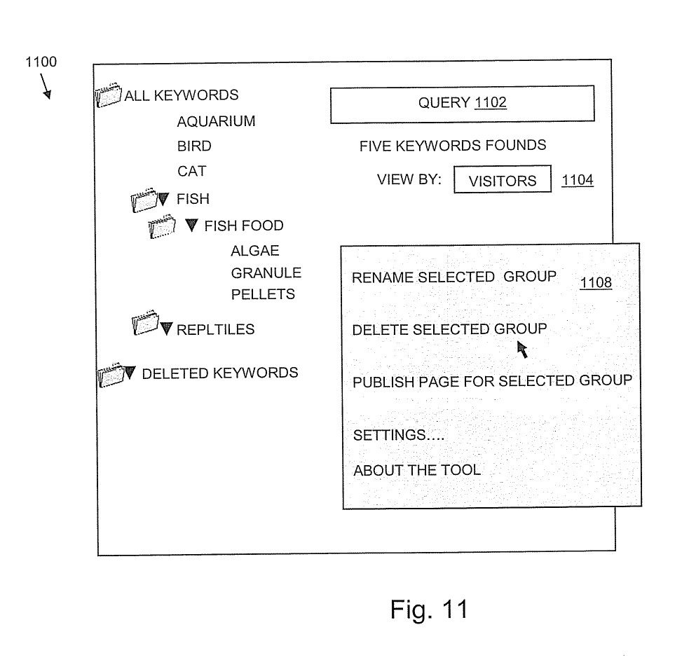

FIG. 11 depicts a process of deleting a keyword grouping from the keyword group explorer. A user can delete one or more keyword groups directly from the short-cut menu of the Keyword Group Explorer, as illustrated in FIG. 11.

When a user deletes a Keyword Group 1108, the keywords belonging to the group are not deleted; rather, their state is changed from being associated with one group to another. For example, suppose the user wishes to delete the “Fish Food” Keyword Group; all keywords in that Keyword Group, as well as all keywords contained below in nested Keyword Groups, would be released from their current group assignments, and would end up in the “Fish” Keyword Group which is the parent group of the “Fish Food” group. Similarly, if the “Fish” group was deleted, then the group would be removed, and all the keywords belonging to the group would be re-assigned up one level in the tree and placed in the “All Keywords” group. It is not possible to delete the default “All Keywords” group. The user may first query 1102 the system to search keywords then choose a viewing category 1104, such as by visitor.

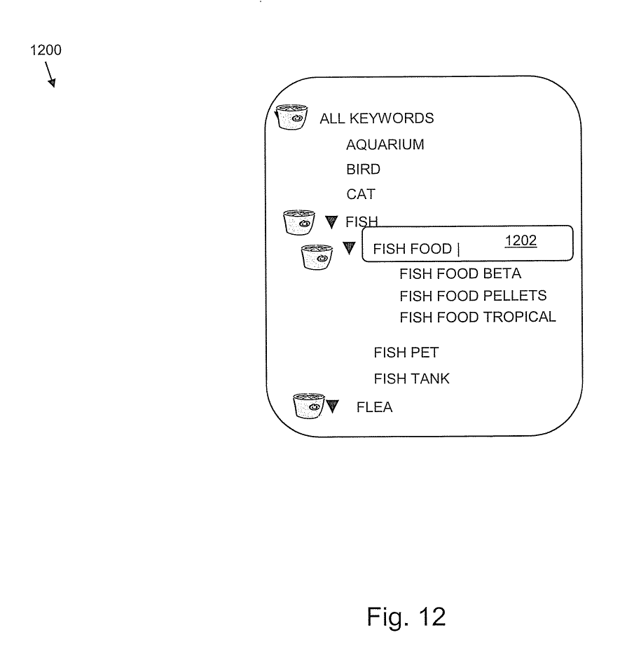

In accordance with an embodiment of the present invention, a user may rename a Keyword Group at any time from the Keyword Group Explorer by double clicking on the Keyword Group and typing in the new name to use, or hitting the [F2] short-cut key, as illustrated in FIG. 12. For example, the editing box 1202 may become activated when one of these actions is taken in the keyword explorer.

The Keyword Group renaming function can also be invoked from the short-cut menu. In some embodiments, it may not be permitted to have two Keyword Groups with the same name at the same depth.

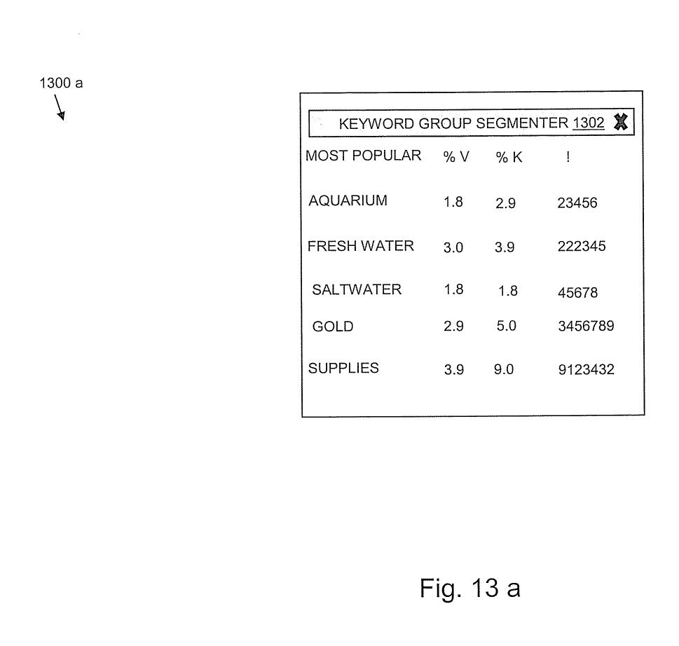

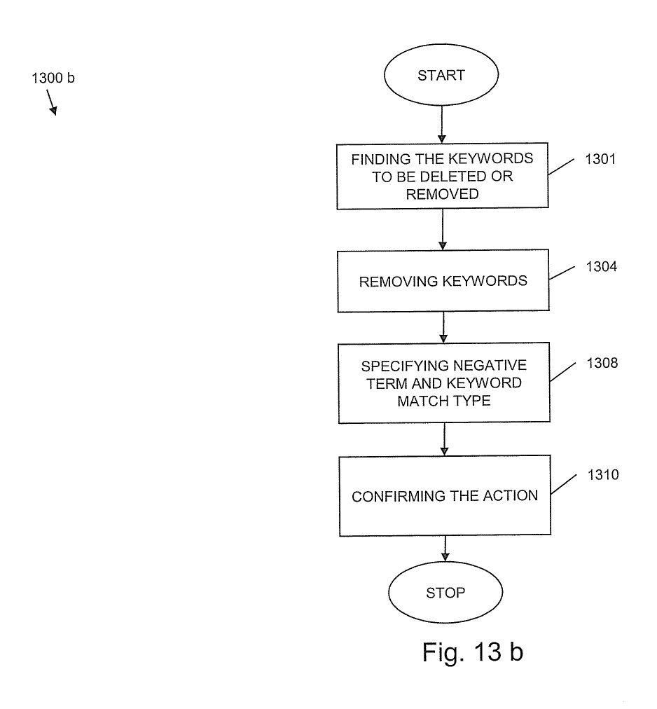

In addition to providing the ability to create Keyword Groupings by manually typing out a Full-Text Query in the query bar 1102 and grouping together the results, the present invention also provides Automated Keyword Group Suggestion tools that may perform an automated, user-defined analysis of keywords contained in the currently selected Keyword Group in order to suggest a list of possible Keyword Groupings to create. Keyword Segmentation is the process of segmenting (or breaking-up) a Keyword Group into one or more smaller sub-groups for the purposes of better organizing keywords. The automated Keyword Grouping Tool is invoked by clicking on the “Segment Keywords” button in the Keywords Tab. FIG. 13a depicts the process of segmenting keyword groupings, in accordance with an embodiment of the present invention.

In order to determine the list of suggested Keyword Segmentations to create, the Keyword Group Segmenter 1302 may analyze the individual keyword members that comprise the currently selected Keyword Group for commonly occurring words. The suggested Keyword Segmentations may be ordered in many different ways.

The Keyword Group Size may order the list of keyword group suggestions based on the size of the resulting keyword grouping, should the operator decide to create the suggested keyword segmentation. It may be important because larger keyword groupings may represent greater opportunity for optimization than creating a keyword group which would result in fewer keyword members.

Keyword Group Search Volume may order the list of keyword group suggestions based on the volume of historical traffic generated by the resulting keyword grouping, should the operator decide to create the suggested keyword segmentation. It may be important because creating keyword groupings of keywords that have historically driven more traffic volume will result in a greater benefit from optimization than performing the same keyword optimization effort on a keyword grouping that has generated little or no keyword traffic in the past.

Keyword Group Relevance may order keyword group segmentation suggestions based on a user-defined relevancy calculation that allows the user to select different keyword properties; for example, number of visits, size of keyword groups, goals, as well as weightings for different goals in order to determine importance of keyword group segmentation. It may be important because it allows a search marketer to focus their optimization efforts on what they deem to be the most productive and important Keyword Groupings for their organization.

In suggesting possible Keyword Groupings to create, the Keyword Group Segmenter 1302 may also take into account popular misspellings, plurals, and keyword variations. For example, in FIG. 13a, the user is trying to segment a “Fish” keyword group consisting of keywords that contain the word “fish.” One of the suggested segmentations may be the words “supplies” and “supply”—which means that both these terms ought to be included in a single keyword group suggestion option because the two terms essentially speak to the same intent; i.e., “fish supplies” is more or less the same thing as “fish supply.”

The Keyword Group Segmenter 1302 may provide an integrated Keyword Group Segmentation Preview Tool which may enable the search marketer to visually inspect the keywords that would be assigned to the newly created keyword group should the user accept the suggested keyword group segmentation. The Keyword Group Segmentation Preview Tool may help the search marketer make the determination of whether or not to accept the tool's suggested keyword segmentation(s). In addition, the user can even expand a suggested keyword segmentation to visually explore its sub-segmentations, even if the originally suggested keyword segmentation has not been created yet. This functionality is intended to further assist the search marketer in determining whether to create suggested keyword segmentation.

The Keyword Group Suggestion Preview Tool may give the operator several options on how to proceed with its recommendations. For example, the operator may select one or more suggested keyword segmentations and simply create them.

If segmentation is deemed irrelevant to an organization's activities, the operator may reject the suggestion, in which case the suggestion is removed from the list of suggested keyword segmentations.

Similarly, the operator may ignore a suggested keyword group segmentation by removing it from the list.

Alternatively, the operator may reset the keyword segmentation suggestion list to include any previously ignored or rejected suggested keyword groupings.

Keywords that are not relevant to an organization may end up in paid search and natural search campaigns—this is due to the fact that often Keywords can have more than one meaning when used in different contexts, and because of errors due to Aggressive Broad Matching employed by the search engines, and other reasons. Keyword exploration facility 112 provides tools and utilities for efficiently finding irrelevant keywords, then blacklisting them so that they are unlikely to appear in the future.

The process of finding negative keyword may typically involve reviewing long lists of search queries, usually from keyword referrer reports, search query reports, or third-party keyword tools—the search marketer goes through these lists (usually manually) and makes note of keyword deemed to be irrelevant and sets those keywords as negative keywords in their paid search campaigns, and has to repeat this process periodically. Keyword exploration facility 112 may provide various tools and an optimized workflow to quickly find and eliminate non-relevant keywords to continuously improve the ‘Quality Score’ of paid search engine marketing campaigns and thereby maximize return on investment.

Keyword exploration facility 112 may simplify the keyword reviewing process involved with discovering and setting negative keywords—rather than reviewing an entire keyword list, the software analyzes the keywords contained within a keyword grouping, breaking them down into a smaller list of terms that frequently appear within a selected keyword group. Initially, all keywords in a Keyword Group are set to an “undecided” keyword state because it is not automatically known if a keyword is relevant to an organization without reviewing them. The operator can invoke the “keyword cleansing” process on a keyword group by invoking a “Cleanse Keyword Group” button in the Negatives Tab which displays the list of commonly occurring terms and provides the following reviewing options:

Terms appearing on the list of commonly occurring terms that are obviously irrelevant can be blacklisted; by blacklisting a word, the operator is setting a Negative Term on the Keyword Group being cleansed—any keywords containing that term are then set to a “rejected” keyword state.

Terms appearing on the list of commonly occurring terms deemed to be obviously relevant may be white-listed; by white-listing a Keyword, the operator is setting a Positive Term on the Keyword Group being cleansed—any keywords containing that term are then set to an “accepted” keyword state.

By blacklisting and whitelisting terms rather than reviewing individual keywords, a search marketer can rapidly cleanse a keyword group by focusing their reviewing attention on only those keywords that remain in an “undecided” keyword state. Furthermore, newly discovered keywords that contain positive or negative terms can automatically be blacklisted or whitelisted, which reduces the burden for constantly reviewing keyword reports—attention can be focused on only those keywords containing unique terms never seen before.

Once a user has specified one or more negative terms, the software can automatically suggest other negative terms based on the notion that irrelevant terms tend to associate with other irrelevant keywords.

Once a user has specified one or more positive terms, the software can automatically suggest other positive terms base on the notion that positive terms tend to associate with other relevant terms.

FIG. 13b depicts a flowchart illustrating the steps for removing a keyword. At step 1301, the keywords to be deleted or removed may be identified by selecting one or more values in the Keyword Data Grid that are meant to be removed from a Keyword Group; and clicking on the “Reject Selected Keywords” button. At step 1304, a decision may be made for removing the keywords based on the options selected in the ‘Remove Keywords Dialog Box.’ For example, the question “How would you like to remove the keywords?” may be answered by choosing either “Remove just this one keyword” which specifies a negative exact match for the selected keyword(s) or “Specify Negative Terms” which enables the operator to remove all keywords matching an expression. The process may proceed to step 1308 where a negative term and keyword match type may be specified. If the option to specify negative terms was selected, the user may then create a filter to reject similar keywords. The user may also specify what keyword matching type option to explicitly control which keywords are to be rejected by click appropriate buttons. Finally, at step 1310, the action may be confirmed. In embodiments, the keyword exploration facility 112 may warn the user of the changes that will happen if the user proceeds.

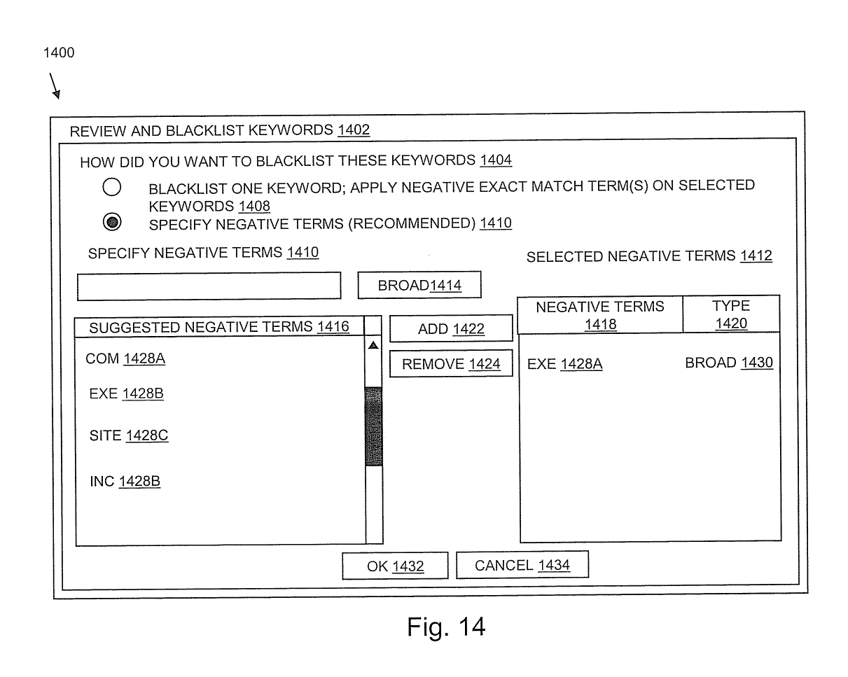

FIG. 14 depicts the review and blacklist keywords dialog box 1402. The user maybe asked how they want to blacklist the keywords 1404, and they may reply with “Blacklist one keyword; apply negative exact match term(s) on selected keywords” 1408 or “Specify negative terms (recommended)” 1410. The negative terms may be specified 1410, suggested 1416 (such as corn 1428A, exe 1428B, site 1428C, and inc 1428D), selected 1412, broad 1414, added 1422, removed 1424, and the like. For example, a negative term in the suggested list 1416 may be added 1422 to the selected list 1412 by dragging and dropping, clicking the add button 1422, and the like. On the selected negative terms list 1412, the negative terms 1418 as well as their type 1420 may be listed. The type 1420 may be broad 1430, exact, narrow, and the like. The user may indicate that the want to move a selected negative term to the negative terms list 1412 by clicking OK 1432, or they may click cancel 1434 to cancel the action.

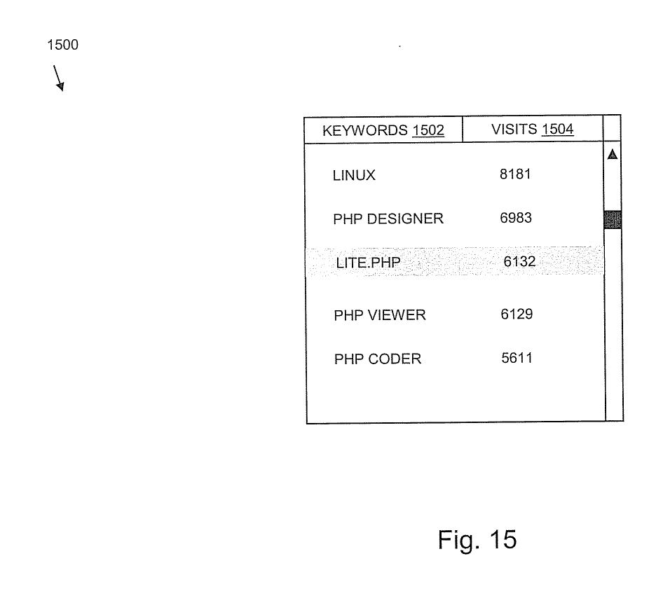

As a convenience to assist with finding non-relevant keywords, the keyword exploration facility 112 may provide the ability to search the Internet to determine the meaning of different keywords by clicking on the “Search” button, located directly on the Keyword Data Grid 1500, as illustrated in FIG. 15. The search results may be displayed in an external browser; the user may then browse the results and determine if the keyword should be kept or deleted and filtered. For example, the search results may indicate the keyword 1502 and the number of visits 1504.

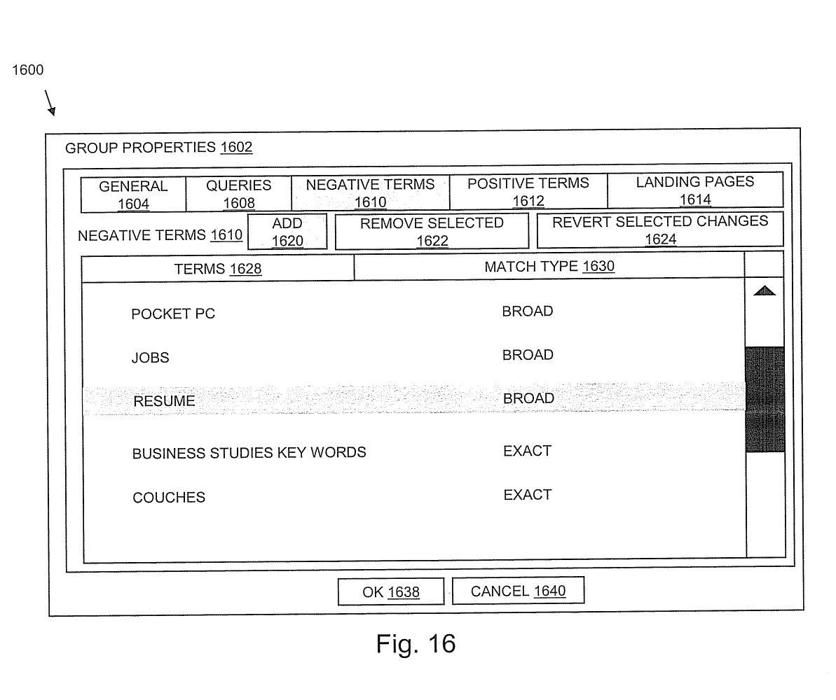

Referring to FIG. 16, the keyword exploration facility 112 may provide a user interface 1600 for viewing, adding, editing, and deleting the Positive Terms and Negative Terms for each Keyword Group simply by clicking on a Keyword Group in the Keyword Group Explorer and selecting the Keyword Group Properties option from the short-cut menu. The group properties 1602 viewable in the user interface include general 1604, queries 1608, negative terms 1610, positive terms 1612, and landing pages 1614. In FIG. 16, the negative terms 1610 button has been selected. Actions related to negative terms 1610 may include adding 1620, removing selected 1622, and revert selected changes 1624. The user interface 1600 displays the terms 1628 in the group and their type 1630. Actions requested by a user may be OKed 1638 or cancelled 1640.

In accordance with embodiments of the present invention, new keywords may be processed and analyzed every day, and as part of the processing, server facility 102 may attempt to organize newly discovered keywords into their most relevant existing Keyword Groups. When automatically assigning a keyword to a Keyword Group, the server facility 102 takes into consideration the queries, settings, positive and negative terms, and other properties that were previously specified on the Keyword Group.

The Automatic Keyword Organization may be a fully automatic process, a fully manual process requiring operator intervention to review every new keyword, or may operate in a semi-automated fashion wherein newly discovered keywords that are assigned to keyword groups containing one or more matching positive or negative terms, are automatically accepted or rejected accordingly.

If the user opts to use either a fully manual or semi-manual reviewing option, then the keyword exploration facility 112 may provide an easy way to visualize the newly discovered keywords and change their keyword state from “new” to “reviewed.” Automatic Keyword Assignment settings can be configured in the Keyword exploration facility 112 “settings” tab.

Many of the previously described tools and features of Keyword exploration facility 112 are designed to simplify the process of generating keyword lists and grouping them into related keyword groups. A key feature of Keyword exploration facility 112 is its ability to leverage the data contained within the keyword groups and integrate it directly with the ad servers of leading search engine marketing platforms, including Google, Yahoo!, and MSN directly via their respective Web service APIs, for the purposes of simplifying and automating much of the work required to create high quality score campaigns and continuously optimize and grow pay-per-click marketing campaigns to increase return on investment. The integration of the keyword exploration facility 112 with search engine marketing platforms is described in detail in herein.

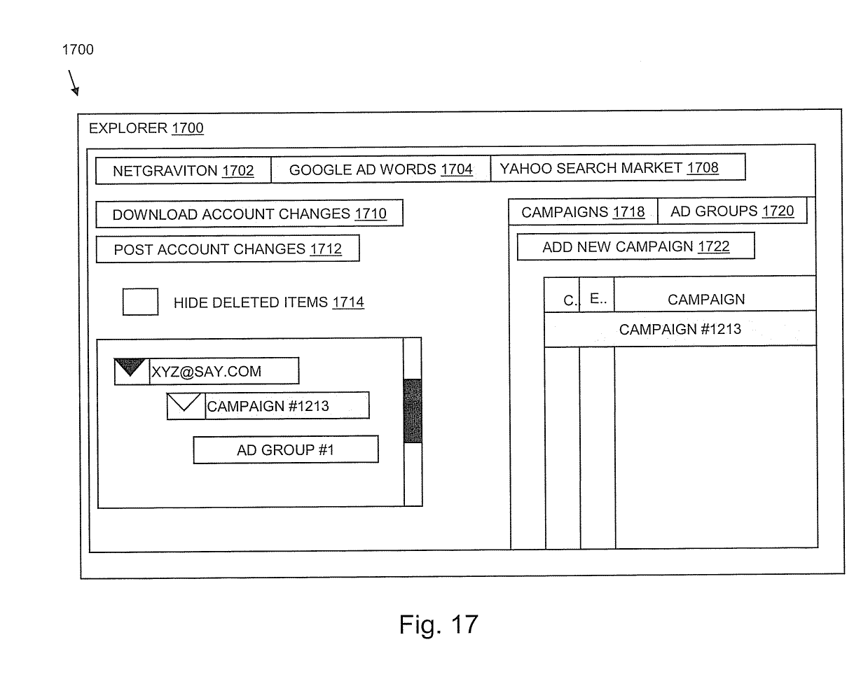

The keyword exploration facility 112 may be an “offline” editing tool because the user can download a copy of all of a user's online advertising accounts, perform any number of edits to the campaigns using various tools, and then automatically synchronize all the changes, across different search engines, in a single posting operation, thus saving the user time by not having to post every change one-at-a-time. To download a copy of a search engine marketing campaign to work on, the user may click “Download Account Changes” 1710, and to upload completed work, the user may click “Post Account Changes,” 1712 as illustrated in FIG. 17. For example, for each advertising account, such as with Netgraviton 1702, Google AdWords 1704, and Yahoo! Search Market 1708, account changes may be downloaded 1710 or posted 1712. Deleted items may be hidden 1714. For each account, campaigns 1718 and Ad Groups 1720 may be viewed or added 1722.

The keyword exploration facility 112 organizes Keyword Groups into keyword hierarchies. The keyword groups can have sub-groups (also known as “children”), and can have them nest to an unlimited depth.

Search engines may employ a completely flat structure, supporting only the ability to group keywords into ad groups, and then organize group one or more ad groups into a campaign.

The keyword exploration facility 112 may provide an intuitive user interface for mapping between different campaign structures. For example, from the “Ad Groups” tab 1720, the user may select a Keyword Group to use as the keywords for an Ad Group.

Similarly, the user may create an Ad Group directly from the short-cut menu of the Keyword Group Explorer.

By associating a Keyword Group to an Ad Group rather than assigning individual keywords (as employed by all other paid search engine marketing tools), the exploration facility 112 may help automatically manage the underlying keywords in a more productive way, by adding more specific terms and adding filters (negative keywords) every day to help improve the Quality Score of the overall campaign.

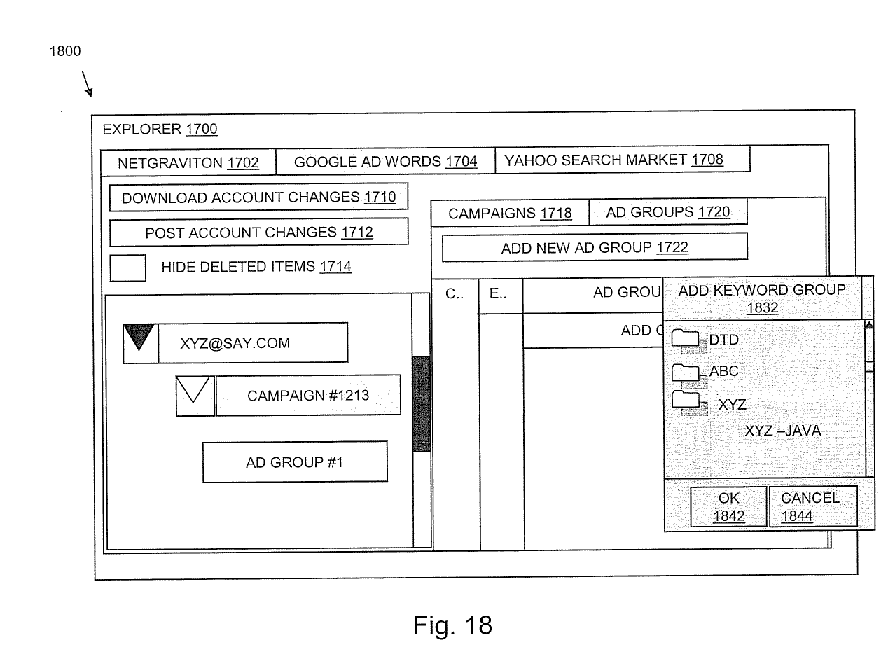

FIG. 18 depicts a process of associating an ad group to a keyword group. The user first creates a New Ad Group, then clicks on “Set” to set an associated Keyword Group; a Keyword Group Explorer window pops up allowing the user to Add Keyword Group 1832 from which the user selects a Keyword Group, then clicks “OK” 1842 or cancel 1844.

The keyword exploration facility 112 may provide a user interface for creating one or more Text Ads for each Ad Group.

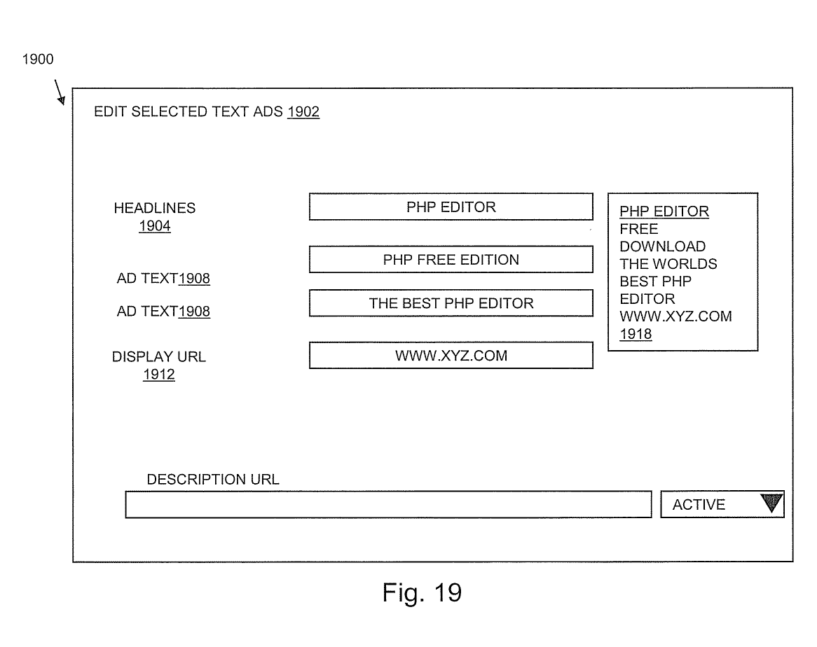

FIG. 19 depicts various tools for automating the creation of high ‘Quality Score’ text ads 1902. The keyword exploration facility 112 may automate the creation of high Quality Score text ads by pre-populating the headline 1904, ad text 1908, and display URLs 1912 with the most popular search terms from the underlying keyword group. By suggesting relevant ad text 1918, the keyword exploration facility 112 may help improve Quality Score because the ad text corresponds directly to the most popular keywords in the Keyword Group assigned to the Ad Group.

The keyword exploration facility 112 may provide an intelligent keyword de-duplicator mechanism that helps a search marketer find and eliminate duplicate keywords that may have been assigned to multiple keyword groupings. Keywords can often be assigned to multiple keyword groupings because a keyword might contain words that span different keyword groupings.

For example, suppose a user searches for “golden retriever dog,” if a search marketer had created Keyword Groups for both “Golden Retriever” and “Dog,” the keyword “golden retriever dog” would be assigned to both groups, because the keyword matches the criteria of both keyword groups. In some cases, the search marketer will not care and will simply allow keywords to be present in multiple keyword groupings, but in other cases, the search marketer might want to de-duplicate keyword groupings.

In accordance with embodiments of the present invention, keyword de-duplication may be facilitated by various tools such as ‘Find Duplicate Keywords,’ ‘Rules-Based Keyword Duplication Elimination,’ and ‘Duplicate Keyword Workflow Tools.’

The first tool may determine what other keyword groups overlap (and the magnitude of the keyword overlap) with the currently selected Keyword Group. Similarly, ‘Rules-Based Keyword Duplication Elimination’ may provide a variety of ways to de-duplicate keywords; in the example involving “golden retriever dog,” the search marketer might want to place the keyword in the “golden retriever” group because that group speaks to a more specific topic than “dog” (“golden retriever” is a type of “dog”). Alternatively, the user might decide to defer the decision to a search engine and simply pick the group where the keyword has the higher quality score. Keyword exploration facility 112 provides tools to set up rules on how to handle and perform the de-duplication operation.

The third tool may provide a view of all keyword groups and orders them by the ones with the highest keyword duplication, in order to help prioritize keyword de-duplication efforts.

The keyword exploration facility 112 may publish ads to search engine marketing platforms either directly using their respective Web service APIs, or via an account export function which enables a search marketer to export their account data and then import them back into search engine marketing platforms using their bulk campaign upload tools.

A conversion (or Goal) occurs when a visitor finds a website through either paid or natural search and subsequently performs a desirable behavior on the client's website, for example, a completed sale, a collected sales lead, or a prospective buyer downloading a white paper about a company's product or service offerings, etc.

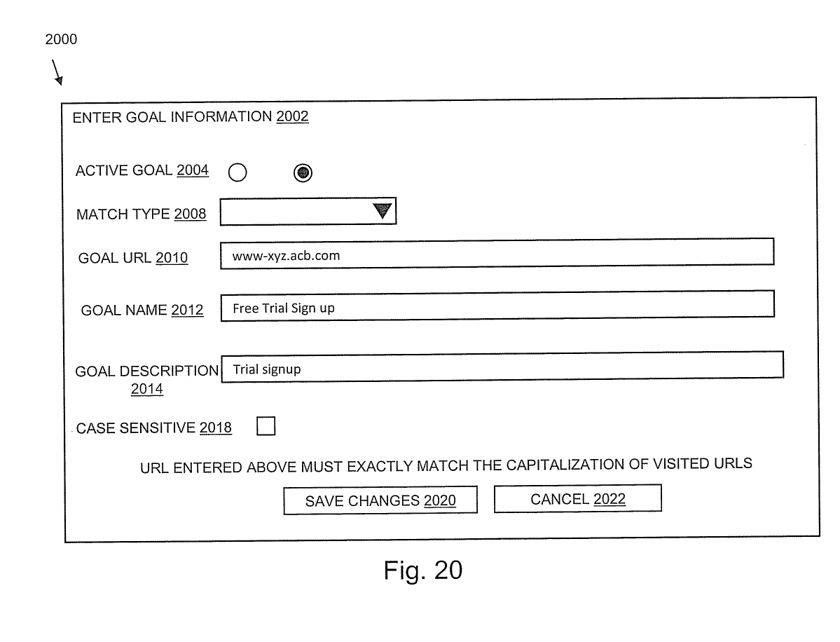

FIG. 20 depicts a process of configuring a goal conversion in accordance with an embodiment of the present invention.

Keyword exploration facility 112 may support integrated conversion tracking and visualization to determine what keyword searches, and more uniquely, what keyword groupings produced what outcomes. Setting up conversion tracking involves defining conversion types such as purchases or sales, leads, Web signups, etc., and specifying a URL of the goal conversion page.

Once conversion tracking is enabled and properly configured, Keyword exploration facility 112 provides different views for browsing keyword distributions; for example, instead of viewing keyword distributions based on traffic frequency, a user could browse keywords based on the number of product sales, or by the number of completed customer registrations, or any other metric. A user can also define different relative weightings for different actions; for example, a completed product sale might be worth 10× more than a product registration, which might be worth 10× more than a visitor; using these different weightings, the Keyword exploration facility 112 can graph a distribution of keywords based on a basket of different metrics and weightings as a way to determine the overall importance of different keywords and keyword groupings to an organization which provide the operator with workflow insights that determine how to most optimally dedicate limited time and resources. For example, a conversion goal may be entered 2002 by indicating whether it is an active goal 2004, the match type 2008, the goal URL 2010, the goal name 2012, the goal description 2014, if the goal is case sensitive 2018. Once the user is done entering the information, they may Save Changes 2020 or cancel the action 2022.

The keyword exploration facility 112 uses a history of keywords data to analyze and act on. This data is gathered by analyzing data contained in archived Web server facility 102 log files, or is streamed in real time directly from a web server via a JavaScript API. However, there are several instances where an organization might not have access to relevant historical Keyword data which is required to get the workflow started.

For example, Web server log files were not saved by the organization or an organization is starting a completely new website, an organization is expanding an existing Website to cover new topic areas (for example, a car company decides to sell boats instead) and so they may have no historical keyword data for the new market.

For these situations, the Keyword exploration facility 112 may provide both a built-in Keyword Generation utility, and support for third party keyword generation tools for harvesting sample keyword data which can subsequently be used to jump-start the process of creating keyword groupings. The integrated Keyword Generation tool can also leverage any third party keyword suggestion tool, providing a keyword import tool for importing new keywords and their relative search frequencies.

Keywords imported into the server facility 102 via a third party Keyword Generator tool may require that initial values for keyword frequency be set. The initial value should reflect the relative frequency data that was provided by the third party Keyword Generation tool; the initial keyword frequencies should not be too low as to not appear important enough to merit any action, nor should it be too high because that would artificially inflate the importance of the generated keyword. The keyword exploration facility 112 may provide a visual interface to import new keyword suggestions and to scale their initial keyword frequencies to a range of values that make sense for the organization.

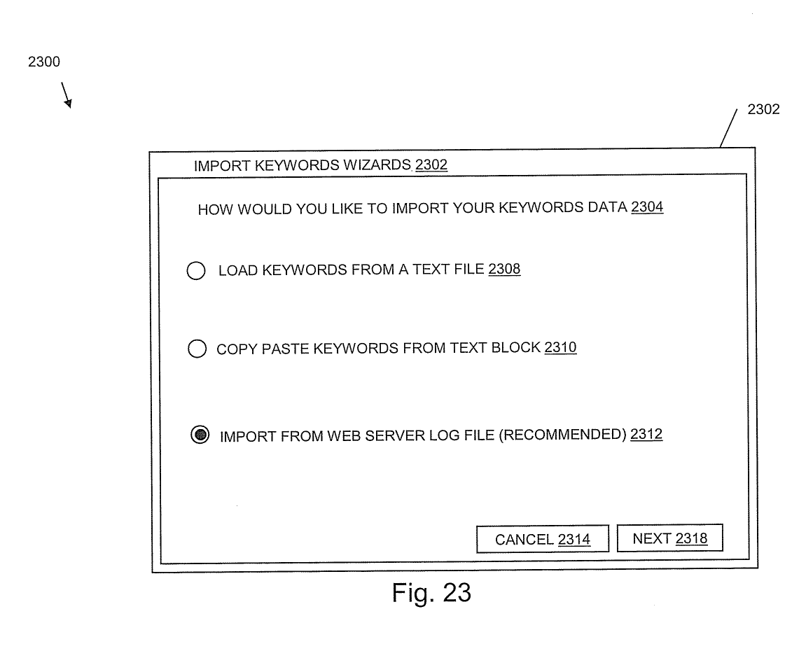

The precise mechanism by which the Keyword exploration facility 112 integrates with third party keyword tools may be a Keyword Import Wizard which is described in conjunction with FIG. 23. FIG. 23 shows an Import Keywords Wizard 2302 dialog box. The user may be asked “How would you like to import your keywords data? 2304”. The user may have a choice of Load Keyword from a Text File 2308, copy paste keywords from text block 2310, import from web server log file (recommended) 2312, and the like. Once an option is selected the user may click Cancel 2314 or Next 2318.

As described herein, there is no limit set on the amount of time and effort that can be spent on creating and optimizing high Quality Score search engine advertising campaigns, simply because there is no limit to the number of keywords, negative keywords, ads, Web content, and of course, the continuous analysis and optimization that can be done. In practical terms however, the limiting factor is usually the availability of time that a search engine professional has to spend on working on an account; therefore, the keyword exploration facility 112 provides advanced data visualization tools, integrated workflow and time management tools which suggest the most optimized workflow for a search marketer to direct their optimization efforts. These workflow tools help identify and prioritize the areas that have the greatest need of optimization work, and would likely yield the greatest positive marginal increase in return on investment if acted on; for example consider the tools and reports such as ‘View Keyword Groups by Number of Visits.’ This report may visually display a “long tail” of all of the Keyword Groups in the account, ordered by Keyword Groups responsible for generating the most traffic. This data can suggest a possible workflow; for example: If a keyword is generating many clicks though paid search engine marketing, then it might be an ideal candidate for natural search optimization work since by publishing a Web page that scores highly on those keywords, it would potentially generate an enormous increase in traffic and possibly even reduce advertising costs because users might click on the natural search result rather than the pay-per-click ad.

Similarly, the other report, ‘View Keyword Groups by Number of Keywords’ may visually display the “long tail” of Keyword Groups ordered by the number of keywords inside each Keyword Group. This report suggests a possible workflow to follow because larger Keyword Groups containing hundreds or even thousands of keywords could be broken up into smaller, more specific keyword groupings, ad copy, and destination URLs which would increase Quality Score and thus decrease the minimum cost per click, while improving ROI because users would be more likely to click on the newer, more relevant ads.

Also, another report ‘View Keyword Groups by User-Defined Criteria’ may provide the ability to chart Keyword Groups by any user-defined conversion tracking metric. For example, online sales, completed registrations, product downloads; or any weighted combination of multiple criteria, providing a visual tool to identify the most important overall most important keyword groups to spend time on optimizing. The data could be acted on in a variety of ways, for example, raising or lowering maximum bids, improving quality score, publishing a Web page for natural search, and the like.

The workflow tab may provide an integrated to-do list that lets users define a list of tasks to do, assign different priorities and types to those tasks, and mark them as being new, work in progress, completed, and the like.

Overall, the keyword exploration facility 112 may provide integrated workflow and time management tools which leverage all available data and built-in visualization tools, allowing the user to identify exactly which keyword groups to focus work on in order to generate the greatest positive outcome for any amount of time spent on account campaign management.

The underlying keyword frequency data and visualization tools provided by the keyword exploration facility 112 may be optionally used to automate and optimize both paid and natural search marketing efforts. Through support for the editor 114 and seamless integration with commercial and open source Content Management Systems and other Web publishing systems, the keyword exploration facility 112 may enable users to act on the keyword distribution in the following ways:

The keyword exploration facility 112 keyword visualization tools may be ideal for identifying the most popular keywords in a particular industry; these keywords could be grouped together and organized into topics that could be written about in specific themed Web pages in order to create a growing collection of highly optimized Web pages that rank highly in natural search engine listings for Web searches on those terms, and thus help generate a daily stream of natural search traffic to a Web site. Rather than authoring a Web page for every single individual keyword (which is simply impossible because there are potentially billions of different keyword combinations), the keyword exploration facility 112 lets the user act on groups of related keywords by providing tools for publishing one Web page for each Keyword Group.

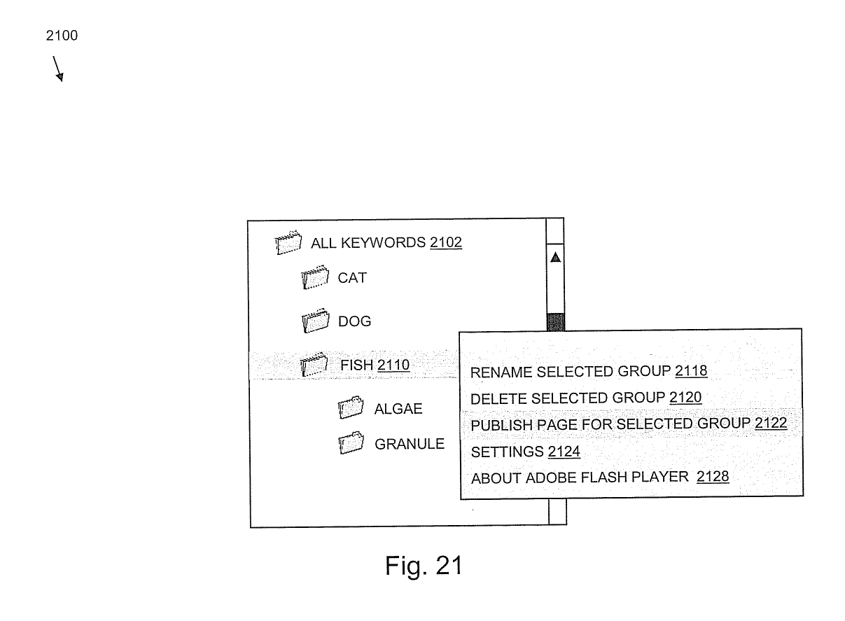

The keyword exploration facility 112 may automate the work required to author and publish to the Web, highly search-optimized Web pages by providing the ability to directly invoke and override the page creation method of an underlying CMS or Web publishing system from directly either the “Text Ads” tab, or from the Keyword Group Explorer window, as illustrated in FIG. 21.

FIG. 21 depicts publishing search-optimized web content directly from the keyword group explorer. A user need only access All Keywords 2102 then select a specific keyword, Fish 2110 in this case. A pop-up window may appear upon selection giving options to rename the selected group 2118, delete the selected group 2120, publish a page for the selected group 2122, alter the settings 2124, get information 2128, and the like.

The newly created page may be initialized using various natural search engine marketing best practices to both improve the relevancy of the page in relation to its associated Keyword Group, and also to help the newly created page achieve a high ranking for natural searches on keywords contained in the underlying keyword group.

The filename of the new page may be derived from the highest frequency search term in the Keyword Group, with spaces replaced by dashes; for example, if the underlying keyword group for the ad group contained terms about “retirement planning,” then the filename would be: retirement-planning.html

The <title> tag of the new page may be set to the highest frequency search term.

The <h1> tag (level 1 heading) of the new page may be pre-populated on the new page using the highest frequency search term in the underlying keyword group.

Several <h2> tags (level 2 headings) may be inserted into the new pages; their values may correspond to the next most popular keyword permutations in the underlying Keyword Group.

The standard HTML meta-keywords may be inserted into the code, using the top 20 most popular keywords in the Keyword Group.

These and other natural search engine optimization best practices may be automatically applied to newly created pages to automate acting on keyword data by publishing search-friendly web pages. By providing seamless integration to the underlying content management and/or Web publishing platform, the user may both reduce the amount of work required to engage in Natural Search Marketing efforts and improve their efficiency.

The relevancy of a Destination URL in relation to an Ad Group (which may comprise of a list of keywords and ad text) is a factor in computing Quality Score. The keyword exploration facility 112 automates the creation of High Quality Score destination URLs by exposing the previously described search-friendly publishing features of Keyword exploration facility 112 directly from within the “Ad Text” tab.

Through integrated support for the editor 114, a search-friendly Web page editing tool, the keyword exploration facility 112 may further automate much of the work required to create highly optimized Web pages for natural web searches on popular keywords. Key features include keyword-suggestion and auto-completion which provide the content author with real time feedback about what popular keywords the author should use within the body of the content currently being authored. The keyword suggestion and auto-completion tools may operate in real time, suggesting popular words relative to where the user's cursor is, suggesting popular phrases as the user types.

In addition, the editor 114 may leverage all of the relationships and associations that were defined between Keyword Groups and Destination URLs in the keyword exploration facility 112, to configure automated hyper-linking tools for cross-referencing related documents from within the contents of a page.

For example, a user may create a relationship between a Keyword Group that has an associated web page (or Destination URL) with the keyword exploration facility 112.

If any of the words contained within the Keyword Group show up in the contents of a Web page, the editor 114 may automatically suggest a hyperlink to the associated Web page, similar to how a spell checker underlines misspelled words in a word processor application.

The editor 114 employs a “greedy” text parsing and matching; it ignores common phrases like “the,” “and,” “how,” “or” (etc.) and tries to hyperlink relevant keywords that appear within Web copy, to the most specific Web page available; a Web page that is associated with Keyword Group that is nested at a deeper level in the Keyword Group is considered to be more specific than a page that is associated with a Keyword Group that is a direct child of the “All Keywords” group.

In addition to the ability to group together keywords and organize them into topics for Web content authoring, the keyword exploration facility 112 may provide workflow tools to identify which topics should be authored first. The determination of priority can be based on a variety of user-defined factors; for example, which topics (i.e. keyword groupings) generated the most traffic and other user-defined goals such as sales or downloads. The keyword exploration facility 112 may provide a workflow tab that displays a list of topics ordered by importance.

The keyword exploration facility 112 may provide several easy ways to import and export all of a User's account data, including keywords, keyword properties (such as Goals or keyword frequencies), Keyword Groupings, Ad Groups (consisting of Text Ads, Keyword Bids, etc.), Negative Keywords, campaign information, and the like, thus providing a way for users to share account information, import & export to a third party application, for example, for manually uploading this data into the Search Engine Marketing Platforms such as Google AdWords, without having to use the Google AdWords API.

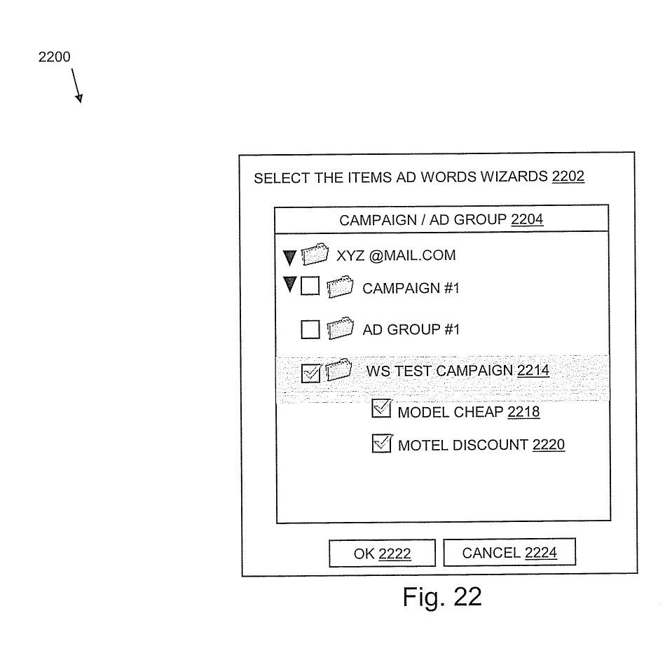

A user may export a copy of the current state of their account, into a variety of different flat-file output formats, both for backup purposes, for importing the data into search marketing advertising platforms via their bulk-upload tools, and for making the data and work done more extensible in integrating with third party tools and workflows. The account export tool is configurable, allowing the user to specify exactly what should be included in the report, for example, what Keyword Groups, different Keyword Properties, Campaigns, Ad Groups, and other properties. To invoke the account export tool, the user clicks on an “Export” button which invokes the Account Export Wizard which is illustrated in FIG. 22. The items to be exported may be selected in the wizard 2202. The campaign/ad groups 2204 may be listed with a facility to select one or more. In this example, the “WS Campaign” 2214 and its sub-groups Model cheap 2218 and motel discount 2220, have been selected. The user may then click OK 2222 to initiate export or cancel 2224.

Upon completing the Account export, the requested data in the requested file format may be generated and the download link may be provided for the user to obtain the files.

The keyword exploration facility 112 may provide a utility for uploading search marketing data such as keywords and keyword properties from a variety of different data sources to a server facility 102. The ability to add external data into the system from almost any data source marks a significant difference between the system and conventional Web Analytics tools which rely on data obtained from Web Server Log files and/or a live data feed from a JavaScript tracker. These data import tools may be invoked via an Import Keywords Wizard which can be invoked from the Keyword exploration facility, and is illustrated in FIG. 23.

The Import Keywords Wizard accepts data from a variety of different data sources, including data from text files, data via copy & pasting operations, and data from historical Web server log file data.

Data may be accepted from text files including those saved using either Comma Separated Values (CSV) or Tab Separated Values (TSV) file formats. Such files could be obtained by running search query reports on Google AdWords, or keyword reports using Web Analytics applications, third-party keyword suggestion tools, and other sources.

Data may be copied and pasted into the exploration facility from spreadsheets, third party keyword suggestion tools, or could simply be typed in manually.

If data is imported via the Load Keywords from Text File or Copy & Paste Keywords options, the user may have the ability to pre-view the resulting data and make revisions to it; for example, incrementing or decrementing keyword properties such as visit frequencies and Goals, or removing certain data.

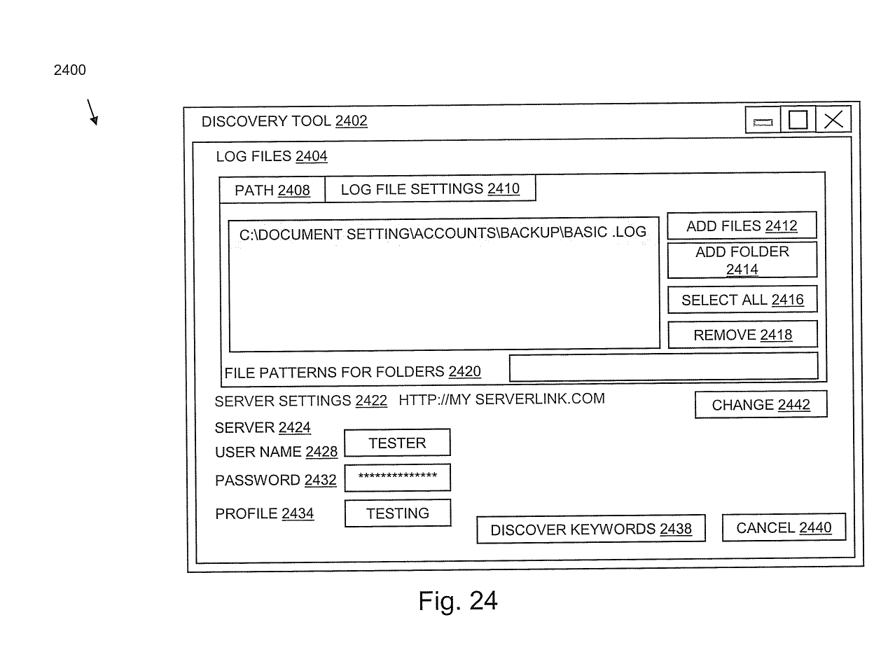

FIG. 24 depicts a keyword discovery tool 2402 that may stream data directly from a user's desktop to a user account.

Import from Web Server Log Files: Suppose a new client wishes to create a new profile for analysis using the past several years worth of historical Web server log file data; such a large amount of data might occupy hundreds of gigabytes or even terabytes of disk space and could potentially take weeks or months to upload, which is not an efficient use of time or resources. Rather than uploading such a large volume of data, the keyword exploration facility 112 provides the ability for a user to download and run a separate program called the Keyword Discovery Tool that can be run from a user's workstation; it operates directly on the user's Web server log files, parsing out the minimum required data and storing it into a more efficient and compressed file format, and the data is automatically streamed directly into the user's account.

To operate the Keyword Discovery Tool 2402, the user has to specify either a list of one or more files from which to extract Keyword data, and/or one or more folders containing Web server log files 2404. If file folders 2414 are specified, then the operator has to specify a file pattern 2420 to use to identify the Web server log files, for example, if a file pattern of *.log is specified, the Keyword Discovery Tool 2402 will process only those files matching that file extension. The user may specify a path 2408 and log file settings 2410. By default, the Keyword Discovery Tool 2402 will search all files in the folders specified by the user. Alternatively, the user may select 2416 or remove 2418 files. In addition to specifying where the files 2412 are located, the user also must specify what account and account profile (since an account can consist of one or more different data profiles) to transmit the data to. Therefore, the user must provide a valid username 2428 and password 2432 which is automatically authenticated in a secure fashion immediately upon typing it in. If the user authentication is successful, the user is presented with a list of available profiles 2434 to choose from for the account. The user must select the Account profile for which the search marketing data should be sent, then click “Discover Keywords” 2438 or cancel the action 2440. The Keyword Discovery Tool 2402 may display a progress bar to show progress being made as well as an estimated time to completion.

The Keyword Discovery Tool 2402 may automatically remember what files have already been processed for a particular account profile, and won't process the same data twice; for example, suppose a user invokes the Keyword Discovery Tool on a directory containing Web server log files, and once again on the same directory but one month later, so that the directory contains new Web server log files that weren't present on the initial program invocation. The Keyword Discovery Tool will check each file to determine if it has already been processed, and will only process files that are new so that data is not duplicated.

The Keyword Discovery Tool 2402 may be invokable via a command line interface and can be automatically scheduled to run as a Windows scheduled task or Linux/Unix Cron job. This would enable a search marketer to automatically update their account periodically without having to install the JavaScript tracker on their website.

The Keyword Discovery Tool 2402 may allow a user to indicate a server 2424, server settings 2422, and change server settings 2442.

The keyword exploration facility 112 may provide an integrated help menu, allowing users to read and search through product documentation from within the browser application. It may also provide context sensitive help which highlights relevant tutorials, video demonstrations and product documentation that can be directly accessed throughout the product.

Therefore, keyword exploration facility 112 may provide for browsing and manipulating the keyword data stored in the taxonomy database of a Server facility.

By integrating Paid Search Engine Marketing tools with Natural Search Engine Marketing tools, the keyword exploration facility 112 “closes the loop” on these two separate yet highly related and synergistic Web marketing activities, providing a powerful and productive tool for simplifying all of an organizations search engine marketing requirements, saving time, money and increasing return on investment.

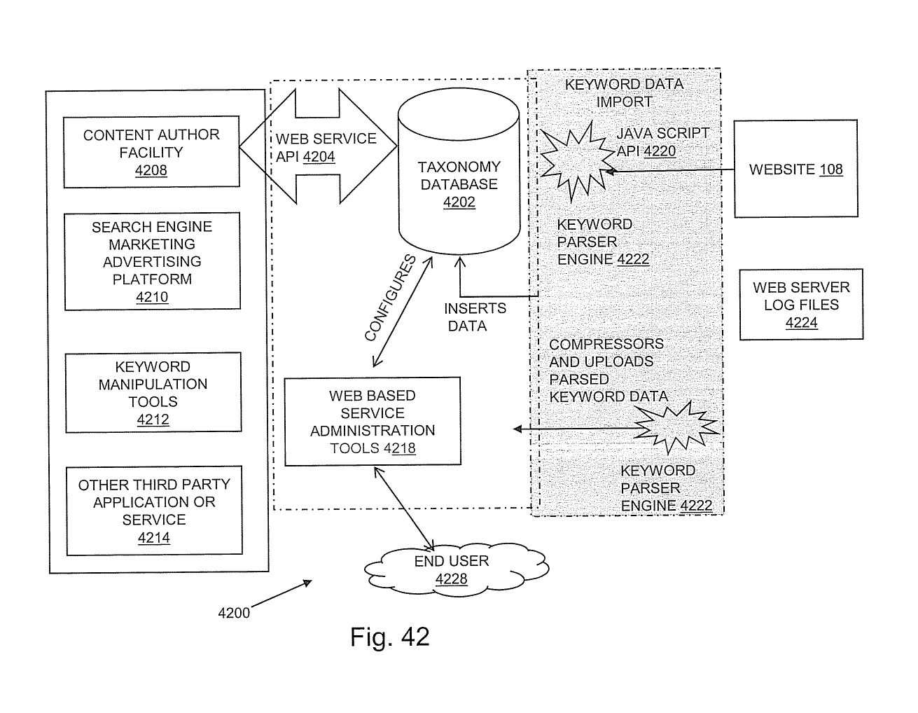

FIG. 42 depicts a high level overview of the server facility 102 in accordance with various embodiments of the present invention. The server may include the taxonomy database 4202, the web server log file parser engine, the JavaScript API 4220, web-based server administration tools 4218, the public keyword suggestion database, and the like. It may be noted that the server facility 102 may be shown to have the above stated tools/databases/components. However, those skilled in the art would appreciate that the server facility 102 may have more or less number of tools/databases/components which may interact with each other and perform different functions.

In embodiments, as described above, the taxonomy database 4202 may store a user's keyword data and other search engine marketing information in an efficient, private, embedded flat-file database.

In embodiments, the web server log file keyword parser engine 4222 may be a software component responsible for extracting keyword data and loading it into the taxonomy database 4202. The keyword parser engine 4222 may operate in two different modes. For example, it may be a separate executable application that may be downloaded by a user and run on a client computer. When run, it may parse the keywords and other data out of web server log files, store the data into an efficient flat file database format, compress and encrypt the data, then upload it to the server facility 102 in a secure way. The data may be subsequently used as input for the taxonomy database 4202.

In another example, the keyword parser engine 4222 may be an integrated component that runs in the same process as a server facility 102 instance. Moreover, it may parse keywords and other important web analytics data from a live data feed that may be transmitted from a user's website directly using a JavaScript API 4220.

In embodiments, the JavaScript API 4220 may be a library of JavaScript functions that may be placed in the HTML code of a user's website. The JavaScript code may automatically determine the keywords which may be used by each visitor which may have resulted in the initial discovery of the website. It may also “tag” a user for the purpose of monitoring user activity during their visit. This data may be transmitted to the server facility 102 for subsequent processing and input into the taxonomy database 4202.

In embodiments, the keyword web service API 4204 may be a library of web service methods used to update or delete the data and settings contained in the server facility 102. These web service methods may be used by any application or service. For example, a web authoring tool may query for keyword suggestions and/or hyperlink suggestions for the purpose of search-optimizing web content. In another example, a pay-per-click search engine campaign management tool may invoke these web service methods to find collections of related keywords, assign them to keyword groups, then assign them to Ad groups in order to create high quality score pay-per-click search engine marketing advertising campaigns.

In embodiments, the web-based server administration tools 4218 are a web application that may allow a user to remotely manage the server facility 102.

In embodiments, referring again to FIG. 1, the public keyword suggestion database (not displayed on FIG. 1), is a searchable database of several hundred million keywords in various languages. A user may leverage the public keyword suggestion database to initially seed their private keyword database with possible keyword suggestions to conduct keyword research and organization work in order to build or optimize a PPC campaign and/or SEO effort. Keyword data contained within the public keyword suggestion database may be gleaned from a variety of publicly accessible keyword data sources and may be separate from the proprietary data contained within a user's private keyword database. Collectively, the above stated software tools/databases/components and their interactions with each other may comprise a single instance of the server facility 102.

In embodiments, the server facility 102 in conjunction with one or more client applications, such as the exploration facility 112 or the editor facility 114 may be used collectively. This collective use may be similar to surfing the “web” and may involve the combined usage of web servers, web browsers and/or other web applications. It may be noted that it is not necessary to use all three components together. For example, as shown in FIG. 4, a user may elect to use only the exploration facility 112 and the server facility 102 for use in creating and managing pay-per-click search engine marketing campaigns.

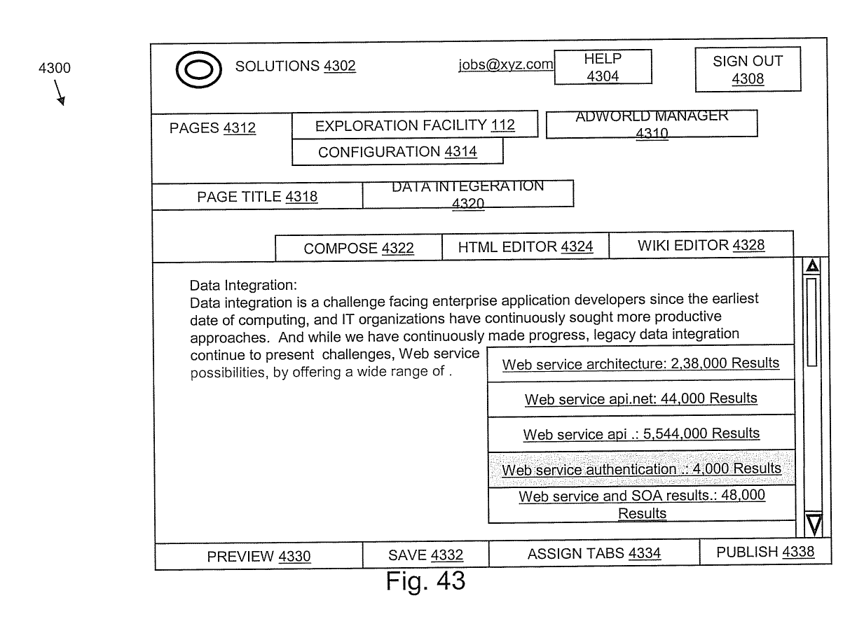

Alternatively, a user may elect to use only the editor facility 114 in conjunction with the server facility 102 for use in automating natural search engine marketing efforts. For example, as shown in FIG. 43, a user may be authoring a search-optimized web page designed to score highly in natural search engine ranking positions for popular search terms. In order to be successful in authoring search-optimized web content, the content author must include popular, high search volume phrases into the content of the page. The editor facility 114 may be integrated for providing a content author with real-time access to keyword data stored in the taxonomy database 4202, which in turn may provide helpful suggestions for the most optimal keywords to be used.

In embodiments, the server facility 102 may host a repository of private keyword databases. Each of these keyword-based databases may comprise search marketing data, such as keywords, a character string, a phrase, a slogan, an idiom, a string of characters of alpha-numeric codes, and the like, which may be aggregated from any number of public and proprietary data sources. For example, the public keyword data sources may utilize a public keyword suggestion tool, a keyword lists derived from third party keyword tools, and the like. Similarly, the private keyword data sources may utilize keyword reports from web analytics applications; search query reports from paid search engines, such as Google AdWords, Yahoo! or MSN; web server log file keyword parser engine 4222, and the like. Similarly, the private keyword data sources may utilize a continuous keyword stream in the JavaScript tracker. It may be noted that throughout this specification, the term “keyword” may include one or more terms that can be used as part of a query that can retrieve a web resource; that is, a keyword may encompass not just a single word, but a phrase that has several terms in it. It may also be noted that the term “website” may be understood to encompass any kind of web resource that can be accessed by a search.

In embodiments, the server facility 102 may provide the users an ability to modify or selectively delete the data. The server facility 102 may allow operations on data such as keywords and their associated properties in different ways. For example, at any time, new keywords may be introduced or added into the server facility 102 from any of the above mentioned public or private keyword data sources, including the continuous keyword stream provided by the JavaScript tracker. In addition, the server facility 102 may allow updating of the existing keyword properties. For example, if the already discovered keywords accrue additional visits and actions, the server facility 102 may update keyword properties to reflect the increased relevancy of select keywords. Moreover, the server facility 102 may allow deleting the data from the data set. For example, the keywords deemed to be irrelevant for any reason may be deleted from the data set.

In embodiments, by making the search marketing database private, readable and writable, the server facility 102 may be easily kept up-to-date with the latest keyword discovery and research data. In addition, the data may be exported and organized into a form that may be more actionable.

In embodiments, the server facility 102 may provide keyword search capabilities to enable keyword research and organization of a private keyword database. These searches may be applied to the entire keyword database or a subset of the keyword database. For example, these searches may be applied to one or more keyword groupings based on any one of different search methods. For example, in the keyword search using full text query, the keywords that contain certain words, word patterns, one or more words, specific word combinations and orderings, the absence of certain words, the absence of certain word combinations, the absence of certain word patterns, or any combination of these text matching criterion, may be searched. Similarly, in keyword search using keyword properties, the keywords may be searched based on keyword properties. Examples of the keyword properties may include but may not be limited to keywords that may have generated a certain amount of visitor traffic, keywords that may have resulted in a specified number of user-defined actions, keywords that may be derived from a certain source, keywords that may exhibit a certain minimum or maximum keyword length, minimum or maximum number of words contained within the search query, keywords discovered during a specified date range, keywords that may lead to traffic through certain URL's, and the like.

In embodiments, the server facility 102 may provide a mechanism for associating or grouping any set of keywords derived by executing the above mentioned ‘Advanced Keyword Search’ into a named, organized grouping of keywords. The keyword grouping mechanism may result in the creation of a named subgroup of the original set of keywords.

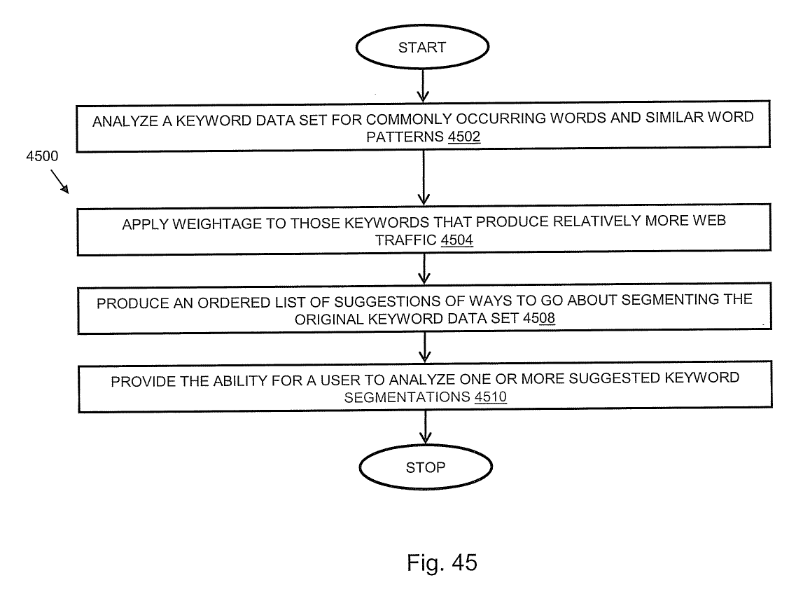

In embodiments, computer algorithms for automatically suggesting one or more ways to break-up a keyword database or any keyword group may be provided. This may help in organizing and categorizing keyword data into closely related groups. In embodiments, referring to the flow chart 4500 of the FIG. 45, at step 4502, a keyword data set for commonly occurring words and similar word patterns, such as plurals, misspellings or variations of a similar word, within the search queries contained in the keyword data set may be analyzed or sampled. At step 4504, greater weightings may be provided to the keywords that are relatively more web traffic producing and/or goal producing. In embodiments, the weighting may be user-defined. At step 4508, an ordered list of suggestions of ways may be produced. The ordered list of suggestions may provide indication for segmenting the original keyword data set, starting with the largest, most web traffic and goal producing keyword segmentations first. At step 4510, the users may be provided to analyze one or more suggested keyword segmentations and to act on the suggestion.

In embodiments, the user may have to accept suggested keyword grouping; in which case, the keywords may be grouped together by using the above mentioned keyword grouping and sub-grouping mechanism. Following this, the algorithm for computing suggested keyword groupings may then be re-executed using the remaining keyword data that may not be present in the newly created keyword segmentation.

In embodiments, the user may have to reject suggested keyword grouping. In this scenario, the algorithm for computing a list of suggested keyword groupings may be re-executed on the original set of keyword data. The keyword data, in this case, may exclude those keywords whose search queries may contain any of the words or word patterns of the rejected keyword segmentation.

In embodiments, the user may have to expand suggested keyword grouping. In this scenario, the algorithm for computing suggested keyword groupings may be re-executed on only those keywords that may be present in the currently suggested keyword grouping.

In the above mentioned algorithm, more keyword data may be accumulated, such as web visitor and goal counts for specific keywords, which may result in a more statistically valid keyword data set. In addition, in the above mentioned algorithm, the users may specify different weightings to different keyword properties such as the web visitor counts and number of goals derived by certain keyword searches which may result in more emphasis being placed on relevant keyword groupings when computing keyword group suggestions. Also, as the users start organizing keyword data by accepting or rejecting keyword segmentations, the algorithm may reduce the size of the keyword data set being analyzed for segmentation; this may allow the algorithm to focus on segmenting only those keywords that may remain un-grouped and still deemed to be relevant. The above stated advantages/features of the algorithm may provide more relevant and better prioritized lists of keyword grouping suggestions over time.

For example, the exploration facility 112 may display the top 500 unassigned search terms and plot them on a standard X-Y graph by default (Keyword Frequency vs. Keyword) to form a ‘long tail’ distribution as illustrated in FIG. 3.

In embodiments, the server facility 102 may also provide a rule-based system for automating keyword research and keyword organization which may pertain to any newly discovered keywords in such a way that may leverage the existing keyword organization structures already in place. This may be done in order to suggest the organization of the newly discovered keywords, while also provide flexibility to modify or override the suggested automatic keyword organization. In embodiments, the newly discovered keywords may automatically be assigned to any existing keyword group that may satisfy the existing keyword criteria used to define the keyword group. Additionally, the keyword criterion, who's functionally may determine the keyword membership for any keyword grouping, may be modified at any time through the addition, removal, or modification to the keyword criterion (or rules) which may result in certain types of keyword being automatically accepted or rejected from keyword groups according to a user's preference of keyword organization.

In embodiments, the rules-based keyword research and organization system may enable a search marketer to produce organized keyword taxonomy in minimal time, and may provide optimum results for paid search marketing and natural search marketing.

In the above embodiment, the keyword database system may be grouped and organized into a hierarchy of keyword groups based on keyword criteria (or rules) expressed by the advanced keyword search methods, that may be based on a combination of full-text search and/or keyword properties. In addition, the new keywords may be constantly discovered and added to the keyword database and/or the properties of existing keywords that may already be contained in the keyword database.

In embodiments, the server facility 102 may provide computer algorithms for detecting keywords that may overlap with multiple keyword group memberships, and for automatically suggesting ways to de-duplicate keyword grouping. This may be done by automatically suggesting one or more possible modifications to the keyword criterion (or rules) that may govern membership into a particular keyword grouping. In embodiments, the server facility 102 may categorize certain keywords that contain multiple terms which span different topical spaces. For example, the keyword search query: “Ford Pinto versus Pontiac Fiero” may be organized into keyword groups for both “Pinto” and “Fiero,” or even “Ford” or “Pontiac.” Such keywords may often result in an overlap with multiple keyword groupings. The algorithms described in this embodiment may use rule-based keyword de-duplication to overcome the overlap.

Normally, keyword search volume estimates provided by keyword tools may be incorrect. In embodiments, server facility 102 may provide a JavaScript tracker that may continuously discover new keywords which may result in web traffic to a user's web Site. The server facility 102 may aggregate the newly discovered keyword data with keywords that may be contained within their private keyword data. The server facility 102 may aggregate the newly discovered keyword data by incrementing web visit and completed goal counts on existing keywords or by adding new keywords that may not already be contained within the keyword database. This type of aggregation may provide more accurate and realistic estimates for web traffic and goal conversions.

In embodiments, the server facility 102 may provide a JavaScript tracker that may discover keywords by analyzing historical and current web server log files. The server facility 102 may aggregate the newly discovered keyword data with keywords that may be contained within their private keyword data. The server facility 102 may aggregate the newly discovered keyword data by incrementing web visit and completed goal counts on existing keywords or by adding new keywords that may not already be contained within the keyword database.

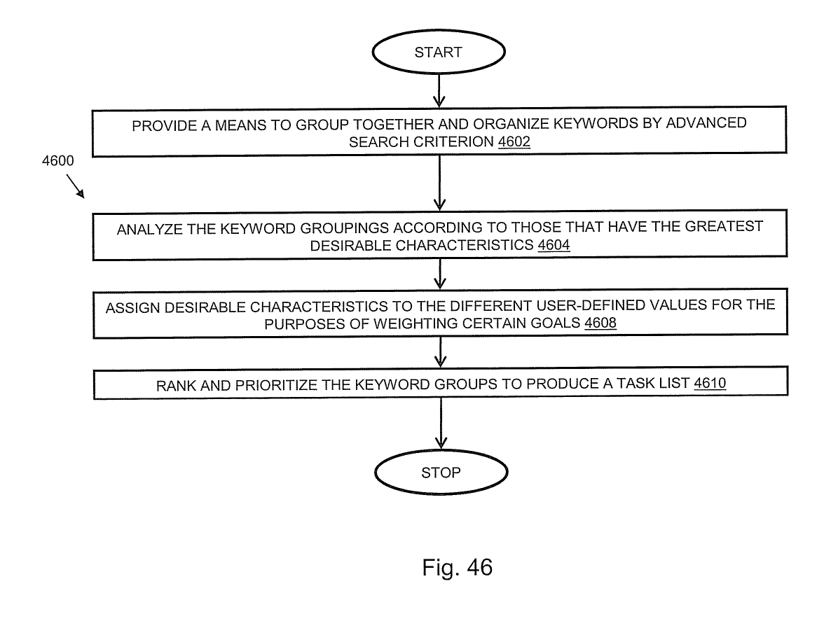

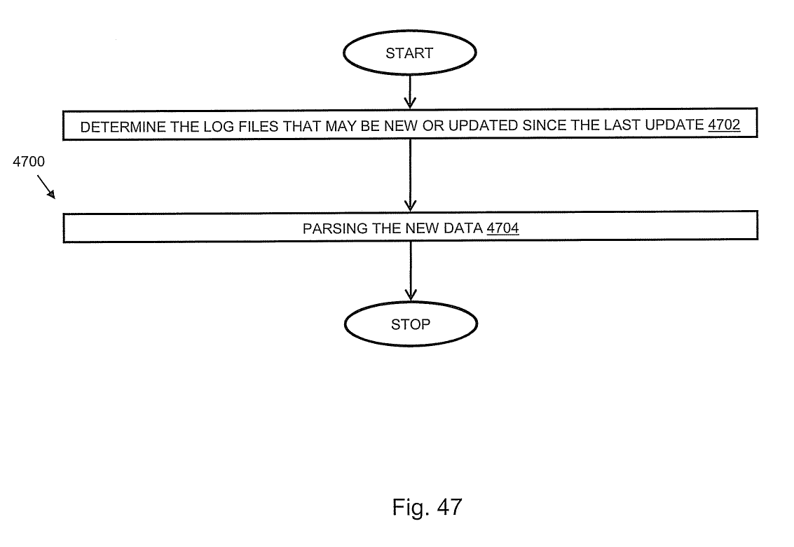

In embodiments, as shown in the flow chart 4600 of the FIG. 46, the server facility 102 may provide algorithms to suggest an optimal search marketing workflow. At step 4602, keywords may be grouped together and organized by advanced search criterion such as full text search and/or various keyword properties. At step 4604, the keyword groupings may be automatically analyzed according to those that have the greatest desirable characteristics, such as web traffic and other user-defined goal producing groups. At step 4608, the desirable characteristics may optionally be assigned different user-defined values for the purposes of weighting certain goals, such as web traffic, and the like. At step 4610, the keyword groups may be ranked and prioritized to produce a task list based on those tasks deemed to have the most or least desirable action-producing potential. This information may be used by a search marketer to make decisions to act accordingly. For example, a search marketer may be able to prioritize the type of keyword groupings which may be turned into Ad Groups for the purpose of engaging in paid search marketing. Alternatively, if the keywords are already targeted for paid search, the search marketer may be able to prioritize the keyword groupings that may have already been targeted as Ad Groups, and which may be segmented into smaller, more relevant keyword groupings, for the purposes of crafting more targeted ads that may be more relevant to the more specific keyword groupings.

In addition, the search marketer may be able to prioritize the destination URL's, i.e. Landing Pages, which may be authored to provide more relevant offers to more specific keyword groupings in order to improve conversion rates. Moreover, the search marketer may be able to prioritize the direct negative keyword discovery efforts. In addition, the search marketer may be able to prioritize the topics for content creation which may be authored as web content for the purposes of engaging in natural search marketing.

In embodiments, the server facility 102 may optionally accept user input to determine the keyword groups that have already been acted on. For example, the server facility 102 may know the keyword groups that may have already been turned into Ad Groups, or may already have dedicated Destination URL's, or for which web content has already been produced. This information may be used to remove suggested workflow actions from the task list.

In embodiments, the server facility 102 may provide the optional use of warning thresholds for various keyword group properties so that items may automatically be placed onto the task list only after accruing certain goals in order to eliminate search marketing tasks deemed to be less important. In addition to suggesting and prioritizing search marketing tasks, the server facility 102 may also be used as a mechanism for coordinating paid and natural search marketing efforts among a team of individual contributors.

Normally, the researched keyword data, i.e. the organized keyword work, may often be stored in a spreadsheet, which may be a separate application from the system. In embodiments, the present invention may provide an Application Program Interface (API) for seamlessly integrating keyword research and organization with action, via the API. The invoking software application may perform different functions which may include, but may not be limited to, accessing any data contained in the keyword database; directly invoking data manipulation operations, such as keyword grouping or un-grouping, adding or deleting keywords modifying keyword properties, and the like. The keyword database API may provide the ability for software developers to create customized search marketing applications to store, and/or organize, and/or access up-to-date keyword data from a centralized, highly available keyword database.

In one embodiment, the keyword database API may be used to synchronize the most up-to-date keyword discovery, research, analysis, and organization data, with Pay-Per-Click campaigns on major search engine ad platforms.

In another embodiment, the keyword database API may be used as a means for enabling seamless integration of the most up-to-date keyword discovery, research, analysis, and organization data, with the systems. Examples of these systems may include word processors, web publishing systems, content management systems, and the like. These systems may be benefitted from access to the keyword database via the keyword database API because the data contained in the keyword server may enable a content author facility 4208. In embodiments, these systems may be used to engage in natural search marketing. In embodiments, the present invention may utilize the search engine marketing advertising platform 4210, keyword manipulation tools 4212, or any other third party application or service 4214.

In embodiments, the content author facility 4208 may help in topic selection. It may assist a user to discern topics suitable for authoring web content, corresponding to keyword groups with desirable web traffic and action producing characteristics. It may also prioritize work so that those keyword groups with the most desirable web traffic and action producing characteristics are acted on first.

In embodiments, the content author facility 4208 may assist in keyword insertion. The content author facility 4208 may assure the user that web content may be search engine optimized and may be contained within the body content of the page, desirable, web traffic and goal producing keywords.

In embodiments, the content author facility 4208 may assist a user by suggesting relevant hyperlinks to related documents using highly relevant anchor text.

The method of classification is termed ‘Taxonomy.’ It refers to compilation of related species of plants and/or animals into categories or groups based on common features. In search engine queries, keywords are classified across industries; e.g., financial, medical, technical, legal, among others. Each of these industries has a typical vocabulary of millions of keyword combinations that are unique to their product or services. The server facility 102 facilitates intelligent querying of huge, private collections of keywords that may then be organized into smaller groups (i.e. Keyword Groups); these are further organized into hierarchical (tree-like) structures according to their relationships with other keyword groups.

In embodiments, the taxonomy database 4202 may be a high-performance, embedded database that may store information about potentially millions of keywords, their properties, and other related data. The other related data may include the type of usage of keywords which may be used by an organization in web publishing and/or pay-per-click search engine marketing campaigns.

The following are some examples of different keyword properties that may be stored in the taxonomy database 4202:

Keyword Length—Example—“How to change a flat tire” consists of 25 characters (including spaces) whereas the keyword “cars” consists of just 4 characters.

Keyword Tokens—Example—“How to change a flat tire” consists of 6 tokens (i.e. words) whereas the keyword “cars” consists of just a single token.

Keyword Search Volume—Example—“Britney Spears”—There may be keywords that may be frequently searched every day and others that may have very low daily search volumes. In embodiments, keyword search volume may reflect the amount of traffic that may be generated by a particular keyword.

Keyword Importance: Certain keywords may be more likely to result in a desirable action than others. For example, using the JavaScript API 4220, an online pet store may calculate that 50% of users searching for the word “fish aquarium filters” ended up purchasing products online where as 0% of users searching for “guppie fish” ended up placing an order. This may clearly reflect that the former is more important to the online pet store than the latter keyword, even if “guppie fish” had a higher keyword search volume.

Negative Keywords: Continuing with the above example, the online pet store might be interested in the keyword “fish food” but not “fish fillet,” “fishing pole,” or “go fish card game;” “fillet,” “pole,” “go,” “card,” and “game.” These key words may be referred as negative keywords because if those words appear in a keyword search involving the word “fish,” then the keyword may not be likely to be very relevant to the online pet store.

Keyword Group: A keyword may be related to other similar keywords; for example “used car” and “used cars” are two different keywords that may mean essentially the same thing; these and other keywords (e.g., “cheap used cars,” “best used cars,” etc.) may be grouped together into a keyword group containing different (yet similar) keyword searches for “used cars.”

Keyword State for Revision: In embodiments, as described above, the server facility 102 may continuously discover new keywords either via the JavaScript Tracker or by periodic keyword importations by different means. Newly added keywords may have a new, un-reviewed state. Once a user has reviewed and accepted or rejected the new keywords, the keyword state for revision may change to either reviewed and accepted, or the keyword may be deleted.

In embodiments, as described above, the taxonomy database 4202 may be a private database of keywords and their properties. The data may be stored in a highly efficient, embedded database format. The taxonomy database 4202 may assist with the discovery and categorization of millions of keywords by providing users with the ability to query and act on the data in different ways.

The taxonomy database 4202 may preserve international characters such as Chinese, Japanese, Korean or any other character set. Therefore keywords expressed in any language may be both stored in the taxonomy database 4202 or may be queried against.

The database may be queried using full-text search. By default, a query containing multiple search terms may be processed using the logical AND operator. For example, a query for ‘used cars’ may return all keywords containing both the words “used” and “cars,” in any order. FIG. 5 lists some examples of supported full-text search queries.

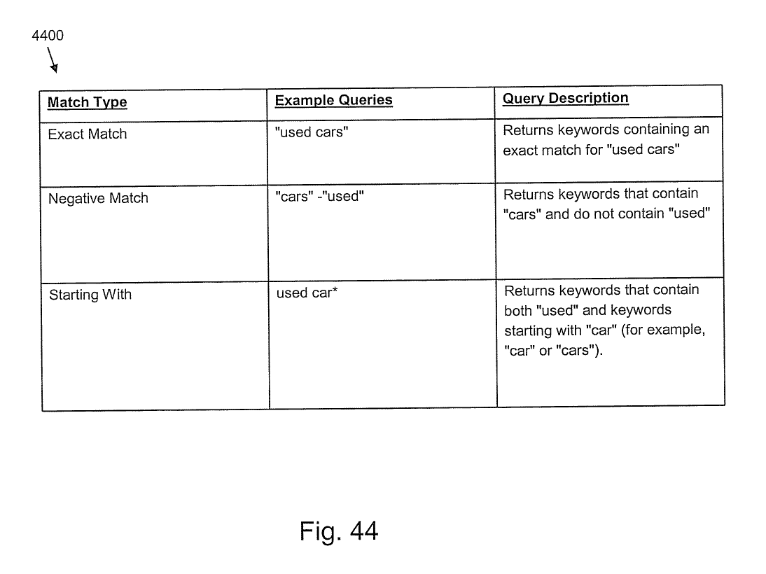

The full text search operators, as shown in the table 4400 of the FIG. 44, may be used along with logical operators and may optionally be separated by parenthesis to form even more specific queries. For example, one such query may be ‘used+(car OR truck) and suv,’ which is a valid query and may return all keywords containing the word “used” and either “car” or “truck” but not the word “suv”.

In addition to providing full-text query support, the taxonomy database 4202 may be queried according to keyword properties. The properties may include but may not be limited to a minimum or maximum number of tokens, keyword frequency, or some other user-defined properties. For example, a user may query for only those keywords that have resulted in 2 or more online sales. By combining the full-text keyword search options with keyword property search features, users may quickly and easily generate very large lists of popular, relevant and important keywords for use in various search engine marketing work, including authoring and publishing search optimized web content and creating high “quality score” pay-per-click search engine marketing advertising campaigns.

The taxonomy database 4202 may implement a multi-threaded, concurrent keyword query driver that supports the ability to fetch a subset of query results in order to provide fast query execution. For example, if a user's query matches 100,000 results, the taxonomy database 4202 may send only the top matching results to reduce the download time and improve query performance. Queries may be executed remotely by any application or service using a web service API 4204.

In addition to storing data about keywords and their various properties and providing the ability to browse and query keyword distributions, the taxonomy database 4202 may also provide various functions for programmatic manipulation of the keyword data. For example, it may provide keyword insertion, keyword property manipulation, keyword deletion, keyword un-deletion, keyword filtering, keyword grouping, and the like. In embodiments, keyword insertion may refer to automatic or manual inserting of newly discovered keywords into the taxonomy database 4202. In embodiments, the keyword property manipulation may refer to the ability to support user-defined keyword properties, such as sales, downloads, customer registrations, or other desirable actions. In addition, it may then set values for those properties according to various actions that may be measured to have occurred on a website. For example, using the tagging capability of the JavaScript API 4220, if a visitor from a specific keyword search results in an online sale, then data may be recorded in the taxonomy database 4202 to assist in the determination of the overall importance of keywords and keyword groups. Similarly, the keyword deletion may refer to automatic or manual deleting of irrelevant keywords from the taxonomy database 4202. On the same note, keyword un-deletion may refer to the ability to retrieve keyword data that was accidently deleted. Similarly, keyword filtering may refer to assigning of filters to prevent certain keywords from ever being inserted into the taxonomy database 4202, or to prevent certain keywords from being inserted into a particular group. Similarly, keyword grouping may refer to organizing a list of related keywords into a specified group. It may also support the ability to rename or delete a keyword group.

In addition to storing information about keywords and their various properties, the taxonomy database 4202 may also store information about the methodology of the usage of keywords in an organization's search engine pay-per-click marketing campaigns for different search engines such as Yahoo!, MSN and Google, and the like. For example, login information, advertising campaign data, keyword group-to-ad group relationships may be stored. The login information may include the username and password required to access the user's search engine marketing accounts. The advertising campaign data may include the information about a user's ad campaigns, ad groups, text ads, keyword bids, historical campaign performance data, campaign settings, and the like. The campaign settings may include the list of different countries, times to run ads, maximum budget, and the like. Similarly, the keyword group-to-ad group relationships may include information about mapping relationships between keyword groups and ad groups.

In embodiments, by using a client application, such as the exploration facility 112, which in turn may leverage the web service API 4204, users may download a copy of their search engine pay-per-click advertising campaigns, and then work on building on and optimizing those campaigns. All of this search engine marketing campaign data may be stored in the taxonomy database 4202.

In embodiments, the taxonomy database 4202 may provide libraries of functions for creating, editing and deleting the search engine marketing campaign information, such as campaigns, ad groups, text ads, etc. A client application such as the exploration facility 112 may then invoke those functions remotely, thus providing an intuitive way to interact with the data stored within the taxonomy database 4202. For example, a user may query the taxonomy database 4202 and then create a group of related keywords. The users may create a new Google Ad Group, and associate it with a keyword group. The users may also create one or more text ads for an Ad Group or set or modify bids for campaigns, ad groups or individual keywords.

Once all the above stated tasks are completed, all changes may be saved to the taxonomy database 4202 and the data may be synchronized and automatically uploaded back to the search engine marketing servers.

In addition to storing information about keyword groups and their relationships to search engine marketing campaigns, the server facility 102 may also store information about mapping relationships between keyword groups and web pages on a user's website, as well as information about the underlying web publishing and/or Content Management System (CMS) utilized by the user. For example, the information may include, but may not be limited to, login information, web page data, keyword group-to-web page relationship data, and the like. The log in information may include the username, password, login URL, and other similar data required to access the user's web publishing or content management system. The web page data may include a complete list of web pages on a user's website 108 as well as their properties, including meta-descriptions, meta-keywords, page title, the frequency of page visits, and the like. Similarly, the keyword group-to-web page relationship data may include Information about the various mapping relationships between keyword Groups and the user's web pages.

In embodiments, the server facility 102 may provide a library of functions to enable any client application. For example, the exploration facility 112 or the editor facility 114 may remotely access and act on the information stored in the taxonomy database 4202 for the purpose of automating the work required to publish search-optimized web content.

For example, a keyword visualization tool such as the exploration facility 112 may leverage the web publishing functions to browse a hierarchy of keyword groups to determine the topics which are the most popular and most relevant. The topics may be written up as web content for use in natural search engine optimization in order to grow an organization's natural search traffic.

In another example, a keyword visualization tool such as the exploration facility 112 may visually create mappings between keyword groups and new or existing web page in an organization's website.

In another example, a keyword visualization tool such as the exploration facility 112 may directly invoke and override the page creation mechanism of the user's web Publishing or Content Management System, pre-populating the newly created page with data from the associated keyword group. The page's meta-keywords may be set to the most frequently searched keywords in the keyword group.

Similarly, a content authoring tool such as the editor facility 114 may invoke these same web publishing functions in different ways. For example, the editor facility 114 may provide a content author with real-time keyword suggestion and auto completion for the most popular keywords, when the user is typing in order to assist in the authoring of search-optimized web content.

In another example, the editor facility 114 may automatically suggest the placement of hyperlinks to relevant documents for certain words appearing in a document to certain web pages, according to the relationships between potentially millions of different keywords and existing web pages. This automated hyperlink suggestion tool may relate URLs to a dynamic Keyword Group that automatically grow over time; thus, this hyperlink suggestion tool may continuously improve over time as more and more relevant keywords may be discovered. This may provide the ability to suggest more and more specific hyperlinks.

In another example, the editor facility 114 may create or edit a webpage, and then associate the webpage and a keyword Group.

In embodiments, the taxonomy database 4202 may store information about web pages and their relationships between keywords; these relationships may be programmatically created, modified, and accessed remotely, and then acted on in a variety of different ways by different applications. These interactions automate and simplify the creation of highly search-optimized web content and/or destination URLs, which in turn results in increased natural search traffic, and higher quality score destination URLs, both of which may generate increased online activities. Examples of these online activities for an organization may include, but may not be limited to, lead generation, sales, and the like.

In embodiments, the server facility 102 may provide a way to track the various updates, edits and deletion operations performed on its data through a robust and extensible revision and change management tracking system. This may enable a user or client application to undo or re-do operations, un-delete deleted keywords, compute differences between live search engine marketing campaigns and local copies in order to determine the data which needs to be synchronized, and the like.

In embodiments, the server facility 102 may include an independent keyword parser engine 4222 that may be implemented in C++ and may operate as part of a Server facility 102 instance or as a standalone executable application which may be run as a desktop application. The keyword parser engine 4222 may be designed to parse through web server log files 4224 to extract data, including information about the different keywords that may be used by people to find an organization's website and other important website metrics, and stores and compresses the data in an efficient flat file database format. The data may be then loaded into the server facility 102.

In embodiments, the keyword parser engine 4222 may operate on any kind of web server log file, including the W3C Extended Log File Format and log files generated by Apache web Server, Microsoft Internet Information Services (IIS), Sun Microsystems, NCSA, and other web servers.

In embodiments, the keyword parser engine 4222 may extract keywords from different search engines, including Google, Yahoo, MSN, AOL, Ask.com, Altavista, AlltheWeb.com, Netscape Search, and other popular search engines.

In embodiments, the taxonomy database 4202 may fully support Unicode and may preserve international characters such as Chinese, Japanese, Korean, and other languages and character encodings. Therefore, keywords written in any language may be extracted using the Keyword parser engine 4222 and then be stored in the taxonomy database 4202 and queried for using the exploration facility 112.

The keyword parser engine 4222 may operate according to an algorithm. The sequence of the steps followed in the algorithm is depicted in the flow chart 4700. At step 4702, the log files that may be new or updated since the last update may be determined. At step 4704, the new data may be parsed. In embodiments, the data may be added into a database format, and indexes of the data may be built.

In embodiments, the keyword parser engine 4222 may be configurable. In embodiments, the keyword parser engine 4222 may have default parsing rules for extracting keywords from web server log files. Examples of the parsing rules may include, but may not be limited to, ignoring very long keywords of greater than 60 characters, ignoring keywords of more than 8 tokens, ignoring keywords which may be lower-cased, and escaping and replacing invalid symbols with white space. For example, the rules may replace the symbols @, &, +, −, =, #, <, >, with a white space. In addition, the predefined rules may include trimming and normalizing white space characters and applying default filters to remove irrelevant keywords from the data. As an illustration, spaces, line feeds, line breaks, tabs, may be trimmed.

In embodiments, the keyword parser engine 4222 may work in different scenarios. For instance, it may work when the log file may be incomplete due to crashing of a web server. In another scenario, the keyword parser engine 4222 may work when the log file format may change mid-way through a file or a collection of files. The log file format may change when a user changes the web server logging settings, resulting in a different number and ordering of data fields. In another scenario, the keyword parser engine 4222 may work when load balancing is employed across different servers generating multiple log files for a single day worth of data. In yet another scenario, the keyword parser engine 4222 may be used to combine data from different websites. For example, a technology company may operate two websites; one geared towards managers and executives, another geared towards IT professionals; the data from these two (or more) servers may be parsed and combined into a single taxonomy database 4202 by using the keyword parser engine 4222.

In embodiments, since the keyword parser engine 4222 produces output that may be intended to be used by the server facility 102. The keyword parser engine 4222 may always be generating the correct output file format corresponding to the most current version of the Server facility 102. The keyword parser engine 4222 may have an automatic update mechanism that may check periodically to ensure that the most current parsing rules may be applied.

In embodiments, the keyword parser engine 4222 may implement performance and scalability enhancements in order to operate on huge data sets, as large as hundreds of terabytes of data, minimize the amount of time required to parse and extract data from a vast collection of web server log files, reduce the amount of time and bandwidth required to upload data to the server facility 102, and the like.

In embodiments, various techniques may be employed by the keyword parser engine 4222. These techniques may include, but may not be limited to, duplicate filtering technique, optimized database format technique, and file compression technique. In the Duplicate Filtering technique, the keyword parser engine 4222 may employ an intelligent log file differencing algorithm to de-duplicate files, ensuring that the same files may not be read over and over again in different test cases. These test cases may include, but may not be limited to, renaming of the same file several times, appending a previously parsed log file when only the new data is read in, and picking of new files on the latest run when the parsing application has previously been executed,

In the optimized database format technique, the keyword parser engine 4222 may extract all the data required by the Server facility 102 and may index the information into an optimized flat file database format which may be designed for fast query execution with average response times in just a few milliseconds.

In the file compression technique, the keyword parser engine 4222 may compress and encode the output files into a single output file (an .SEO file) for efficiently storage and transmission of the keyword data to the server facility 102.

In embodiments, the keyword parser engine 4222 may operate as a stand-alone software application on a user's workstation; the user may download and install a binary application archive that may correspond to the operating system. The keyword parser engine 4222 may be installed on any operating system including Windows 2000/XP/Vista, Mac OS, Linux, UNIX, etc. The keyword parser engine 4222, operating as a client-installed, stand-alone software application may parse web server log files 4224 to extract keyword data used to populate the taxonomy database 4202 and may store the results in an efficient output format (an .SEO file). The application may provide a graphical user interface with different features that may include, but may not be limited to, installer and un-installer, directory settings, project settings, file format, display estimates, file compression, file upload, and wizard interface. The functions of these features are as follows:

Installer and Un-installer: It detects if the application is already installed and determines if a newer keyword parser engine 4222 is available; if so, it prompts the user to get the latest version. It also lets the user override default installation parameters.

Directory Settings: It specifies the location of the web server log files 4224 (i.e., input files) using a file explorer tool for browsing the local file system, the network drives, and file systems. It may pick one or more directories and may specify file masks. It may also specify an output directory and output file name.

Project Settings: It specifies whether the data is meant to be used as a new data profile or as part of an existing data profile.

File Format: It may specify the format in which the log files may be stored, such as the Microsoft IIS or Apache web Server. It may also enable the keyword parser engine 4222 to automatically detect the web server log file format.

Display Estimates: It may estimate the amount of disk space that may be required to process log files and may check the availability of the disk space. It may also estimate the amount of time required to complete the parsing operation and may display the percentage of parsing done.

File Compression: It may compress the output files generated by the keyword parser engine 4222 into a single file (and .SEO file) for efficient storage and file transfer. It may also verify the integrity of the compress file archive and may report errors.

File Upload: It may upload a .SEO file to the Server facility 102 instance in a secure manner. It may also display an upload progress bar that may show the percentage of the uploading of the file. For example, it may display the number of megabytes transferred and an estimate of the time remaining to upload the file.

Wizard Interface: It may provide a step-by-step interface for guiding a user through the process of parsing the keyword data from web server log files 4224 and uploading it to the Server facility 102 instance.

In embodiments, the server facility 102 may provide the JavaScript API 4220 that may perform different functions. For example, it may populate the taxonomy database 4202 with live keyword data from new web searches to a user's web site. In addition, it may provide an optional means to define and measure goals for the purpose of tagging visitors. It may also analyze specific keywords that may lead to specific goals; or conversely, it may analyze the particular keywords which may not result in any goals. This may be done in order to determine the overall importance of different keywords and to compute return on investment.

In embodiments, the JavaScript API 4220 may be different from web service API 4204 and may be used primarily to gather keyword data for input to a taxonomy database 4202 and to determine the importance of those keywords. On the contrary, the web service API 4204 may be used for accessing and acting on the data that may be already contained inside the taxonomy database 4202.

In embodiments, the JavaScript API 4220 may be a snippet of the JavaScript code that may be included towards the bottom, before the closing </body> tag of every HTML page of the user's website. The script, when loaded, may perform different functions. For example, it may instruct the visitor's browser to download the most current JavaScript instructions from a secure, central location so that all users may not have to change their web server configuration every time the script is modified. It may also check that the current request may correspond to a new browser session; if so, the HTTP referrer header may be parsed in order to determine the methodology by which the end-user found the web site. It may also determine whether the referrer may have a search engine, such as Google, Yahoo!, MSN, and the like. If yes, the keyword that was originally searched by the user may be stored in the user's web browser as a cookie. It may also send keyword data to the server facility 102 along with a globally unique identifier to identify the client's website, as well as several additional parameters about user's request, such as a timestamp, client IP address, and the like.

Once the data is received by the server facility 102, it may save a copy to a database table, which is periodically validated, parsed, and indexed into the taxonomy database 4202.

In embodiments, the JavaScript API 4220 may be designed and tested to operate in all the major web browsers, including Microsoft Internet Explorer 7.x, Microsoft Internet Explorer 6.x, Microsoft Internet Explorer 5.x, Mozilla Firefox 2.x, Firefox 1.x, Opera, Safari, Mozilla, Netscape, and others.

In embodiments, the JavaScript API 4220 may also be designed to minimize page-load times and latency. It may not affect the end-user's browsing experience when the user is unable to download the required JavaScript code

In embodiments, in addition to transmitting visitor keyword data, the JavaScript API 4220 may be optionally used to track outcomes from website visitor sessions for the purposes of monitoring and recording the activities of visitors once they arrive at a user's website.

In embodiments, a goal conversion monitoring may involve defining various goals or objectives such as a completed online purchase, a customer registration, a product download, number of page views, and the like. The exploration facility 112 may provide a user interface for defining such goals. For example, it may simply define a goal URL corresponding to a “Thank You” page that may correspond to the action being defined. A “Thank You” page may typically be a web page to which an HTML form is posted. For example, when the user clicks on the “Submit” button for completing an online purchase, the “Thank You” page may be the following page that typically says “Thank you for placing your order” and may list out an order confirmation number and the like.

The JavaScript Tracker code present on a user's site may then automatically determine when the user arrives at a “Thank You” page. It may also determine the initial keyword search queries that may lead to the outcome. If the data is available, it may be sent to the server facility 102 which may log a record of the event, along with other information such as the user's IP address, an identifier which identifies the website 108 that may be sending the data, and the like. Thus the JavaScript API 4220 may provide an optional mechanism to enable users to determine the keywords that led to different actions.

Using the goal conversion features of the JavaScript API 4220 described above, the server facility 102 may provide an extensible mechanism to define specific goals, and then determine what keywords led to what completed goals. This data may be stored along with many other keyword properties, such as keyword frequency, etc., which may be leveraged to determine the overall importance of different keyword groupings. For example, a user may query the taxonomy database 4202 for keywords that may result in a certain dollar amount of sales in the last year. Similarly, the user may filter a keyword query to display only those keywords that may result in a successful product download, or other specific action. On the same note, the use may compute a custom measure of overall importance by applying different weightings to different goals. For example, the user may apply a value of 1 for each visit, 5 for each completed product download, and 25 for each completed online product sale and may then view different keywords according to this weighted score.

In embodiments, the exploration facility 112 may provide a user interface for applying different weightings to different actions and computing the results. By determining which keywords and keyword groups are the most important (and by corollary, which keywords and keyword groups are the least important), a web marketing professional may leverage the data to optimize their ad spend, programmatically reducing spending on keywords that may generate no results and re-allocating those funds to keywords and keyword groups that may produce the greatest return on investment.

In embodiments, the server facility 102 may provide a firewall friendly, secure web service Application Program Interface (API) for remotely invoking server facility 102 on the Internet over HTTP, and may use an XML-based protocol to pass data and to communicate different error conditions between the client that invoked the method and the server responding to the method invocation. In embodiments, the web service API 4204 may consist of various libraries of methods for invoking different types of operations supported by the server facility 102, including functions for querying and manipulating keyword data contained in the taxonomy database 4202, functions for setting up pay-per-click search engine marketing advertising campaigns, and for synchronizing those changes with live search engine marketing ad servers, functions for authoring, publishing and optimizing web content, as well as functions for administering a server facility 102 instance.

In embodiments, the keyword manipulation API may be one of many libraries in the web service API 4204 and may consist of the methods for performing the following operations on keywords and Keyword Groups:

Keyword Querying: In embodiments, the taxonomy database 4202 may be searched based on a full-text-search string and/or other keyword properties such as keyword length, number of tokens, minimum keyword frequency, date, maximum number of results to return, and the like.

Keyword Grouping: In embodiments, one or more related keywords may be assigned to a group of keywords (i.e., a Keyword Group) based on common criteria; for example, a full-text-search and/or other keyword properties.

Keyword Un-Grouping: In embodiments, one or more (or all) keywords may be unassigned from a Keyword Group.

Keyword Deleting: In embodiments, one or more keywords may be deleted based on deletion criteria, such as a full-text-search string and/or other keyword properties.

Keyword Un-Deleting: In embodiments, one or more previously deleted keywords may be restored based on un-deletion criteria, such as a full-text-search string and/or other keyword properties.

Keyword Filtering: In embodiments, one or more negative Keywords may be specified to exclude certain keywords from a Keyword Group.

Keyword Importing: In embodiments, keywords and initial keyword frequency values generated by third party keyword suggestion tools may be bulk loaded into the taxonomy database 4202.

Keyword Modification: In embodiments, keyword properties may be changed and/or added. For example, a “sales” property for a keyword may be incremented, if it was determined that a particular keyword resulted in a completed online sale.

Keyword Group Modification: In embodiments, a keyword Group may be renamed, or the keyword group definition (i.e., the query that was initially used to create the Keyword Group) may be changed.

Other Keyword Manipulation Operations: In embodiments, other functions, typically involving querying or modifying keywords and their properties, may be located in the Keyword Manipulation API.

In embodiments, the Search Engine Integration API may also be one of many libraries in the web service API 4204, including methods for creating and updating search engine pay-per-click advertising account data from Google, MSN, Yahoo, and the like. For example, an application may invoke the Search Engine Integration API to perform the following functions:

Logging In: In embodiments, a username and a password may be transmitted along with other credentials such as a developer token key and/or an application token key in a secure manner, in order to establish a connection to a search engine marketing campaign server.

Downloading Account Data: In embodiments, a copy of search engine marketing campaign data, including campaigns, ad groups, text ads, keywords, and other settings, may be downloaded.

Creating & Modifying Campaigns: In embodiments, search engine marketing campaigns and their properties may be added, deleted, paused, or modified. Search engine marketing campaigns and their properties may include, for example, start and end date, budgeting information, geographical targeting options, and the like.

Creating & Modifying Ad Groups: In embodiments, Ad groups may be added, deleted, paused, or modified, which may include changing default bids, assigning Ad Groups to Keyword Groups, and the like.

Creating & Modifying Text Ads: In embodiments, one or more Text ads may be added, deleted, paused, or modified.

Adding Keywords: In embodiments, relevant keywords may be programmatically added or deleted from ad groups.

Modifying Bids: In embodiments, bids may be programmatically raised or lowered, based on data analysis.

Uploading Account Data: In embodiments, changes made to an offline copy of a search engine marketing account may be synchronized and uploaded to the search engine marketing campaign servers.

Other Search Engine Marketing Operations: In embodiments, other functions involving programmatically interacting with search engine marketing campaign management servers may be all placed in the Search Engine Integration API.

In embodiments, the web service API 4204 may also include a web publishing API which includes methods for interacting with content authoring components, web publishing and content management systems, and word processing software applications, to automate the work involved with publishing search-optimized web content.

Keyword Suggestion: In embodiments, high search volume and relevant search terms to use in the contents of a web page may be suggested.

Keyword Injection: In embodiments, relevant keywords may be programmatically inserted into the content of a page; for example, for use in meta-keywords, title tags, image tags, hyperlink mouse-over titles, and the like.

Other web publishing Functions: In embodiments, other functions involving programmatically automating the optimization of web content may be found in the Search Engine Integration API.

In embodiments, the server facility 102 may have various properties and settings which may be user-configurable. This may be achieved either by directly modifying the server instance configuration files or remotely by invoking web service functions contained in the server facility 102 administration API. For example, the below listed functions may be utilized.

Configure Keyword Parser Engine Settings: In embodiments, keyword parser engine 4222 settings may be configured the way in which keywords may be processed; for example, exclude data from certain hosts, data that was generated from traffic to certain pages, exclude data from different user agents, upload parsed keyword data, and the like.

View & Modify Server Properties: In embodiments, other functions involving programmatically configuring the operation of a Server facility 102 instances may be placed in the server administration API.

In embodiments, the web service API 4204 libraries may be designed to be embedded into any software application or service. For example, the editor facility 114 may invoke various methods of the web Publishing API; and the exploration facility 112 may invoke various methods of the keyword manipulation API, search engine integration API, and web Publishing API.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1-36. (canceled)

37. A computer-implemented method applicable to a computer facility adapted to facilitate a workflow for at least one of search engine optimization and search engine marketing, comprising:
collecting a data set of traffic-generating keywords, the traffic-generating keyword data set representing keywords used to access a web resource during different periods of time;
collecting a data set of suggested keywords;
associating at least one of the suggested keywords and the traffic-generating keywords into a working keyword data set;
presenting the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization;
storing in a private keyword data set a property indicative of the performance of each keyword from the working keyword data set in accessing the web resource; and
presenting in a visual user interface information representing the keyword performance properties, thereby facilitating analysis as to what keywords should be used to optimize at least one of search engine results and search engine marketing for the web resource.

38. The computer-implemented method of claim 37, further comprising grouping keywords in the working keyword data set into a plurality of multi-dimensional, hierarchical keyword groups.

39. The computer-implemented method of claim 38, wherein at least some keyword groups are segmented into sub-groups.

40. The computer implemented method of claim 38, further comprising, allowing users to add keywords to and delete keywords from keyword groups and sub-groups.

41. The computer-implemented method of claim 37, further comprising, allowing user-definition of rules that automatically govern at least one of addition of new keywords to keyword groups, and deletion of keywords from the working keyword data set.

42. The computer-implemented method of claim 37, further comprising, allowing user-definition of rules that automatically govern grouping of keywords into keyword groups.

43. The computer implemented method of claim 37, further comprising,
analyzing the working keyword data set to automatically identify terms that are at least one of relevant or irrelevant to accessing a website; and
automatically grouping relevant new keywords with a relevant keyword group and automatically grouping irrelevant keywords with an irrelevant keyword group to transform the keyword data set into a grouped data set of relevant and irrelevant keywords.

44. The computer implemented method of claim 43, further comprising allowing a user to define a rule set by which a keyword is grouped with a keyword group according to a relevance of the keyword.

45. The computer implemented method of claim 37, wherein the performance property is at least one of a frequency with which a keyword is used to access a web resource and a frequency that a desired action is undertaken by a user who has accessed the web resource by using the keyword.

46. The computer implemented method of claim 37, wherein the performance property is a historical value of actions taken by users who have accessed a web resource by using the keyword and the expected value of future actions that are predicted to be taken by users who have accessed the resource using the keyword.

47. A system adapted to facilitate a workflow for at least one of search engine optimization and search engine marketing, comprising:
a data collection facility that collects a data set of traffic-generating keywords, the traffic-generating keyword data set representing keywords used to access a web resource during different periods of time and a data set of suggested keywords;
a processor that associates at least one of the suggested keywords and the traffic-generating keywords into a working keyword data set;
a presentation facility that presents the working keyword data set to users, thereby allowing users to transform the working keyword data set into a private keyword data set by at least one of adding keywords to and deleting keywords from the working keyword data set, the private keyword data set being adapted for use in a workflow associated with at least one of search engine marketing and search engine optimization;
a memory facility that stores in a private keyword data set a property indicative of the performance of each keyword from the working keyword data set in accessing the web resource; and
a visual user interface that presents information representing the keyword performance properties, thereby facilitating analysis as to what keywords should be used to optimize at least one of search engine results and search engine marketing for the web resource.

48. The system of claim 47, further comprising a processor that groups keywords in the working keyword data set into a plurality of multi-dimensional, hierarchical keyword groups.

49. The system of claim 48, wherein at least some keyword groups are segmented into sub-groups.

50. The system of claim 48, wherein the processor enables users to add keywords to and delete keywords from keyword groups and sub-groups.

51. The system of claim 47, further comprising, a rules server to store a user-defined rule that automatically governs at least one of addition of new keywords to keyword groups, and deletion of keywords from the working keyword data set.

52. The system of claim 47, further comprising, a rules server to store a user-defined rule that automatically governs grouping of keywords into keyword groups.

53. The system of claim 47, further comprising,
a processor that analyzes the working keyword data set to automatically identify terms that are at least one of relevant or irrelevant to accessing a website; and
a processor that automatically groups relevant new keywords with a relevant keyword group and automatically groups irrelevant keywords with an irrelevant keyword group to transform the keyword data set into a grouped data set of relevant and irrelevant keywords.

54. The system of claim 53, further comprising, a rules server to store a user-defined rule by which a keyword is grouped with a keyword group according to a relevance of the keyword.

55. The system of claim 47, wherein the performance property is at least one of a frequency with which a keyword is used to access a web resource and a frequency that a desired action is undertaken by a user who has accessed the web resource by using the keyword.

56. The system of claim 47, wherein the performance property is a historical value of actions taken by users who have accessed a web resource by using the keyword and the expected value of future actions that are predicted to be taken by users who have accessed the resource using the keyword.
